(19) United States
(12) Patent Application Publication
(10) Pub. No.: US 2024/0411506 A1
(43) Pub. Date: Dec. 12, 2024

(54) Devices, Methods, and User Interfaces for Controlling Operation of Wearable Audio Output Devices

(71) Applicant: Apple Inc., Cupertino, CA (US)

(72) Inventors: Taylor G. Carrigan, San Francisco, CA (US); Hugo D. Verweij, Portola Valley, CA (US); Mitchell R. Lerner, San Francisco, CA (US); Charles C. Hoyt, Pacifica, CA (US); Patrick L. Coffman, San Francisco, CA (US); James N. Jones, San Francisco, CA (US); Ashok Masilamani, San Diego, CA (US); Jessica J. Tran, Cupertino, CA (US); David M. Fischer, San Francisco, CA (US); Nishal Ancelette Pereira, Sunnyvale, CA (US); Sanket S. Dave, Sunnyvale, CA (US); Vladan Bajic, San Francisco, CA (US)

(21) Appl. No.: 18/639,759

(22) Filed: Apr. 18, 2024

Related U.S. Application Data
(60) Provisional application No. 63/462,783, filed on Apr. 28, 2023.

(51) Int. Cl. G06F 3/16; G06F 1/16; G06F 3/0487; G10K 11/178

(52) U.S. Cl. CPC G06F 3/162; G06F 1/163; G06F 3/0487; G06F 3/165; G10K 11/17881

(57) ABSTRACT

A wearable audio output device that includes a microphone and one or more input devices detects an input via the one or more input devices. In response to detecting the input and in accordance with a determination that the input is a first type of input, the wearable audio output device adjusts a mute state of the microphone for a first audio function that uses the microphone without adjusting the mute state of the microphone for a second audio function that uses the microphone. In response to detecting the input and in accordance with a determination that the input is not the first type of input, the wearable audio output device forgoes adjusting the mute state of the microphone for the first audio function that uses the microphone.

### RELATED APPLICATIONS

This application claims priority to U.S. Provisional Patent Application No. 63/462,783, filed Apr. 28, 2023, which is hereby incorporated by reference in its entirety.

### TECHNICAL FIELD

This relates generally to audio output devices such as wearable audio output devices, including but not limited to audio output devices that provide audio outputs adaptively based on changes in the environs, techniques for muting microphones of the audio output devices, and techniques for communicatively coupling the audio output devices with other electronic devices.

### BACKGROUND

Audio output devices, including wearable audio output devices such as headphones and earphones, are widely used to provide audio outputs to a user. But conventional methods of providing audio outputs are cumbersome, inefficient, and limited.

In some cases, conventional methods provide audio outputs in a manner that hinders a user's ability to interact with his surrounding physical environment. For example, audio outputs are provided in a static manner irrespective of a user's environs, thereby interfering with a user's ability to hear and understand their environs as well as the user's ability to hear and understand their audio playback content.

In some cases, limited control over audio inputs/outputs is given to inputs provided at the wearable audio output devices; for example, an input may be limited to having control over a single predefined feature of audio output, such as toggling power or a feature on or off. For example, limited control over audio outputs interferes with a user's ability to control a microphone of the wearable audio output devices and/or control the amount of conversational sound that the user is able to hear from the surrounding physical environment while wearing the wearable audio output devices.

In some cases, the wearable audio output devices do not automatically communicatively couple with a nearby electronic device of the user, e.g., requiring the user to manually establish an audio route to wirelessly play audio from the electronic device. In other cases, the wearable audio output devices automatically switch from the electronic device of the user to an electronic device of another user when such a switch is not desired by the user.

In addition, conventional methods take longer and require more user interaction than necessary to adjust audio input/outputs and/or connectivity of the audio output devices, thereby wasting energy and providing an inefficient human-machine interface. Conserving device energy is particularly important in battery-operated devices.

### SUMMARY

Accordingly, there is a need for audio output devices and associated electronic devices with improved methods and interfaces for controlling and interacting with, such as adaptively adjusting audio outputs and/or noise controls, muting audio inputs for particular functions/applications, and communicatively coupling between the audio output devices and nearby electronic devices. Such methods and interfaces optionally complement or replace conventional methods for controlling operation of audio output devices. Such methods and interfaces reduce the number, extent, and/or nature of the inputs from a user and produce a more efficient human-machine interface. For battery-operated systems and devices, such methods and interfaces conserve power and increase the time between battery charges.

The above deficiencies and other problems associated with user interfaces for electronic devices and audio output devices are reduced or eliminated by the disclosed computer systems and audio output devices. In some embodiments, the computer system includes a desktop computer. In some embodiments, the computer system is portable (e.g., a notebook computer, tablet computer, or handheld device). In some embodiments, the computer system includes a personal electronic device (e.g., a wearable electronic device, such as a watch). In some embodiments, the computer system includes (and/or is in communication with) the wearable audio output devices (e.g., in-ear earphones, earbuds, over-ear headphones, etc.). In some embodiments, the computer system has (and/or is in communication with) a touch-sensitive surface (also known as a “touchpad”). In some embodiments, the computer system has (and/or is in communication with) a display device, which in some embodiments is a touch-sensitive display (also known as a “touch screen” or “touch-screen display”). In some embodiments, the computer system has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, audio output device pairing and calibration, digital music/audio playing, note taking, and/or digital video playing. Executable instructions for performing these functions are, optionally, included in a non-transitory computer readable storage medium or other computer program product configured for execution by one or more processors.

In accordance with some embodiments, a method is performed at a wearable audio output device that includes a microphone and one or more input devices. The method includes detecting an input via the one or more input devices, and, in response to detecting the input, in accordance with a determination that the input is a first type of input, adjusting a mute state of the microphone for a first audio function that uses the microphone without adjusting the mute state of the microphone for a second audio function that uses the microphone. The method also includes, in response to detecting the input, in accordance with a determination that the input is not the first type of input, forgoing adjusting the mute state of the microphone for the first audio function that uses the microphone.

In accordance with some embodiments, a method is performed at a wearable audio output device. The method includes, while the wearable audio output device has a first physical arrangement relative to a respective body part of a user and ambient sound from a physical environment is modified by the wearable audio output device to have a first ambient-sound audio level, detecting speech in the physical environment, the speech corresponding to a start of conversation. The method further includes, in response to detecting the speech, changing a modification of ambient sound from the physical environment by the wearable audio output so that ambient sound from the physical environment is modified by the wearable audio output device to have a second ambient-sound audio level that is louder than the first ambient-sound audio level. The method also includes detecting a pause in the conversation, and, in response to detecting the pause in the conversation: in accordance with a determination that the conversation had a first value for a respective characteristic, changing, at the end of a first time period after detecting the pause in the conversation, a modification of ambient sound from the physical environment by the wearable audio output so that ambient sound from the physical environment is modified by the wearable audio output device to have an ambient-sound audio level that is quieter than the second ambient-sound audio level; and, in accordance with a determination that the conversation had a second value for a respective characteristic that is different from the first value, forgoing changing, at the end of the first time period after detecting the pause in the conversation, a modification of ambient sound from the physical environment by the wearable audio output so that ambient sound from the physical environment is modified by the wearable audio output device to have an ambient-sound audio level that is quieter than the second ambient-sound audio level.

In accordance with some embodiments, a method is performed at a wearable audio output device that includes an audio output component. The method includes, while the wearable audio output device has a first physical arrangement relative to a respective body part of a user and ambient sound from the physical environment is modified by the wearable audio output device to have a first ambient-sound level, detecting a change in one or more audio properties of the physical environment. The method further includes, in response to detecting the change in the one or more audio properties of the physical environment: in accordance with the wearable audio output device operating in a first mode, changing a modification of ambient sound from the physical environment by the wearable audio output device, where changing the modification of ambient sound from the physical environment includes changing a degree and/or type of ambient sound modification that is being provided by the audio output component; and, in accordance with the wearable audio output device not operating in the first mode, forgoing changing the modification of the ambient sound in response to detecting the change in the one or more audio properties of the physical environment.

In accordance with some embodiments, a method is performed at a wearable audio output device. The method includes, while the wearable audio output device is communicatively coupled to wirelessly play audio from a first electronic device that is associated with a first user account, detecting a second electronic device in a communication range of the wearable audio output device, the second electronic device capable of providing audio to the wearable audio output device, where the second electronic device is associated with a user account that is authorized to use the wearable audio output device. The method further includes, in response to detecting the second electronic device: in accordance with a determination that the second electronic device is associated with the first user account, communicatively coupling the wearable audio output device to wirelessly play audio from the second electronic device; and, in accordance with a determination that the second electronic device is not associated with the first user account, forgoing communicatively coupling the wearable audio output device to wirelessly play audio from the second electronic device even though the second electronic device is associated with a user account that is authorized to use the wearable audio output device.

In accordance with some embodiments, an electronic device (e.g., a multifunction device, an audio output device, or other type of electronic device) includes one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device cause the device to perform or cause performance of the operations of any of the methods described herein. In accordance with some embodiments, a graphical user interface on an electronic device with a display, a touch-sensitive surface, a memory, and one or more processors to execute one or more programs stored in the memory includes one or more of the elements displayed in any of the methods described herein, which are updated in response to inputs, as described in any of the methods described herein. In accordance with some embodiments, an electronic device includes means for performing or causing performance of the operations of any of the methods described herein. In accordance with some embodiments, an information processing apparatus, for use in an electronic device includes means for performing or causing performance of the operations of any of the methods described herein.

Thus, electronic devices that include or are in communication with one or more display devices, one or more input devices, and/or one or more audio output devices, are provided with improved methods and interfaces for controlling operation of the audio output devices, thereby increasing the effectiveness, efficiency, and user satisfaction with such devices. Such methods and interfaces may complement or replace conventional methods for controlling operation of audio output devices.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3A is a block diagram of an example multifunction device with a display and a touch-sensitive surface in accordance with some embodiments.

FIG. 3B illustrates physical features of an example wearable audio output device in accordance with some embodiments.

FIG. 3C is a block diagram of an example wearable audio output device in accordance with some embodiments.

FIG. 3D illustrates example audio control by a wearable audio output device in accordance with some embodiments.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 5A-5P illustrate example user interfaces and user interactions for adjusting microphone operation of wearable audio output devices in accordance with some embodiments.

FIGS. 6A-6J illustrate example user interfaces and user interactions for controlling various features associated with audio output devices in accordance with some embodiments.

FIGS. 7A-7D illustrate example user interfaces and user interactions for various features associated with audio output devices in accordance with some embodiments.

FIGS. 8A-8P illustrate example audio outputs with example changes in the audio properties of a surrounding physical environment in accordance with some embodiments.

FIGS. 9A-9B illustrate example conversations and corresponding changes in the audio outputs of wearable audio output devices in accordance with some embodiments.

FIGS. 10A-10E illustrate an example conversation and corresponding changes in the outputs of a multifunction device and wearable audio output devices in accordance with some embodiments.

FIGS. 11A-11M illustrate example user interfaces, user interactions, and connectivity for audio output devices in accordance with some embodiments.

FIGS. 12A-12G illustrate example user interfaces and user interactions corresponding to various associated audio output devices in accordance with some embodiments.

FIGS. 13A-13C are flow diagrams of a process for adjusting a mute state of a microphone of one or more wearable audio output devices in accordance with some embodiments.

FIGS. 14A-14C are flow diagrams of a process for adaptively changing ambient sound audio levels in response to detected speech in the physical environment in accordance with some embodiments.

FIGS. 15A-15B are flow diagrams of a process for adaptively changing modification of ambient sound audio levels in response to detected change in one or more audio properties of the physical environment in accordance with some embodiments.

FIGS. 16A-16C are flow diagrams of a process for communicatively coupling a wearable audio output device with authorized electronic devices in accordance with some embodiments.

### DESCRIPTION OF EMBODIMENTS

As noted above, audio output devices, including wearable audio output devices such as headphones, earbuds, and earphones, are widely used to provide outputs to a user. Many computer systems that include or are in communication with audio output devices give a user only limited control over connectivity and inputs/outputs of the audio output devices, or provide user interfaces with too few or too many output controls. The methods, systems, and user interfaces/interactions described herein improve interactions with audio output devices in multiple ways. For example, embodiments disclosed herein describe improved ways to control microphone states using inputs at the audio output devices and to provide improved user interfaces for controlling audio input/output settings.

As also noted above, many audio output devices provide audio outputs in a static manner that does not adapt to changes in the audio properties of the surrounding physical environment. The methods, devices, and user interfaces/interactions described herein improve how audio outputs are provided in multiple ways. For example, embodiments disclosed herein describe ways to provide audio outputs adaptively based on detected speech and/or changes in the audio properties of the surrounding physical environment, e.g., so that the user can better interact with their surrounding physical environment.

The processes described below enhance the operability of devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

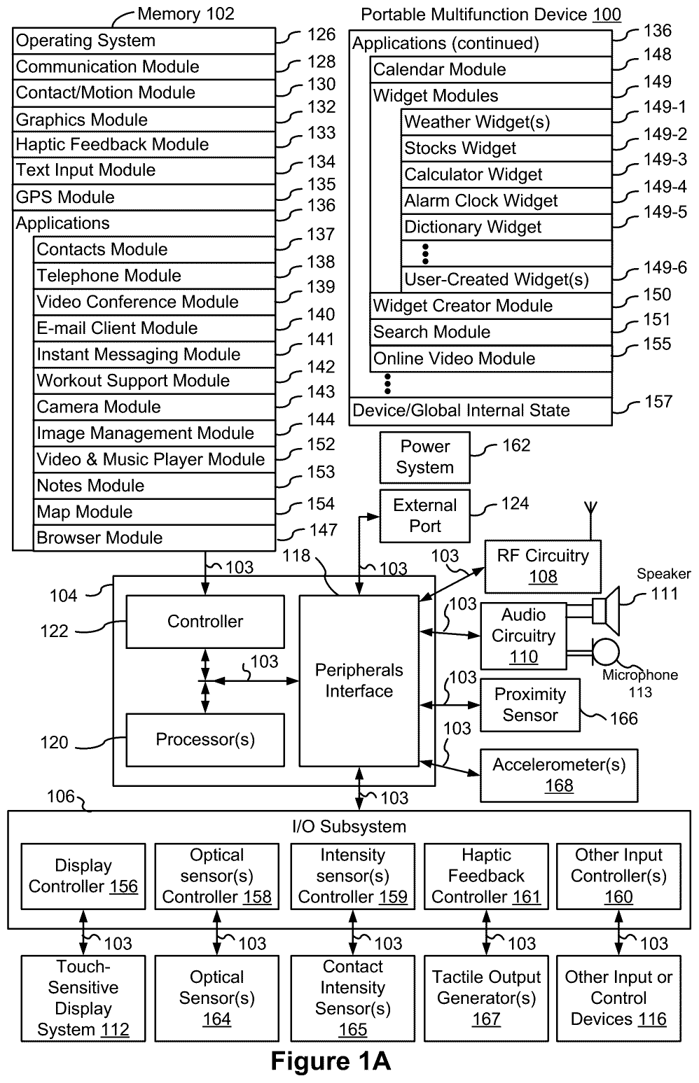

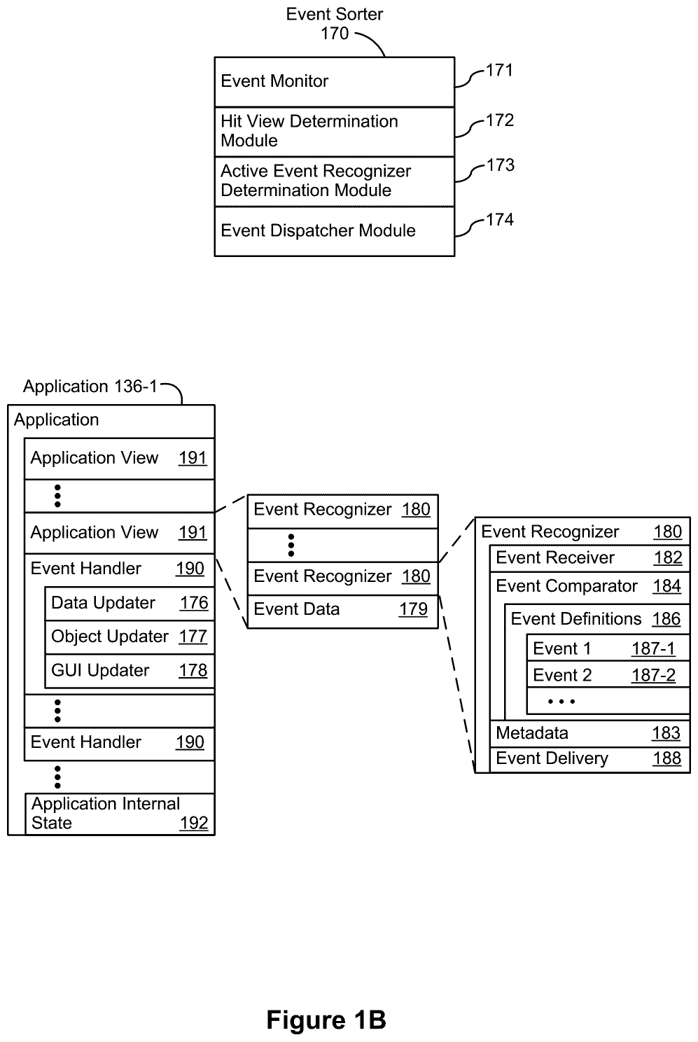

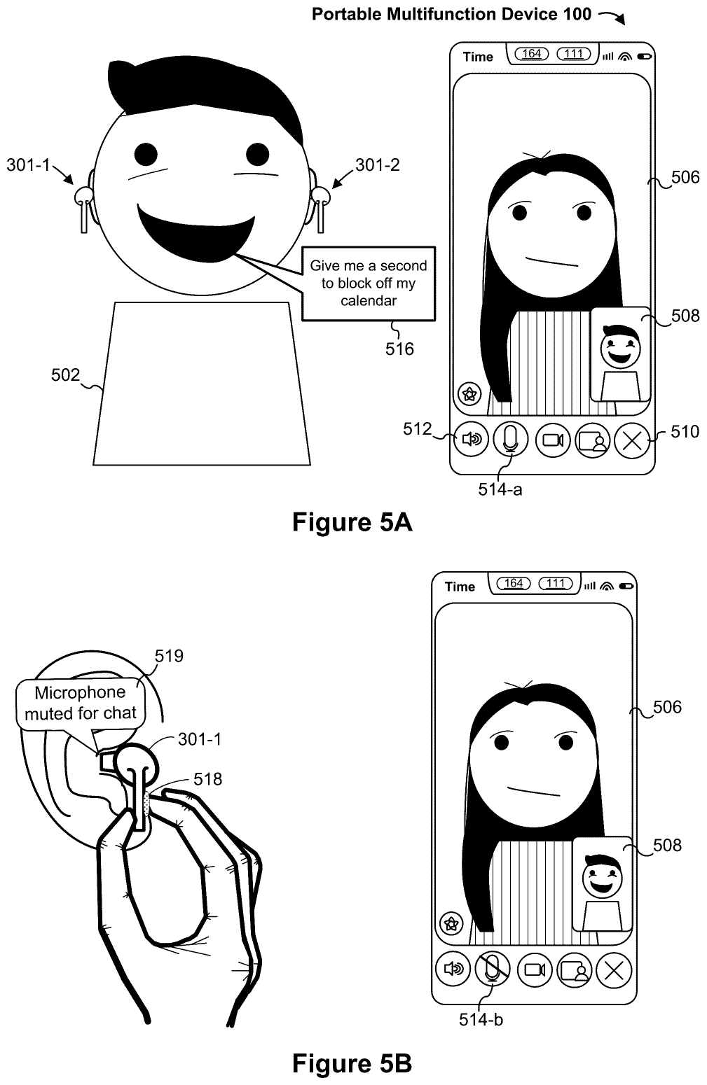

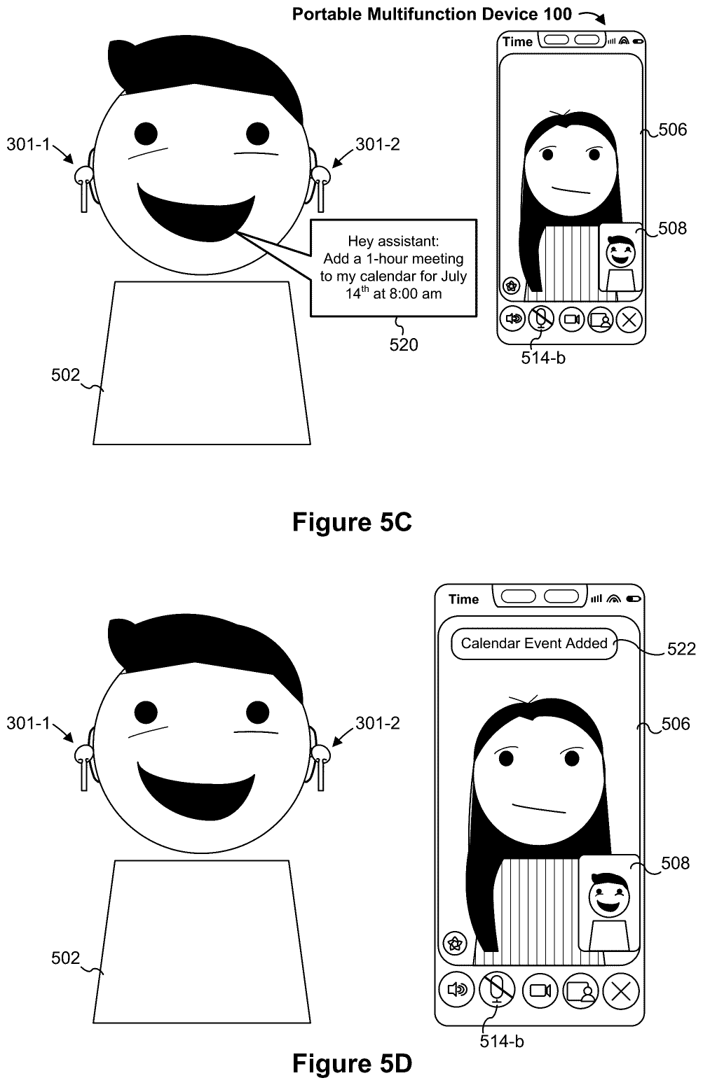

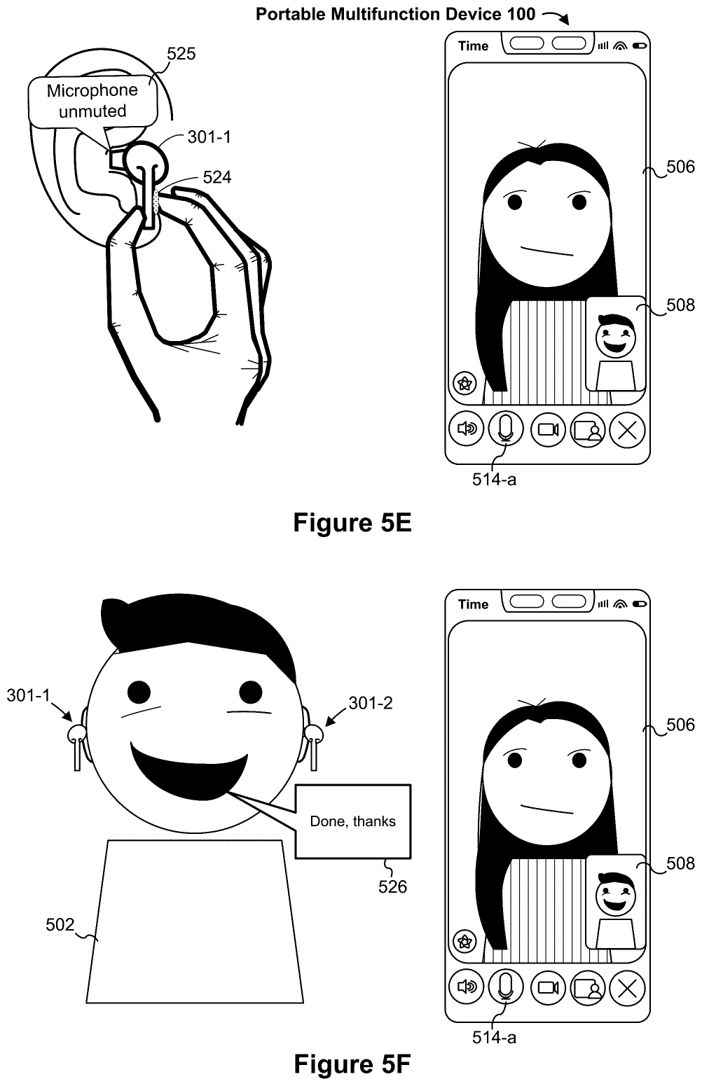

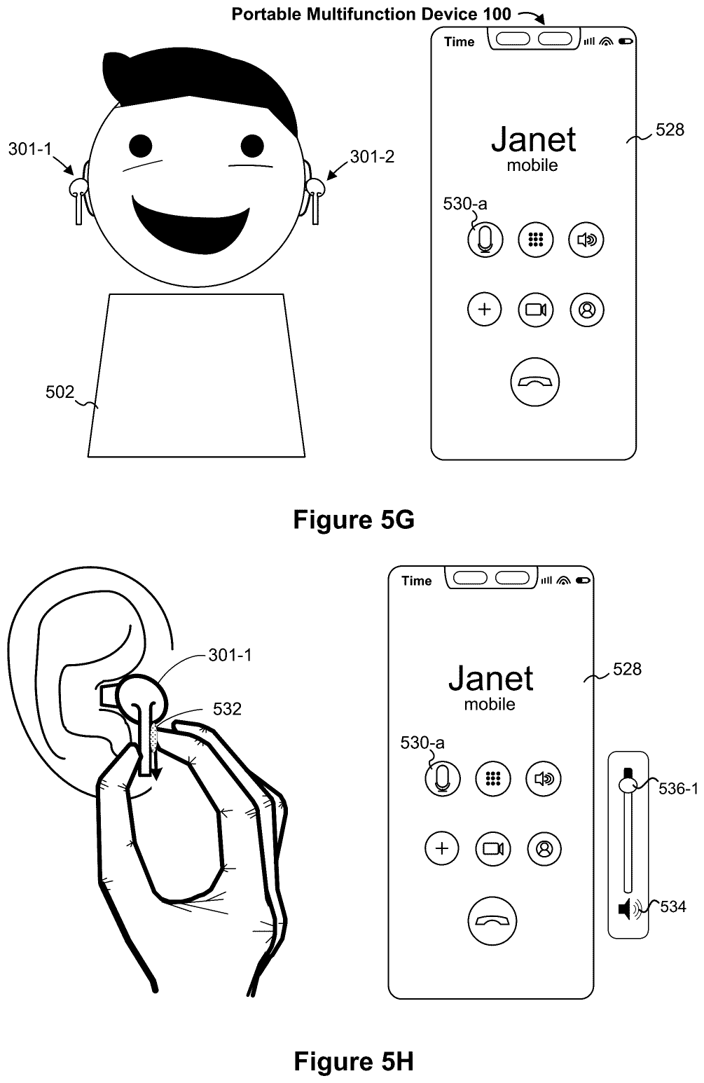

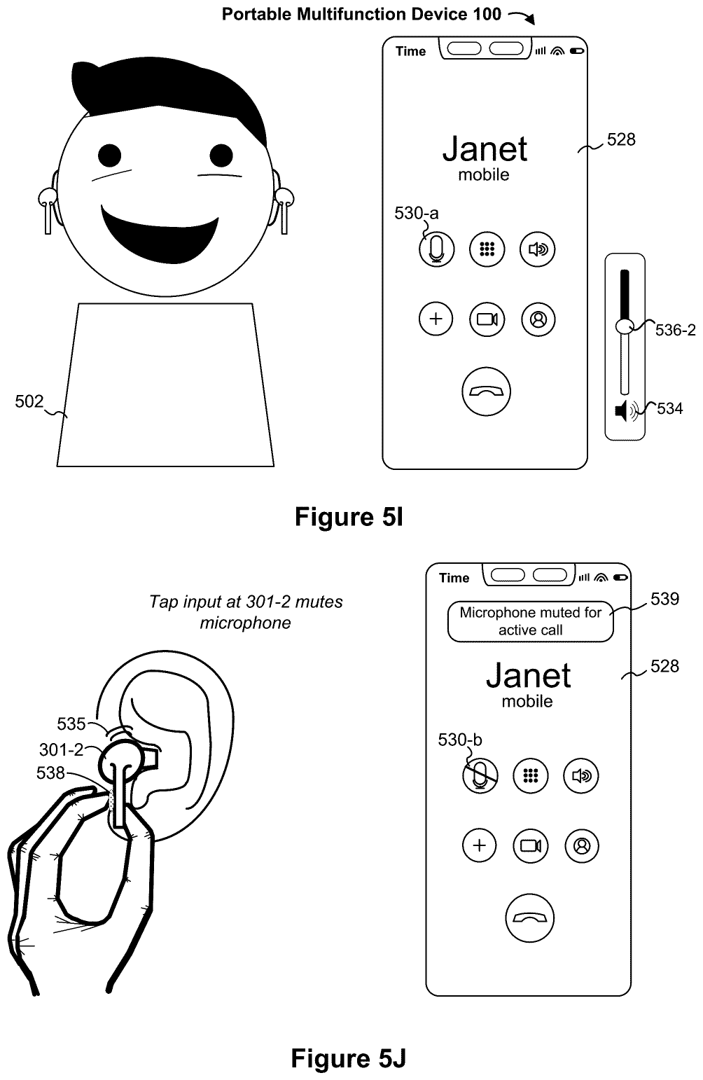

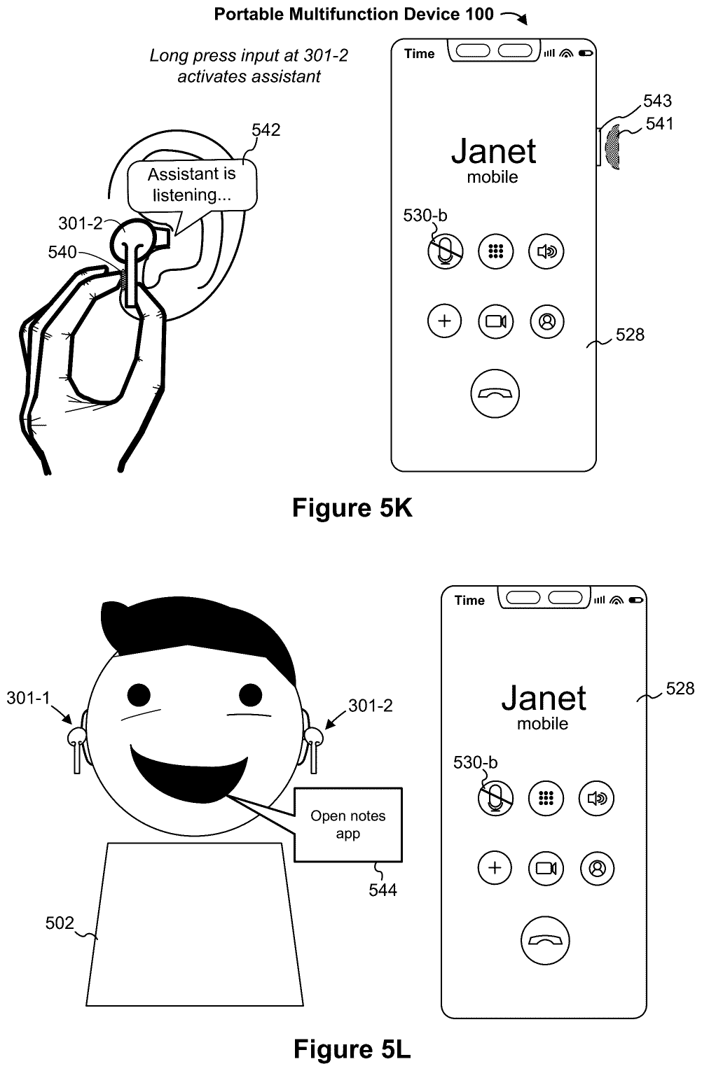

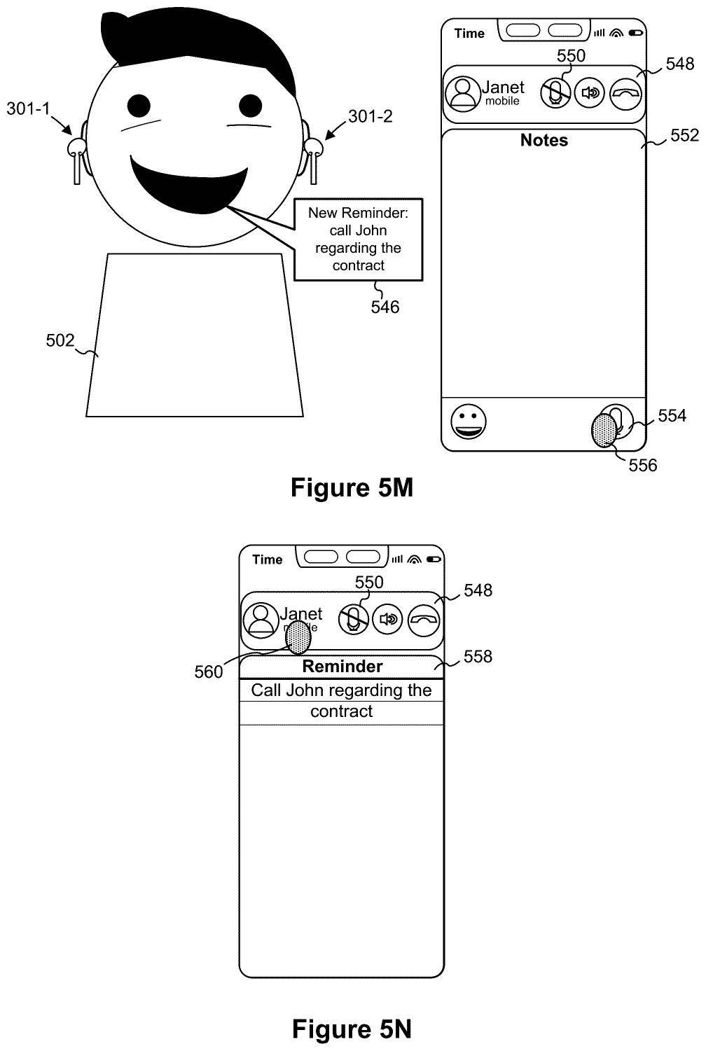

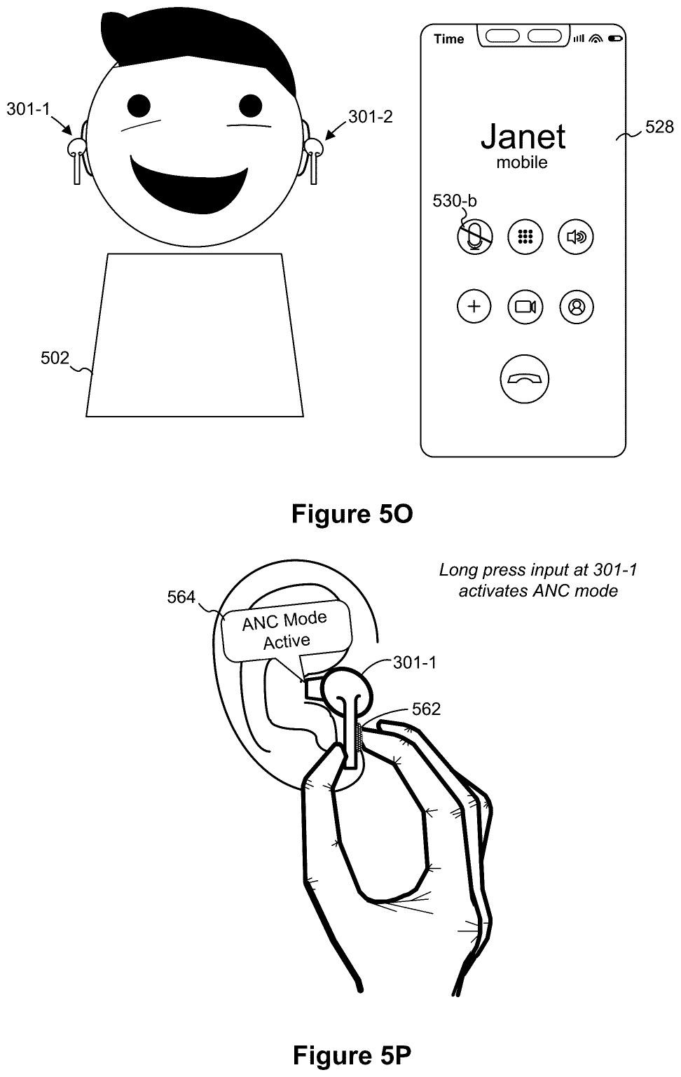

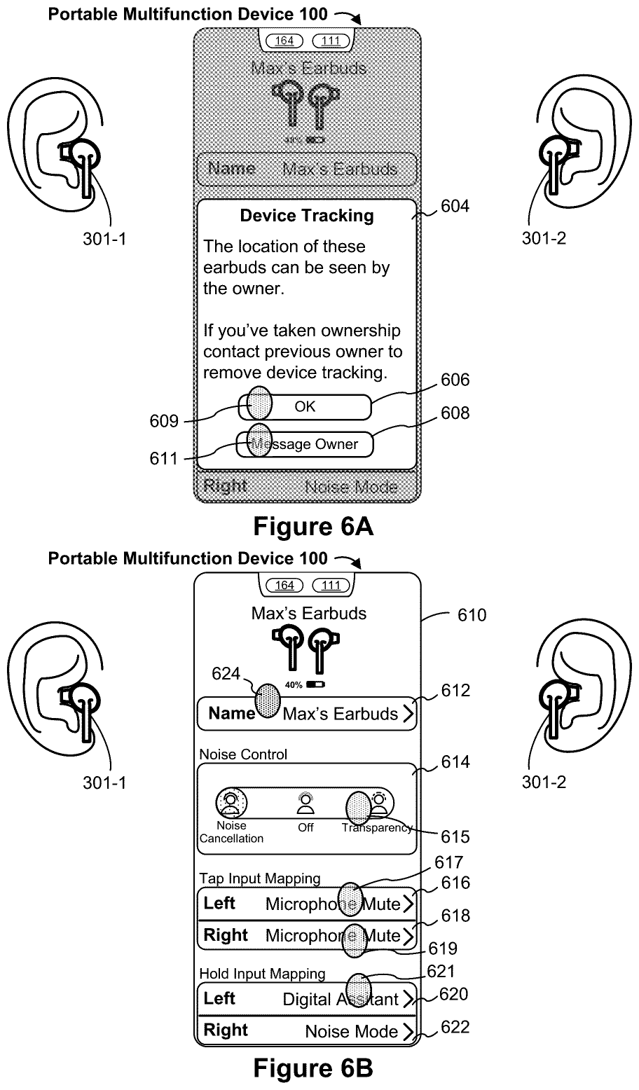

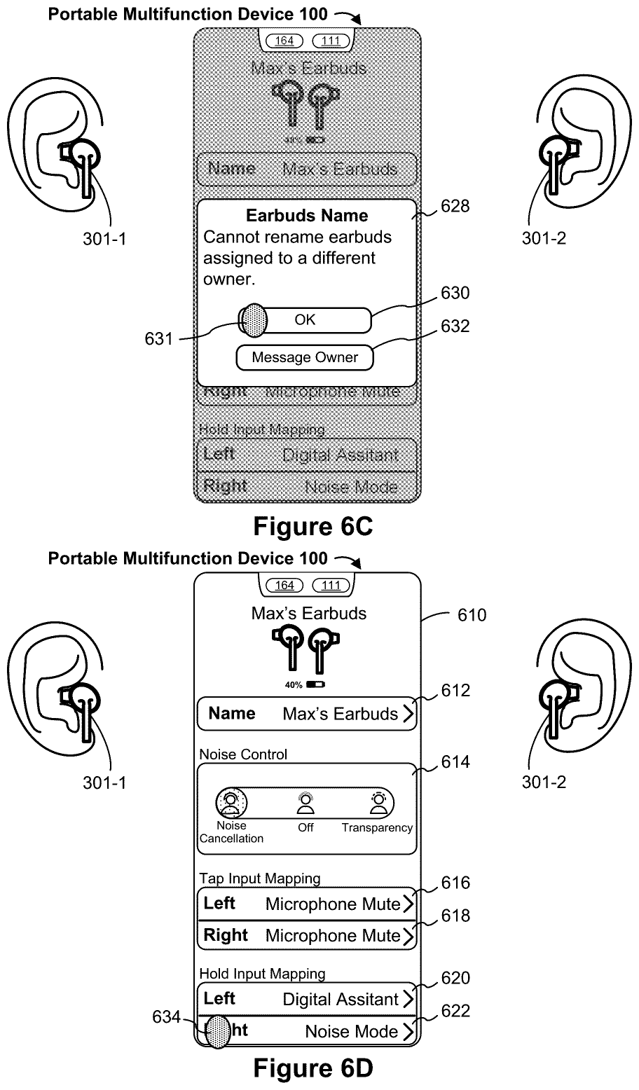

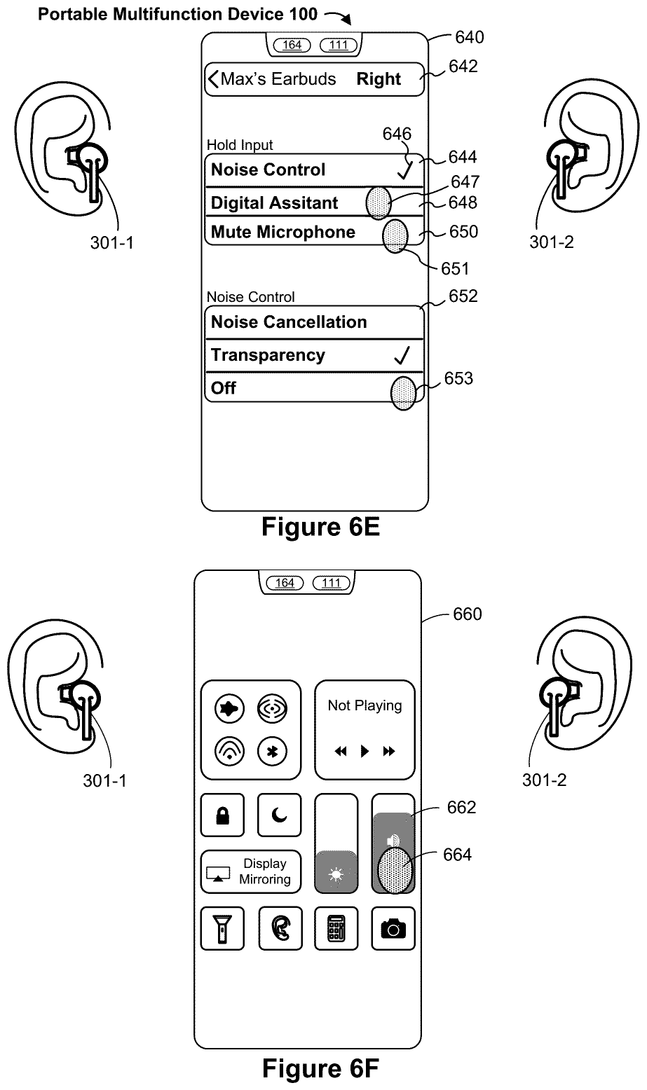

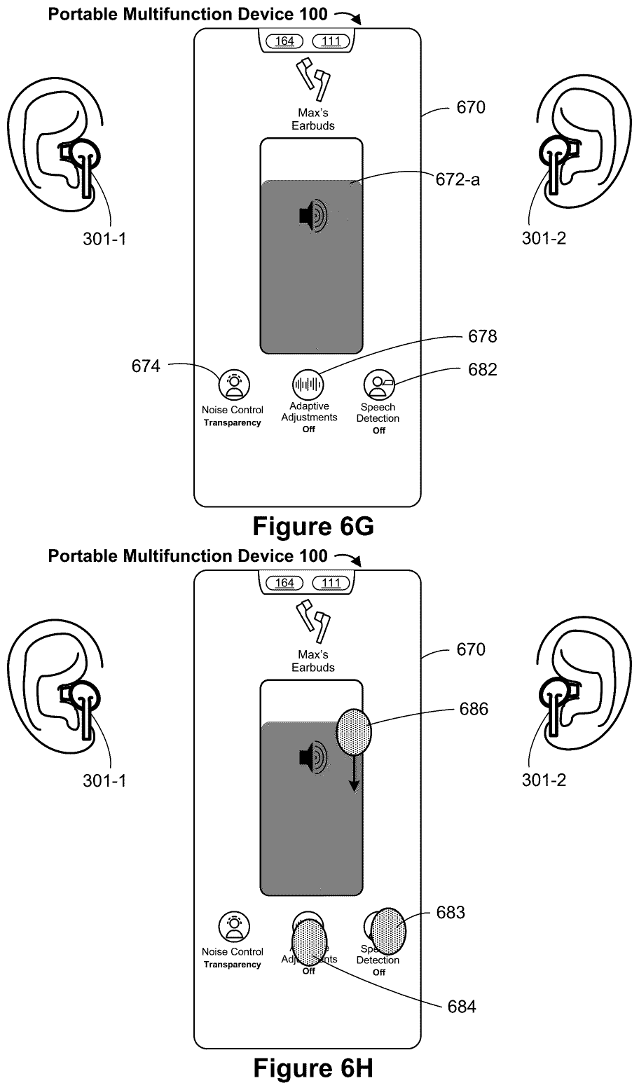

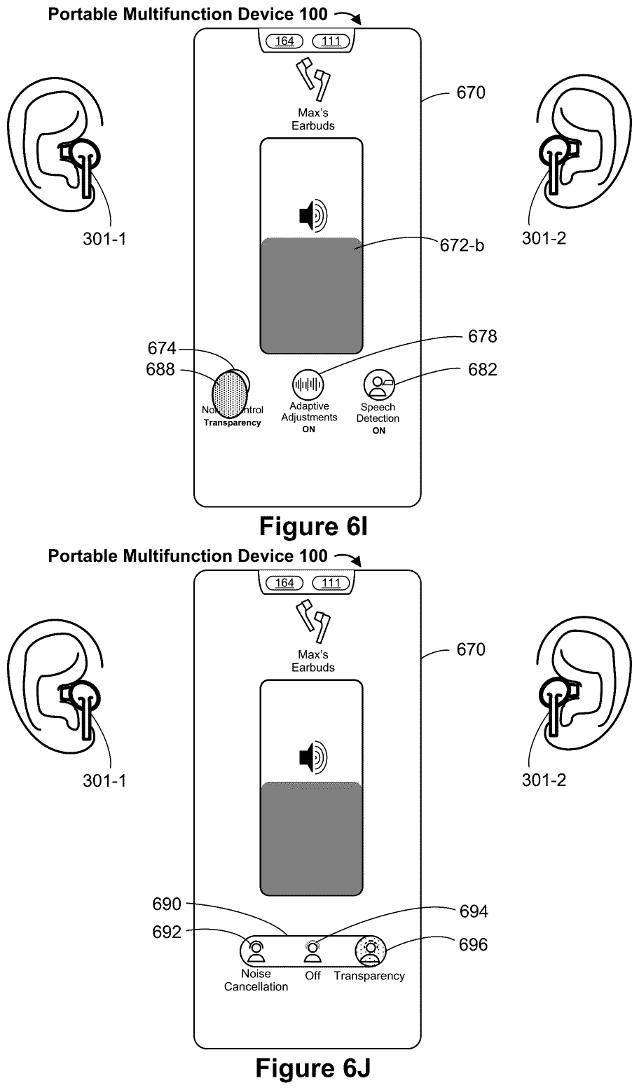

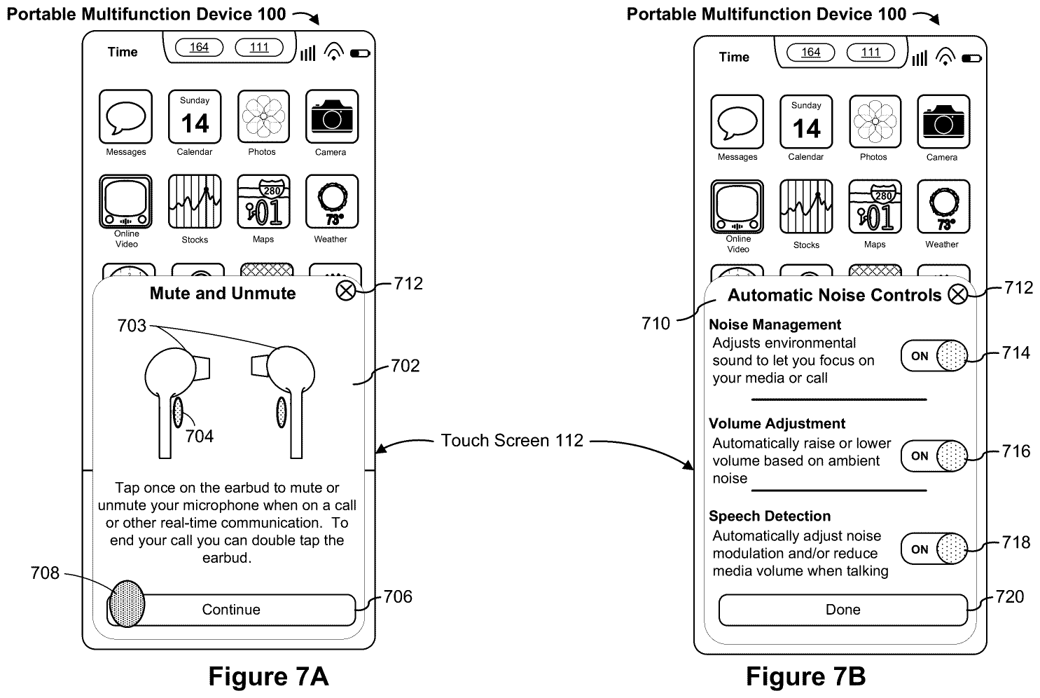

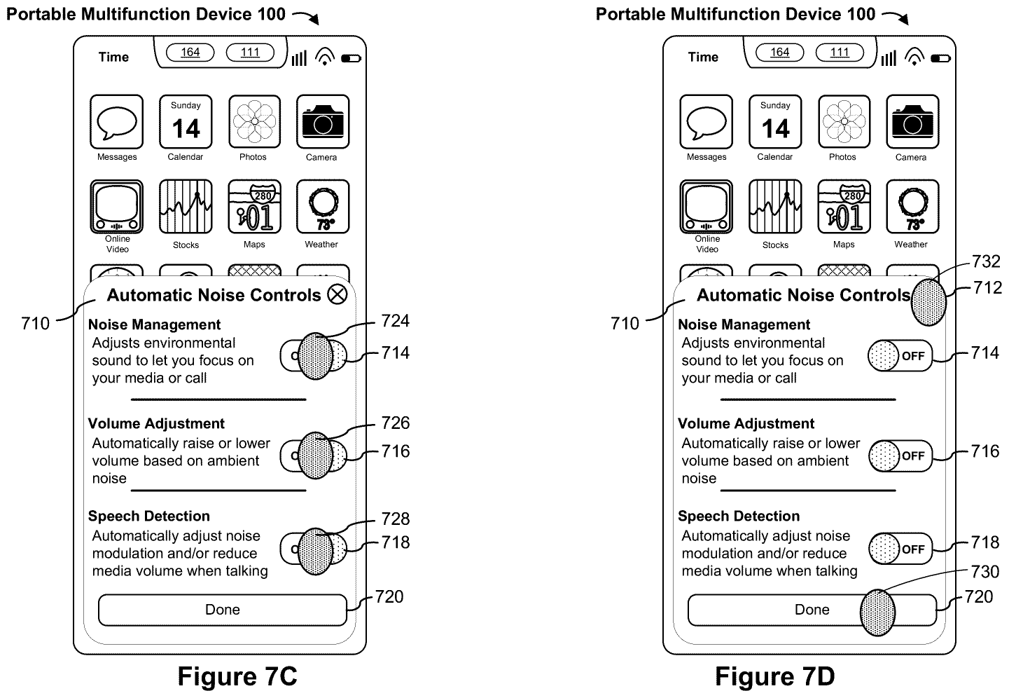

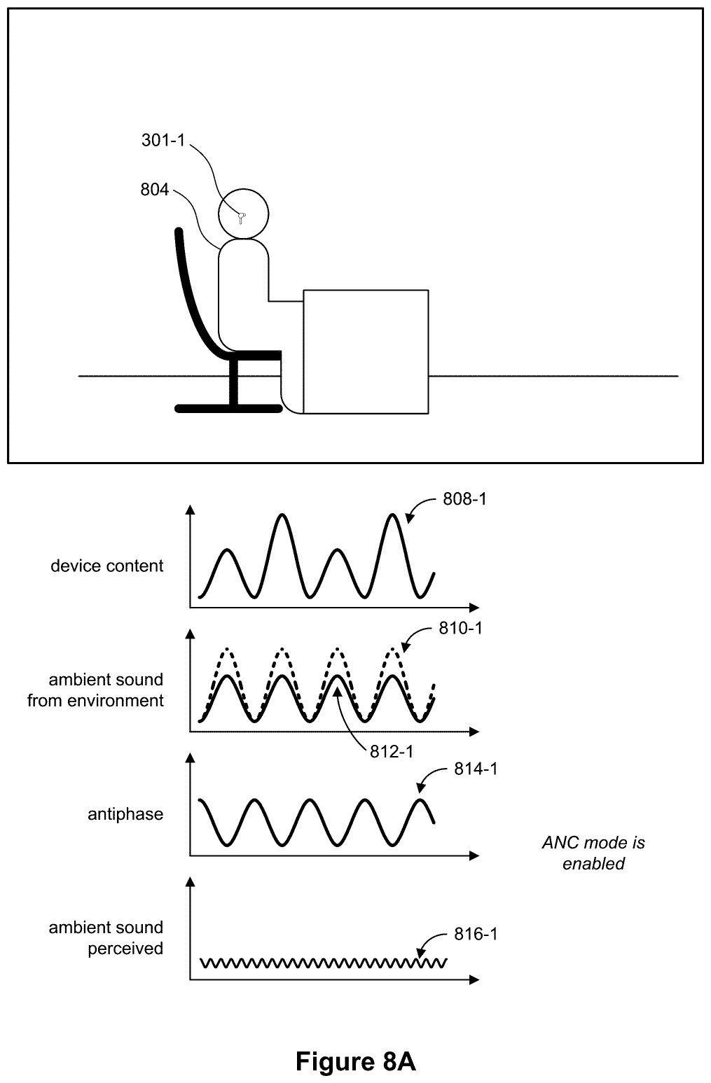

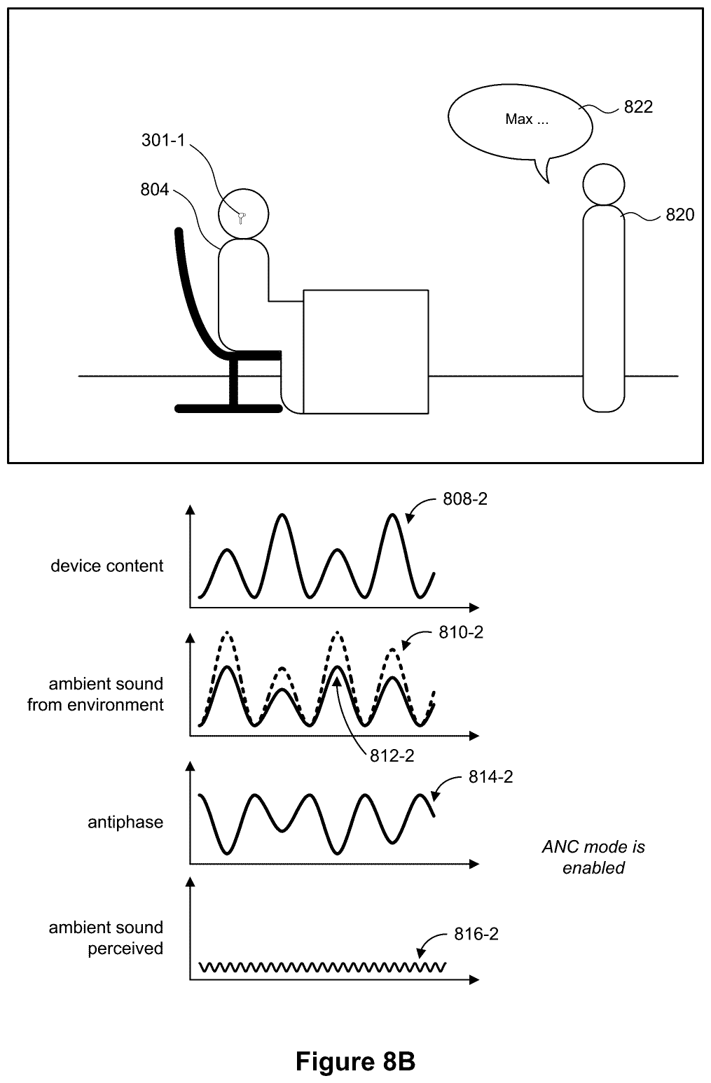

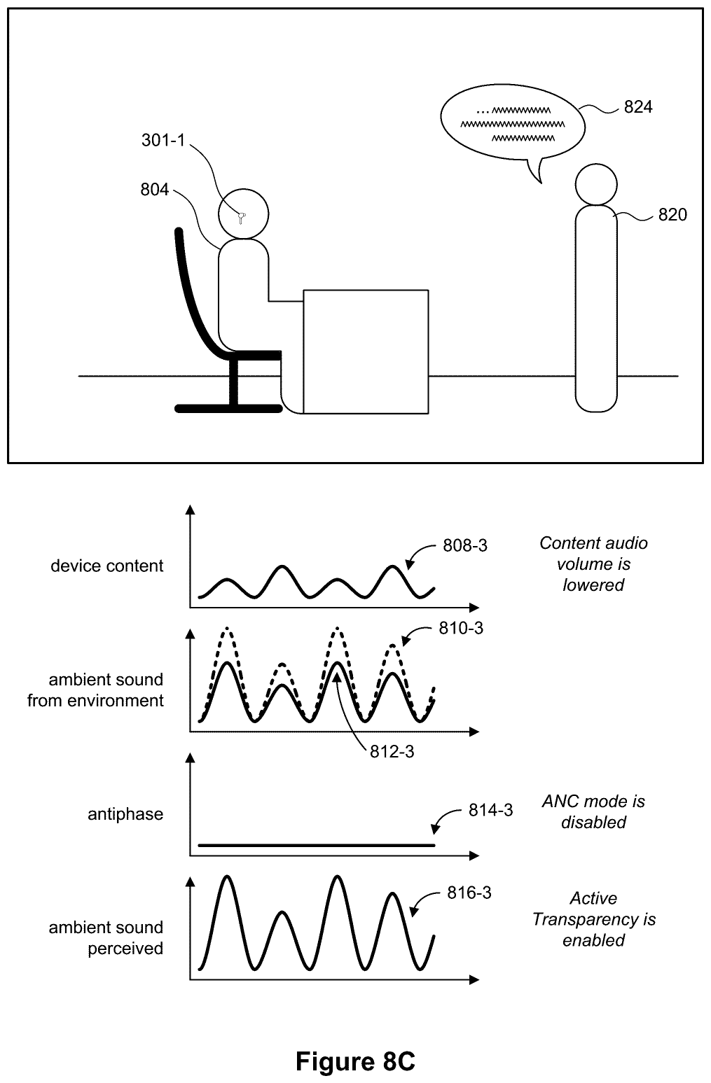

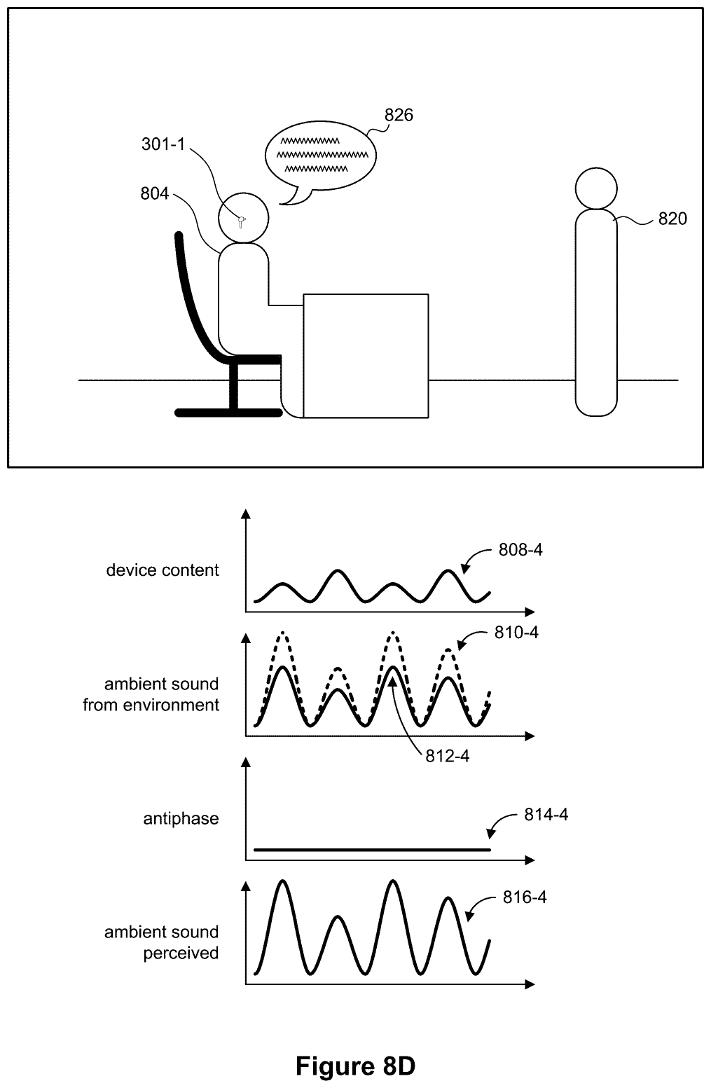

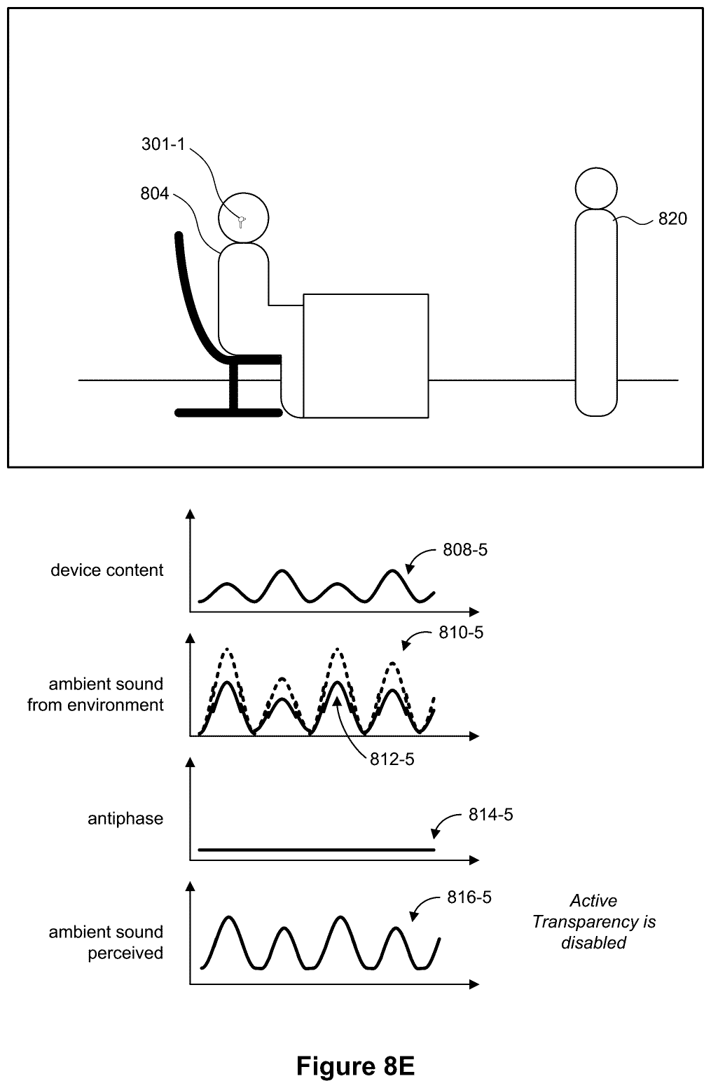

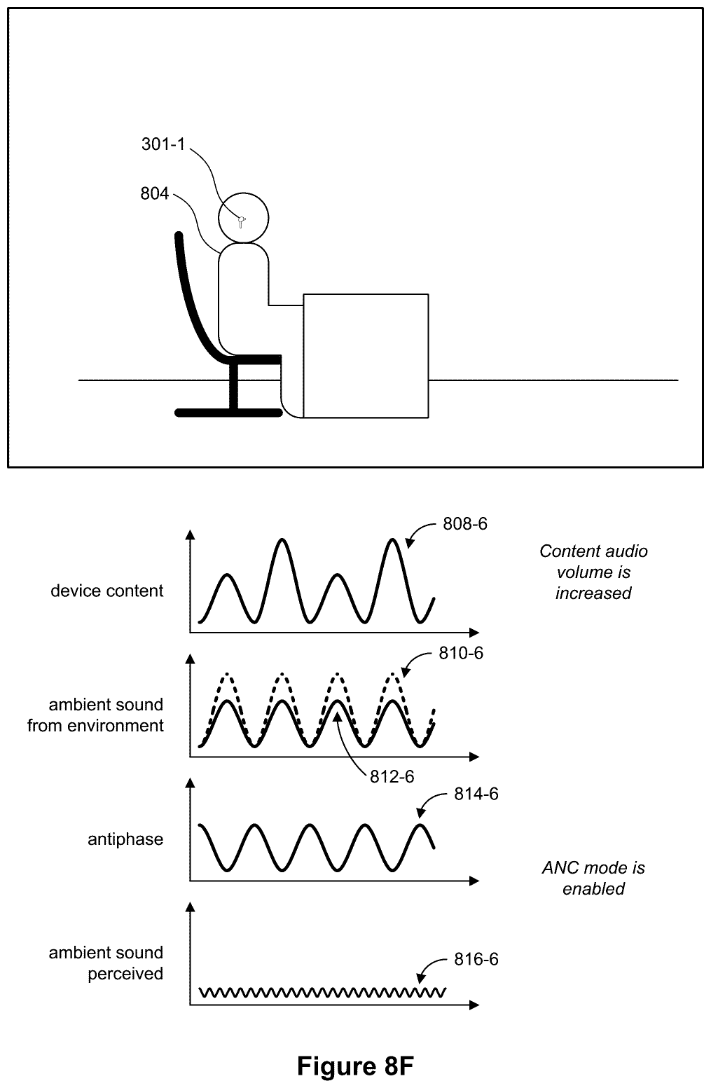

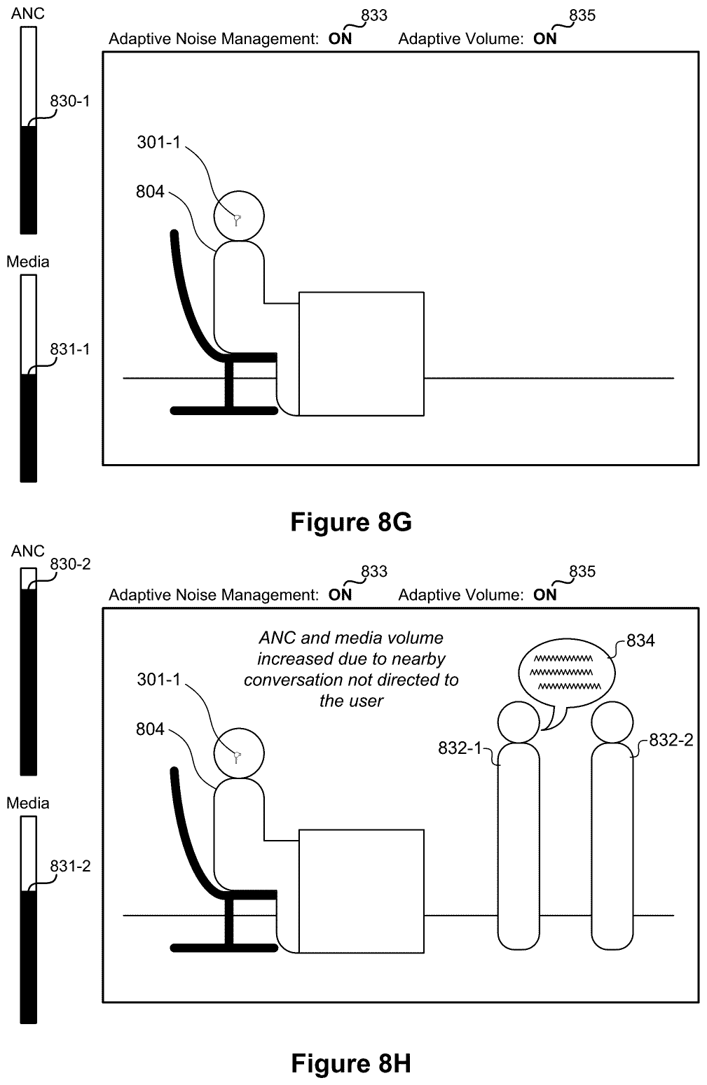

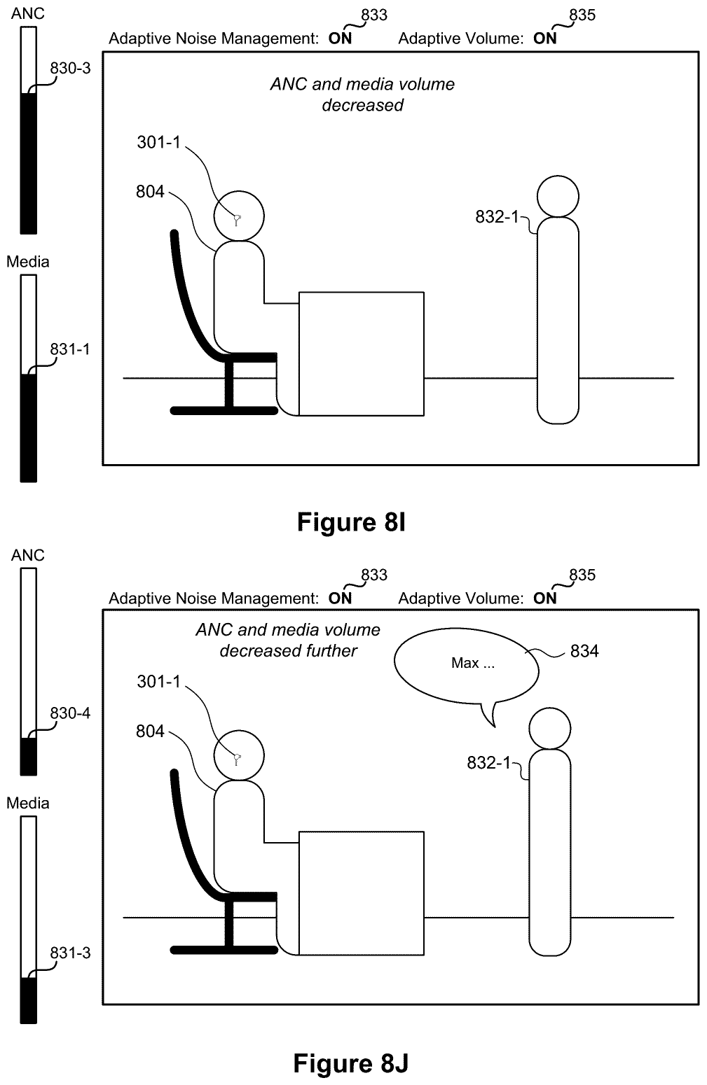

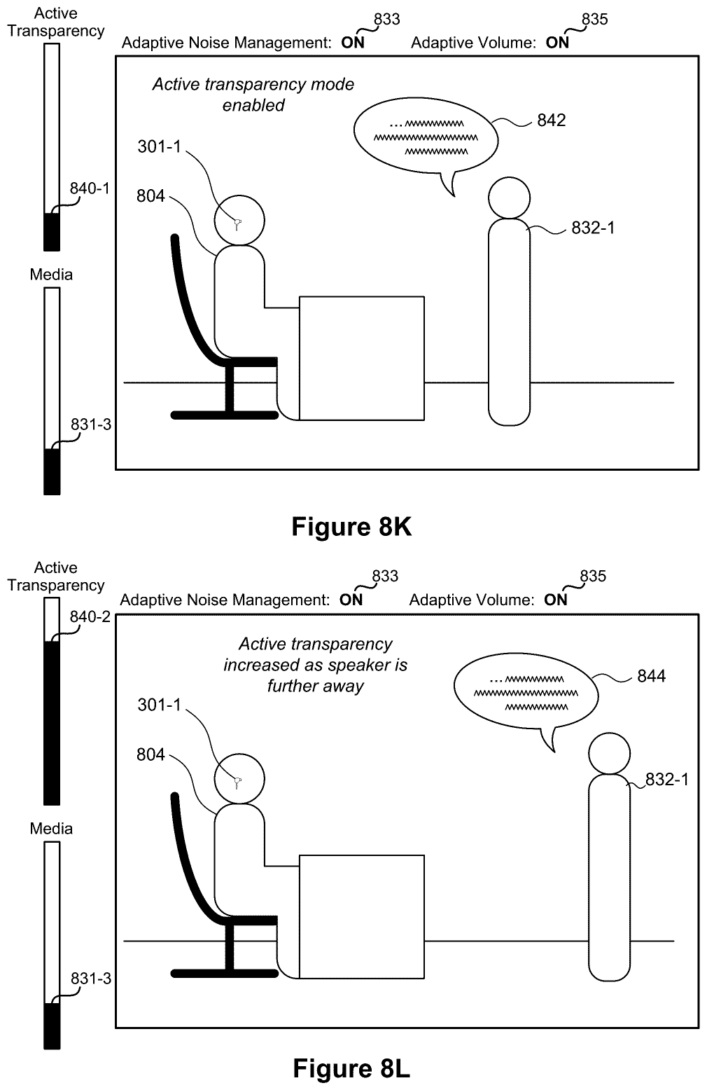

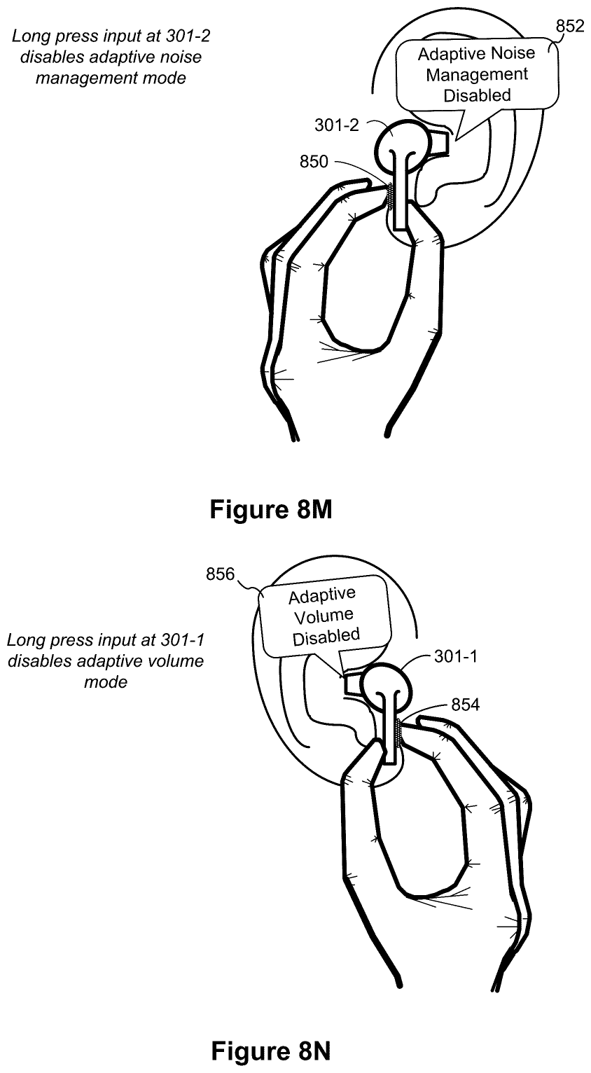

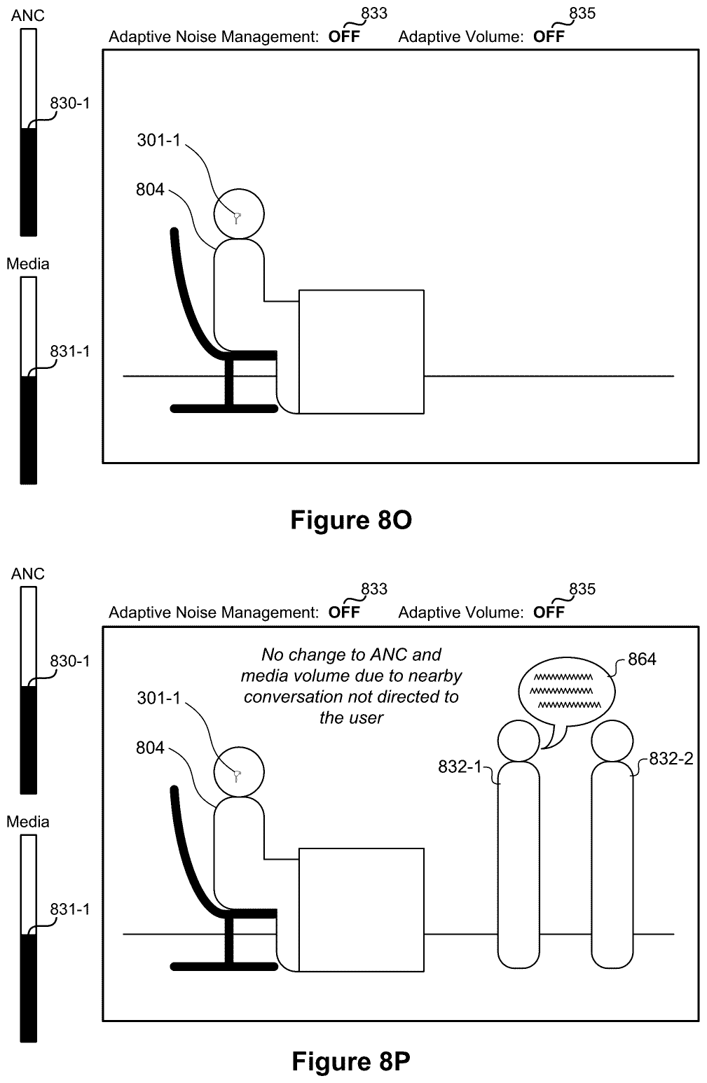

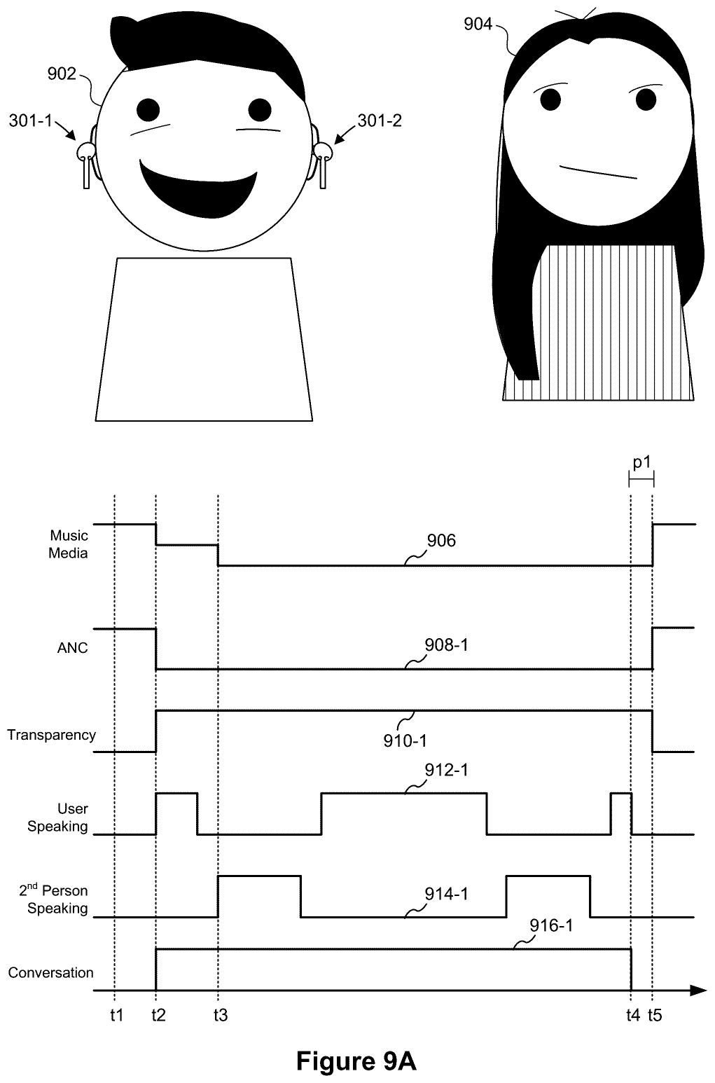

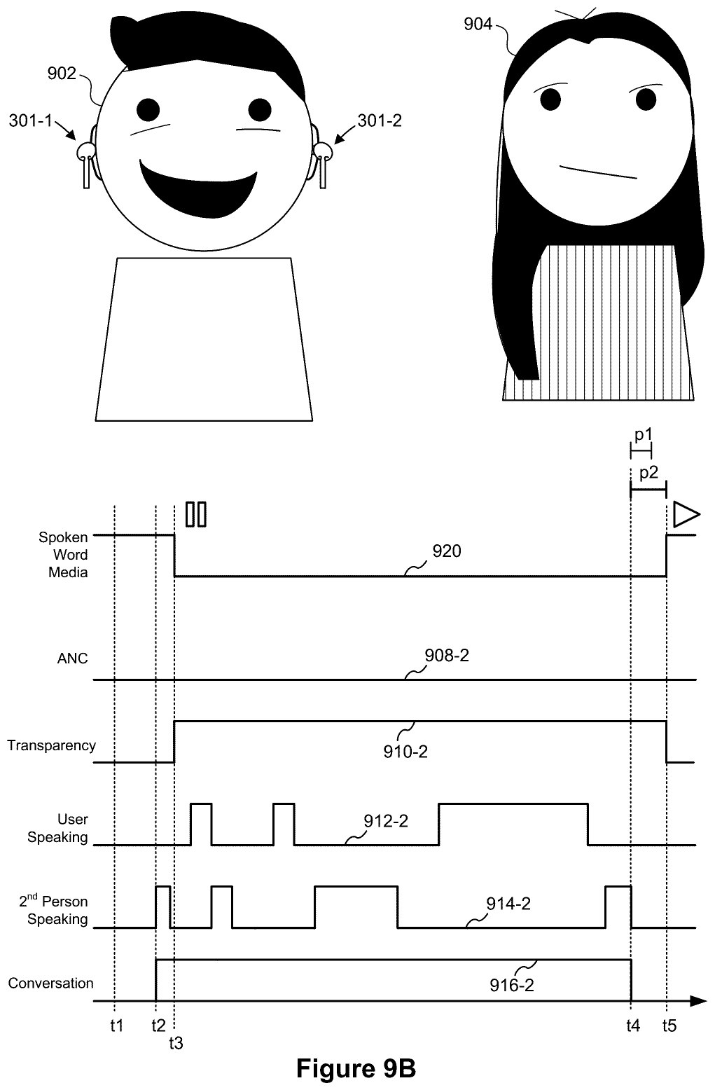

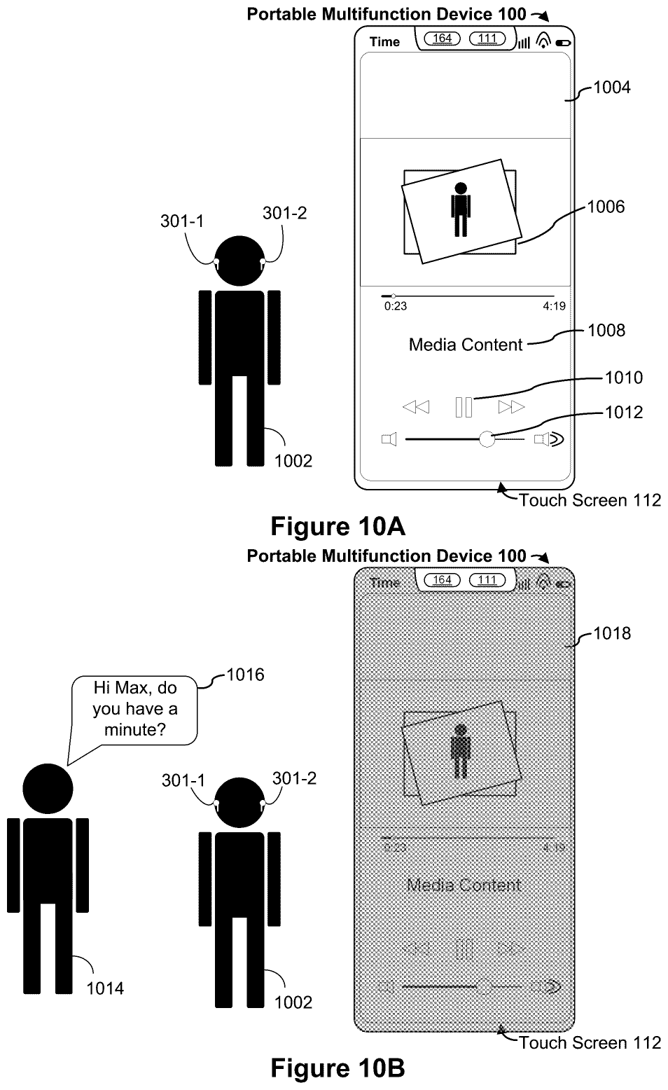

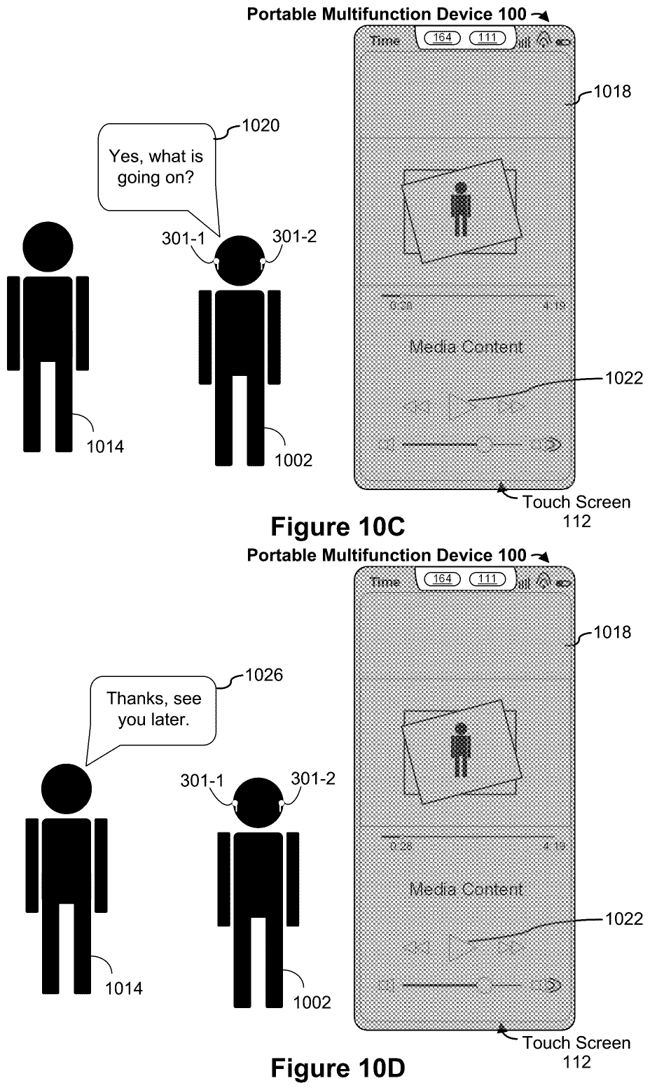

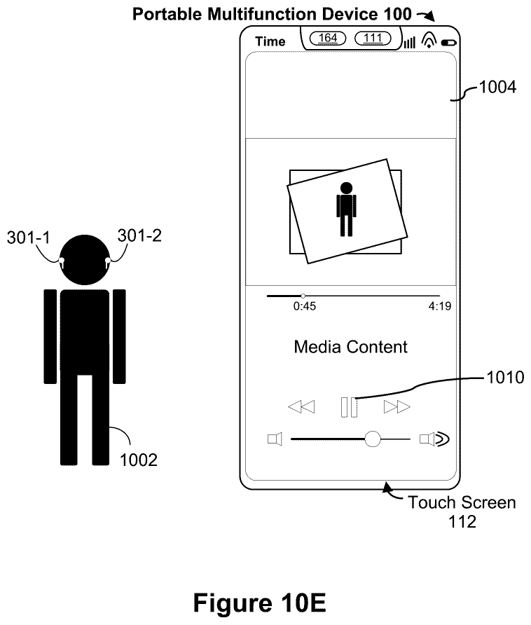

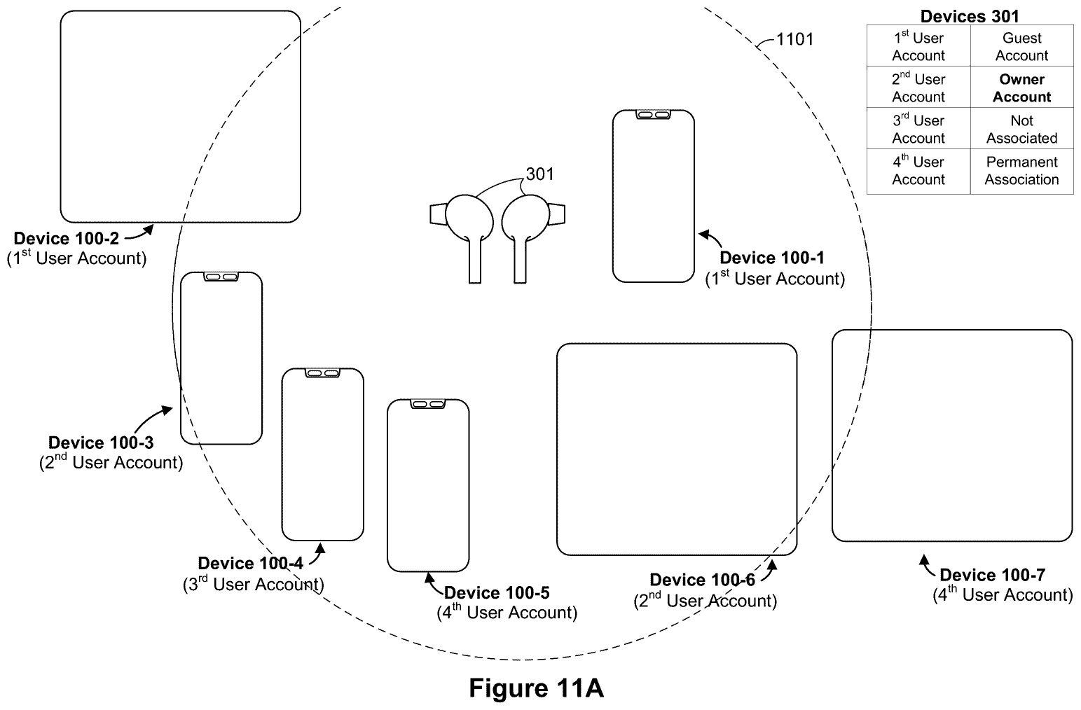

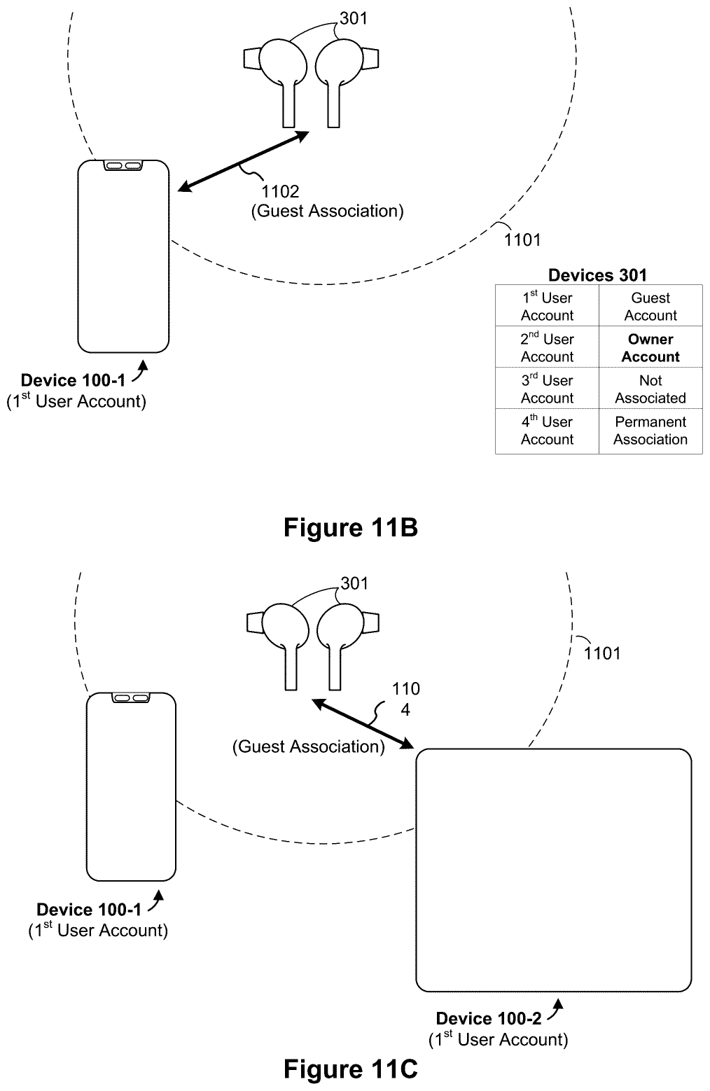

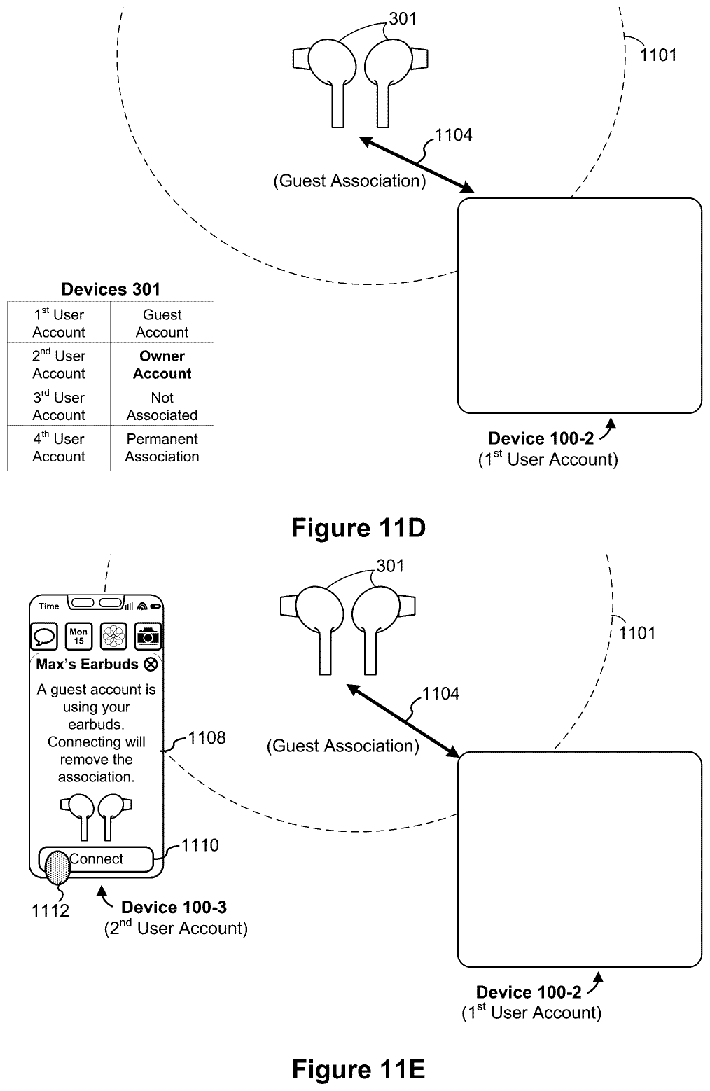

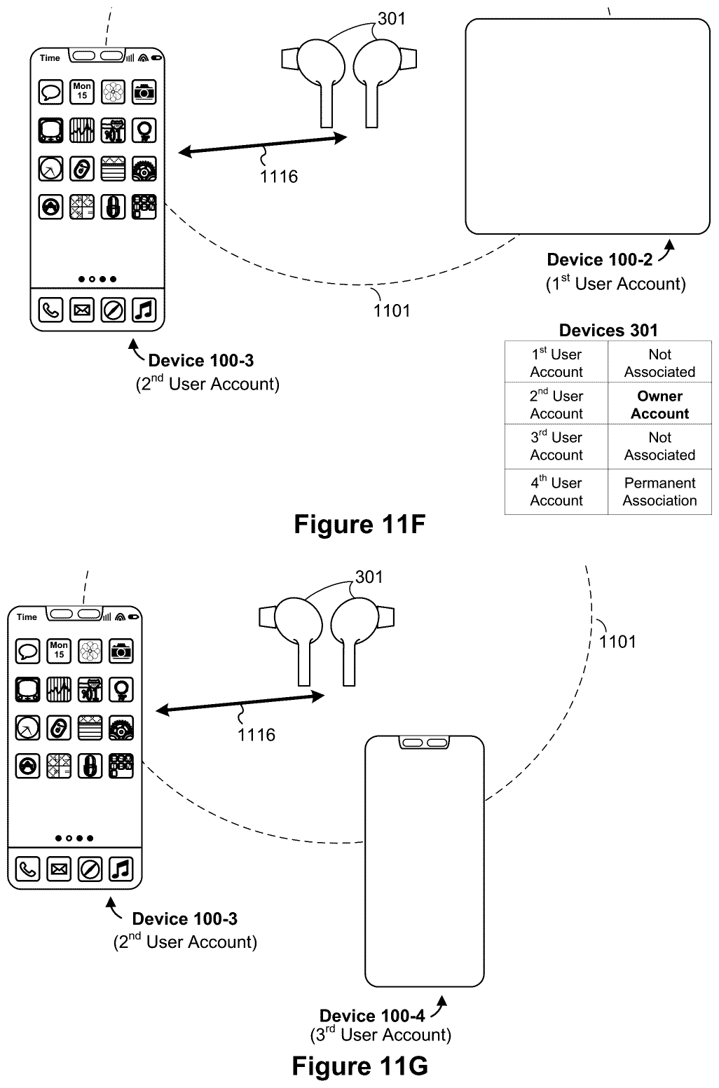

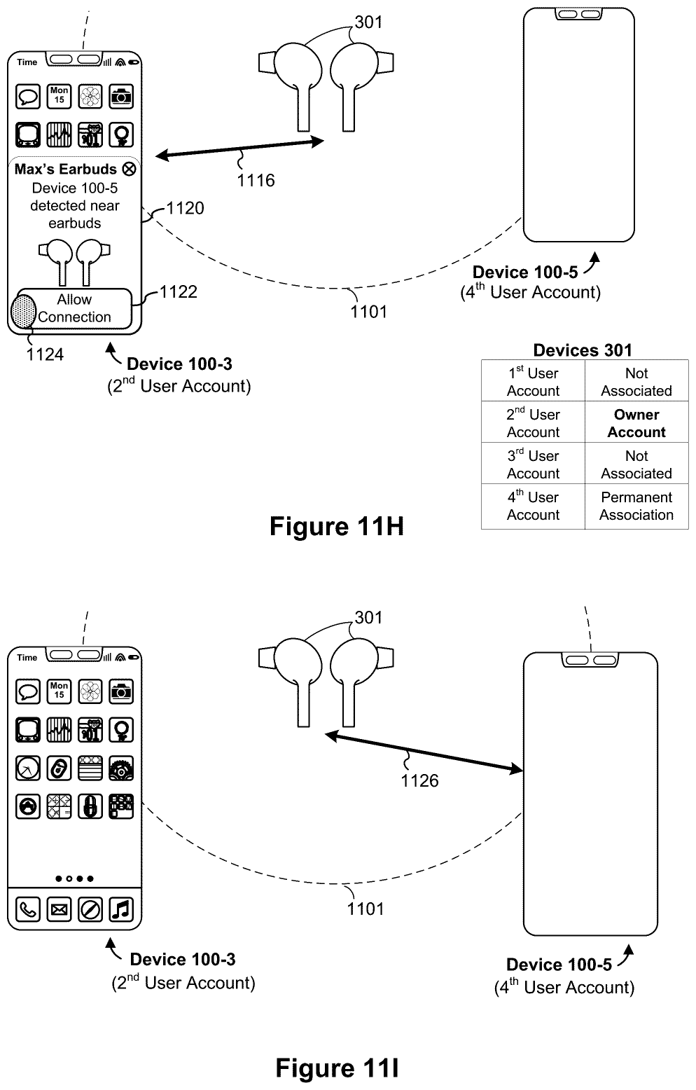

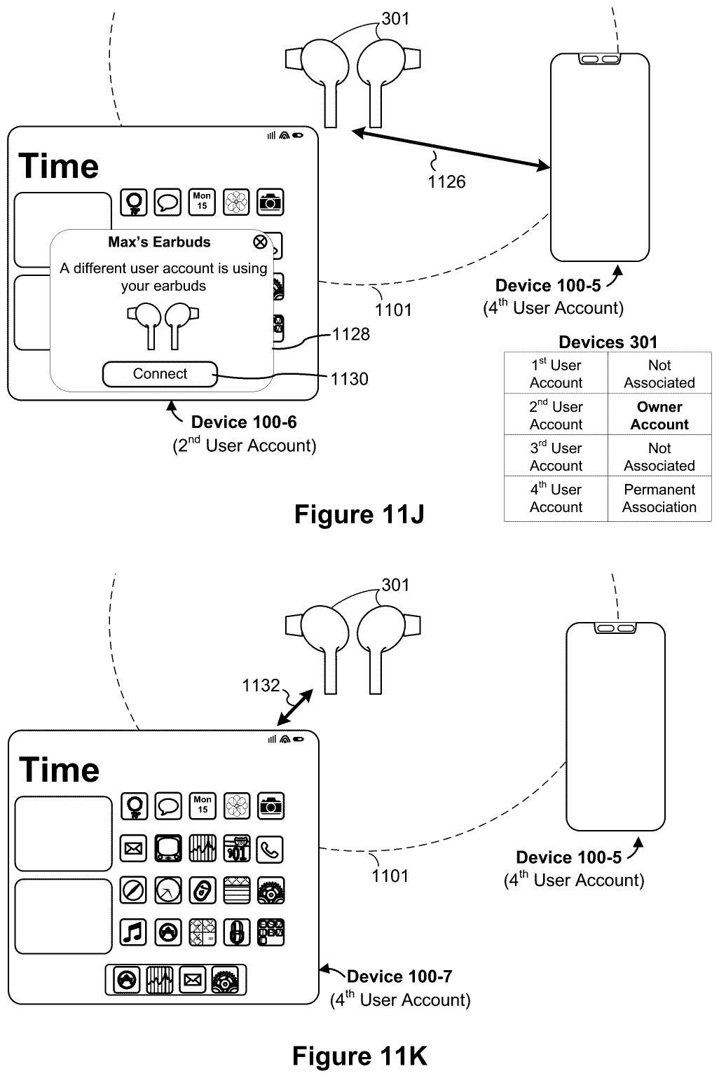

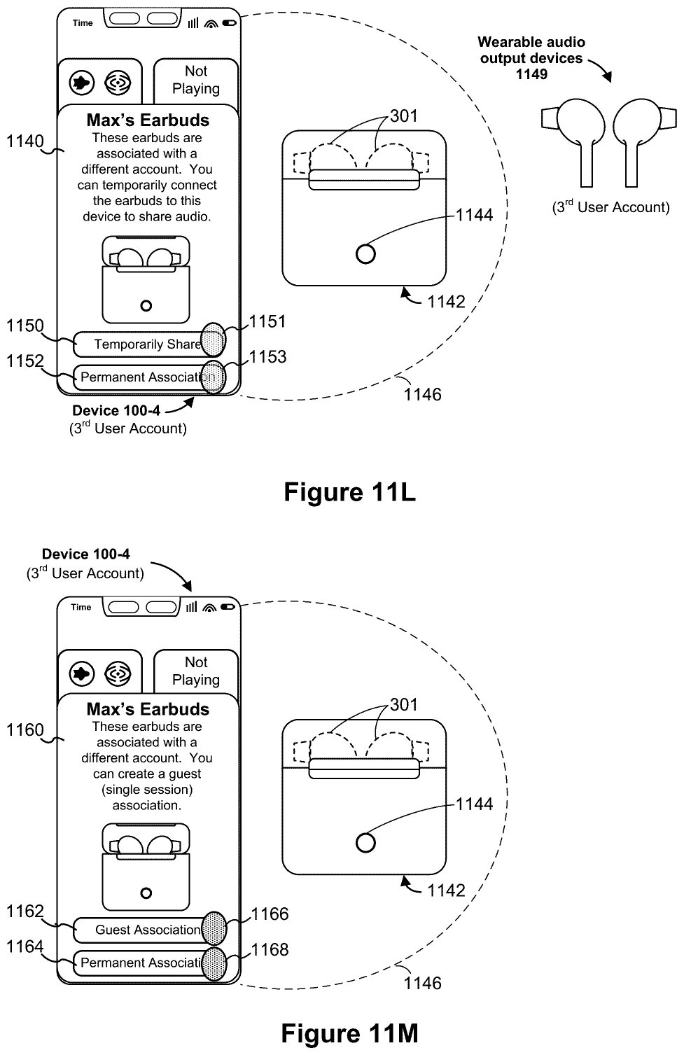

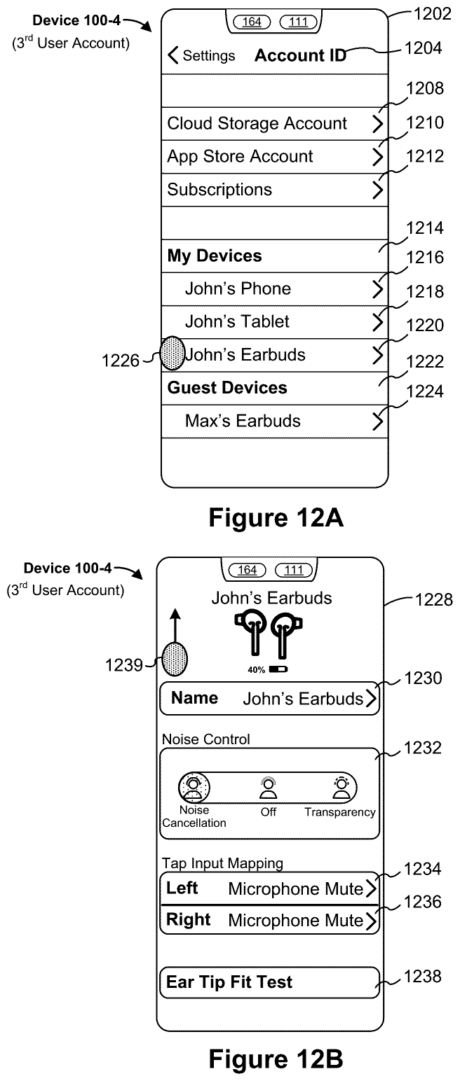

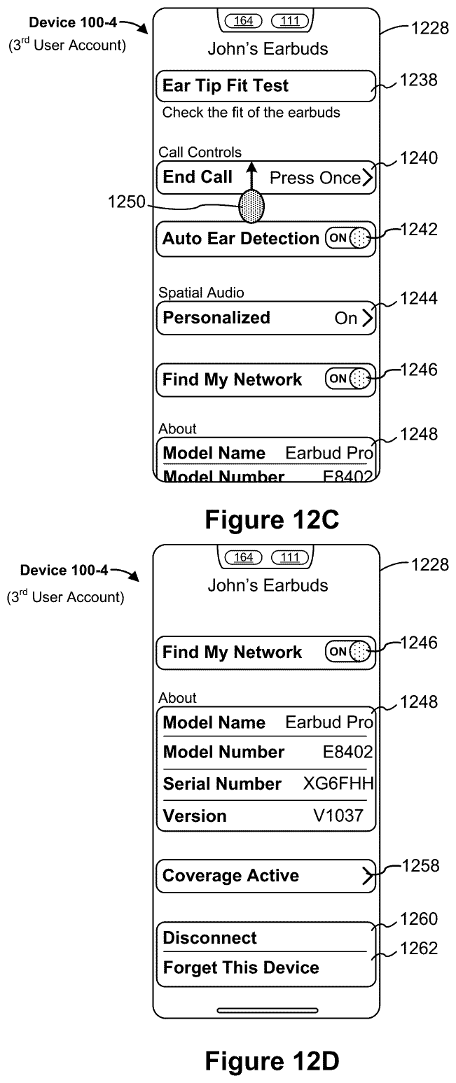

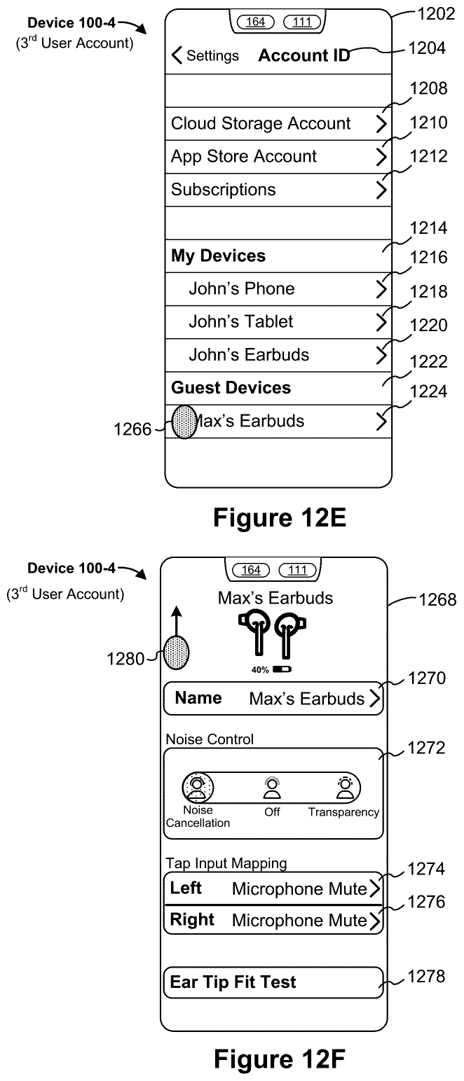

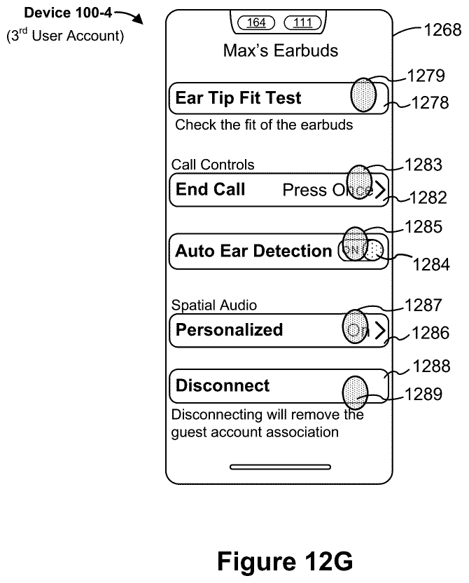

Below, FIGS. 1A-1B, 2, 3A-3D, and 4A-4B illustrate example devices. FIGS. 5A-5P illustrate example user interfaces and user interactions for adjusting microphone, and other operations, of wearable audio output devices. FIGS. 6A-6J and 7A-7D illustrate example user interfaces and user interactions for controlling various features associated with audio output devices. FIGS. 8A-8P illustrate example audio outputs with example changes in the audio properties of a surrounding physical environment. FIGS. 9A-9B illustrate example conversations and corresponding changes in the audio outputs of wearable audio output devices. FIGS. 10A-10E illustrate an example conversation and corresponding changes in the outputs of a multifunction device and wearable audio output devices. FIGS. 11A-11M illustrate example user interfaces, user interactions, and connectivity for audio output devices. FIGS. 12A-12G illustrate example user interfaces and user interactions corresponding to various associated audio output devices.

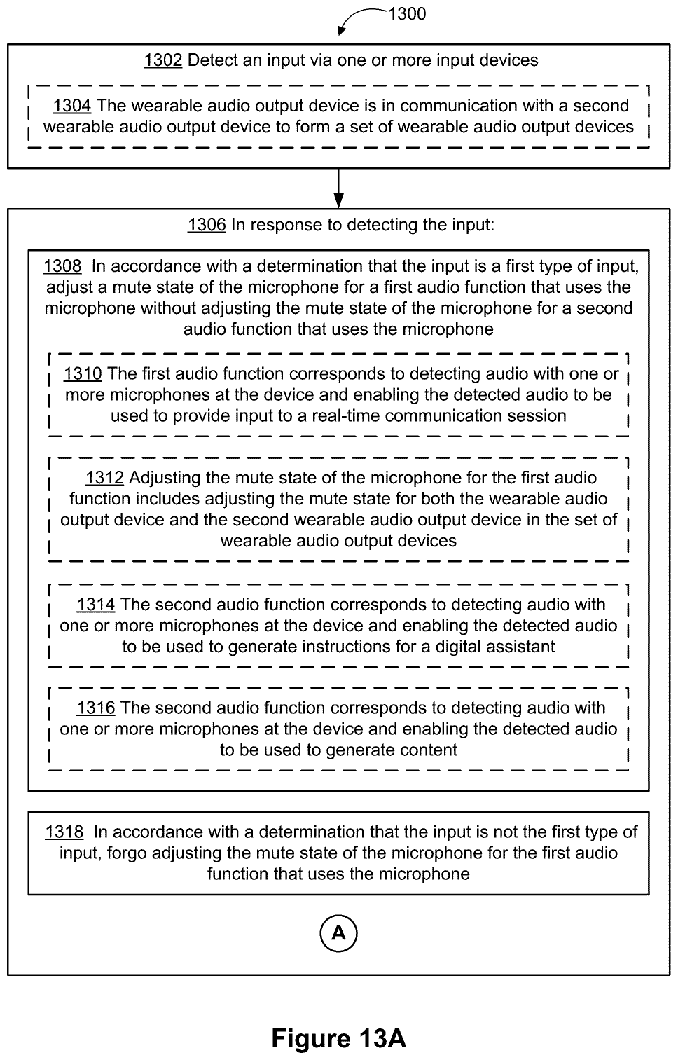

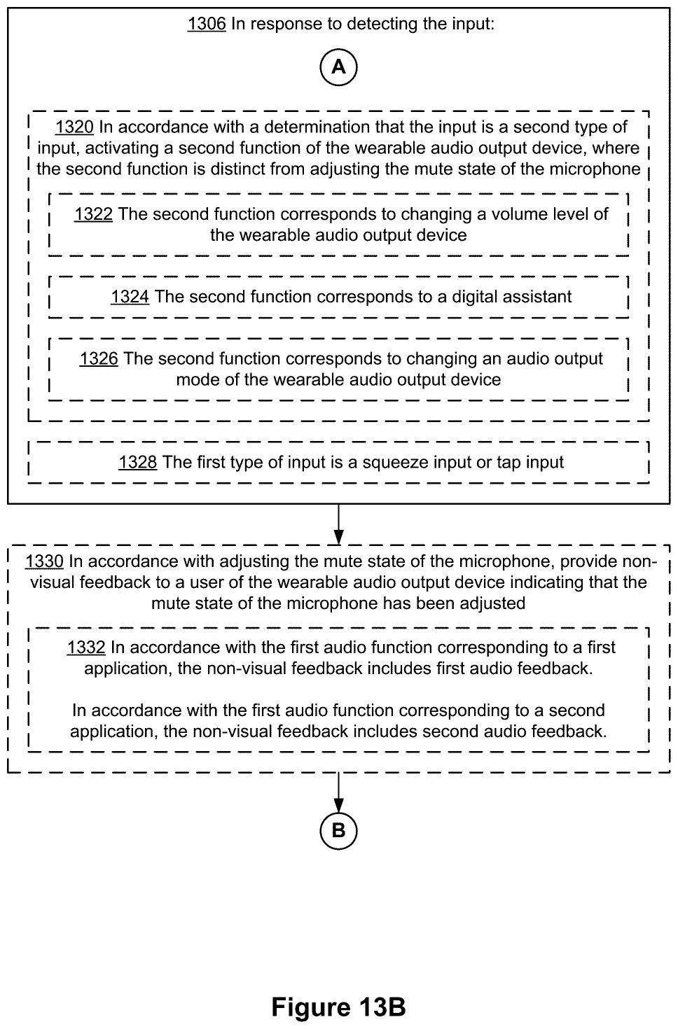

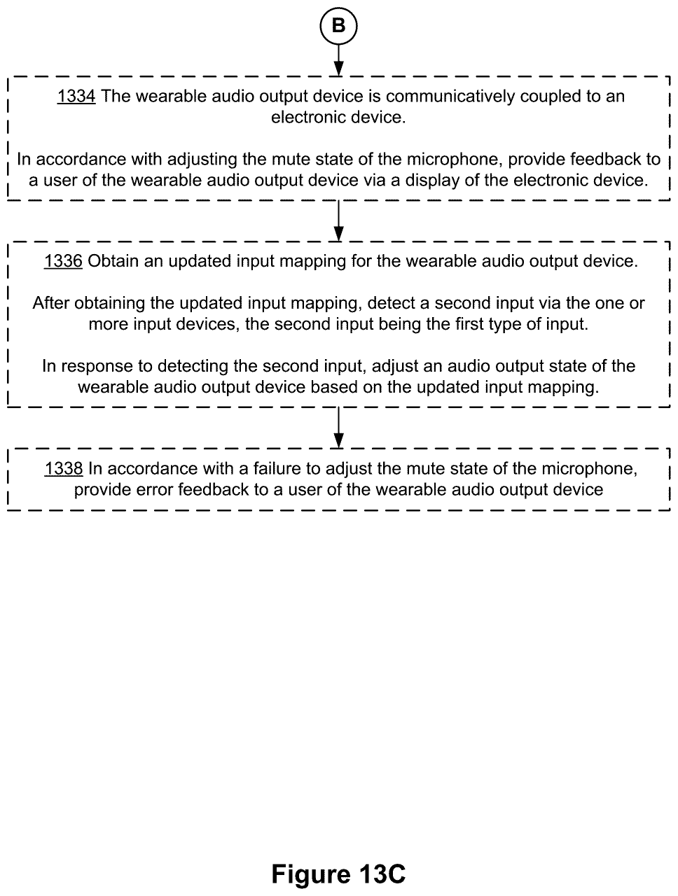

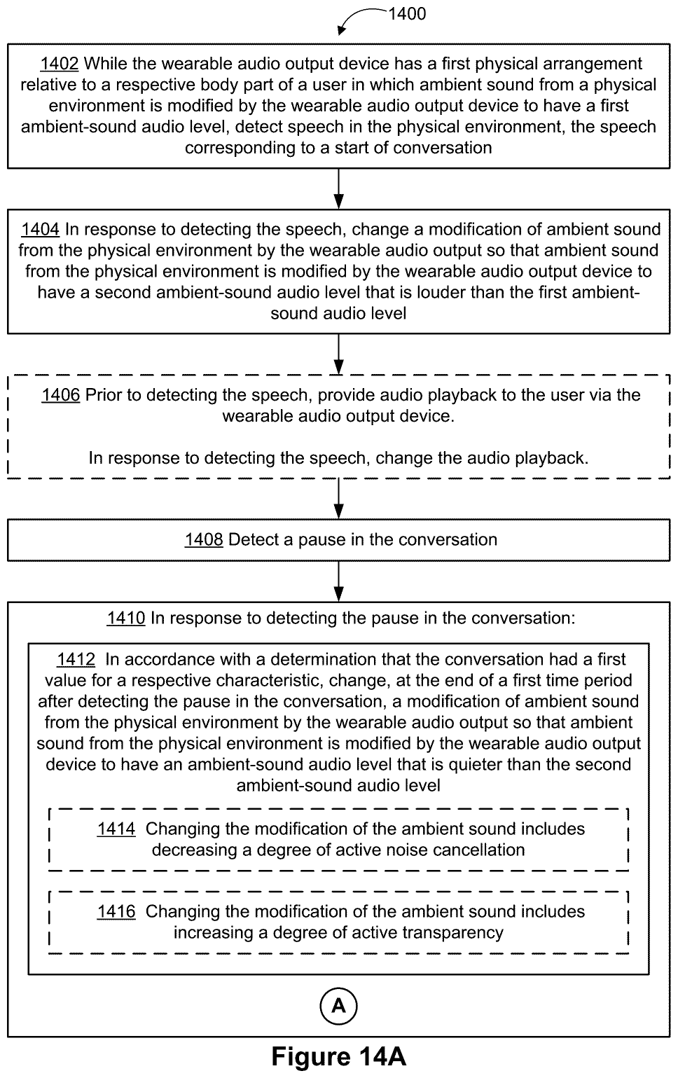

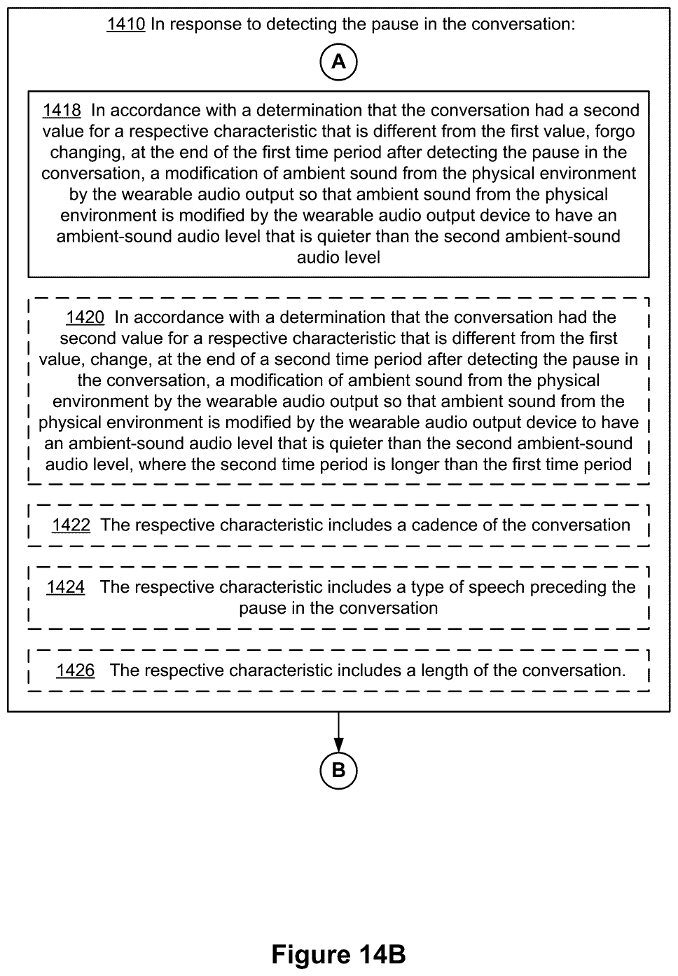

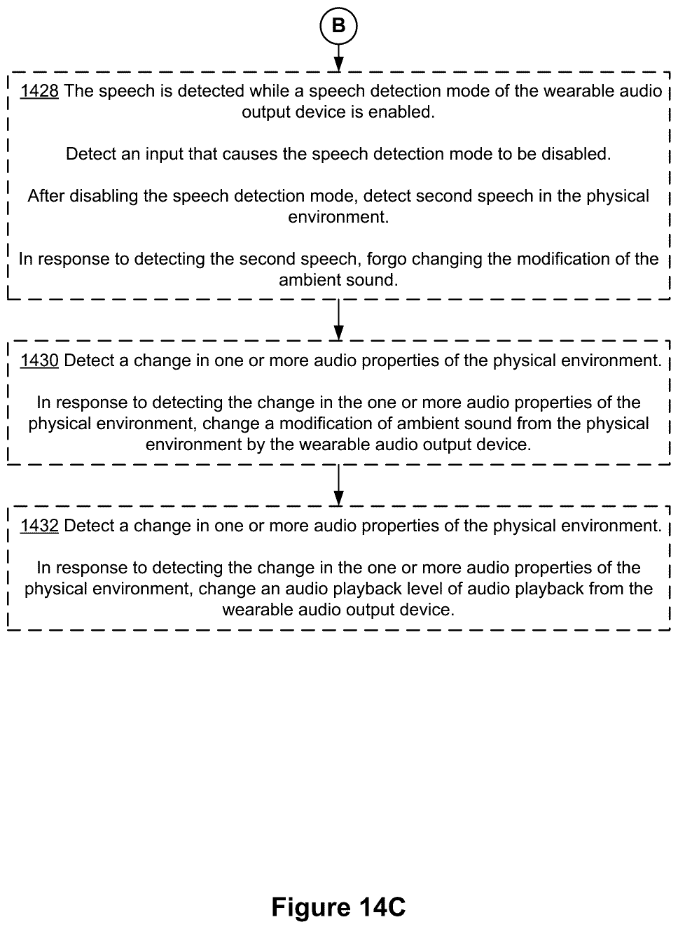

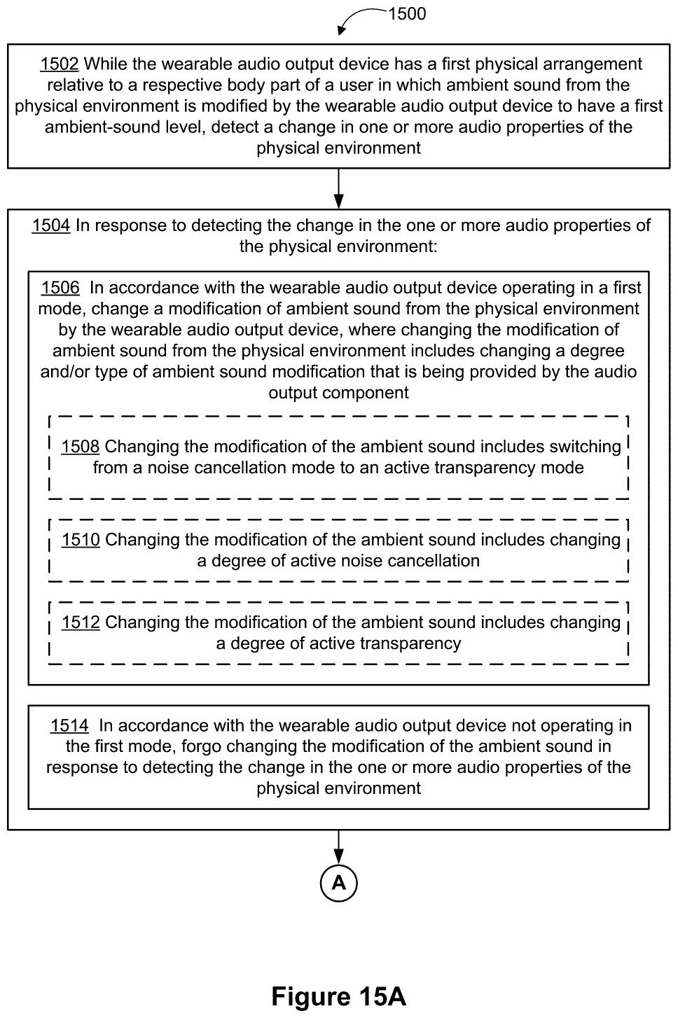

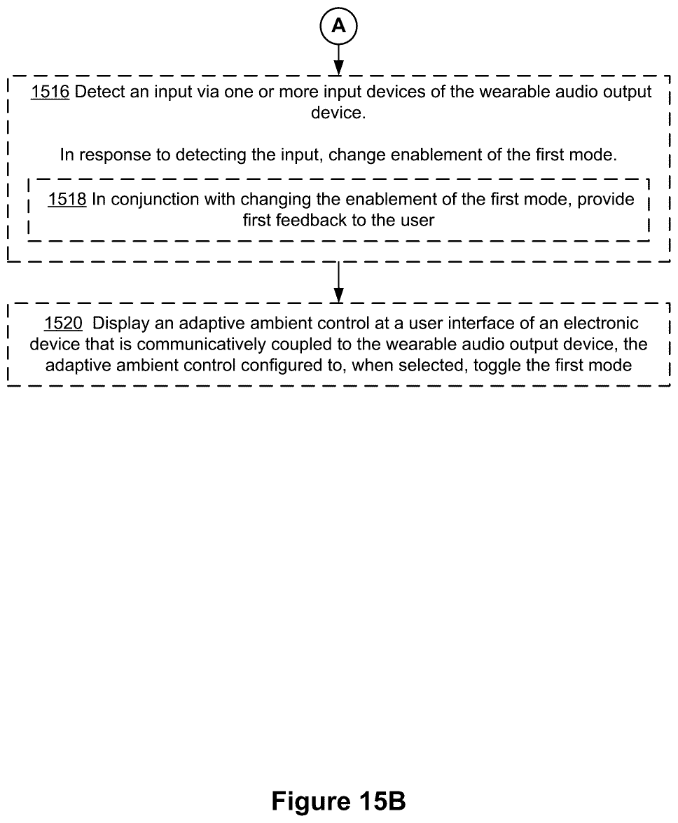

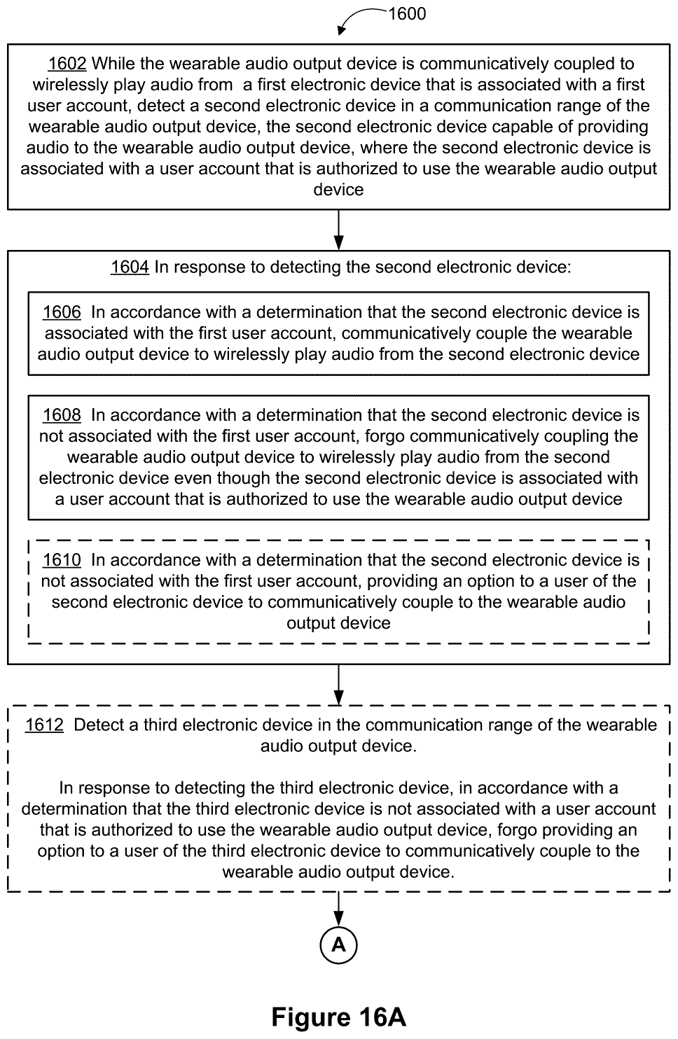

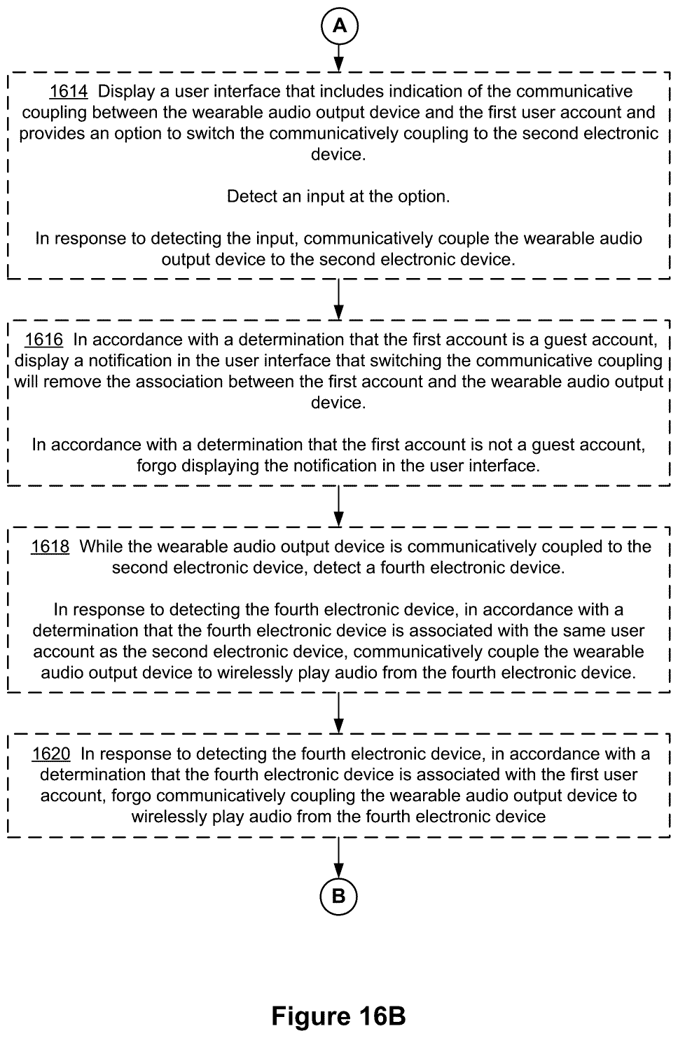

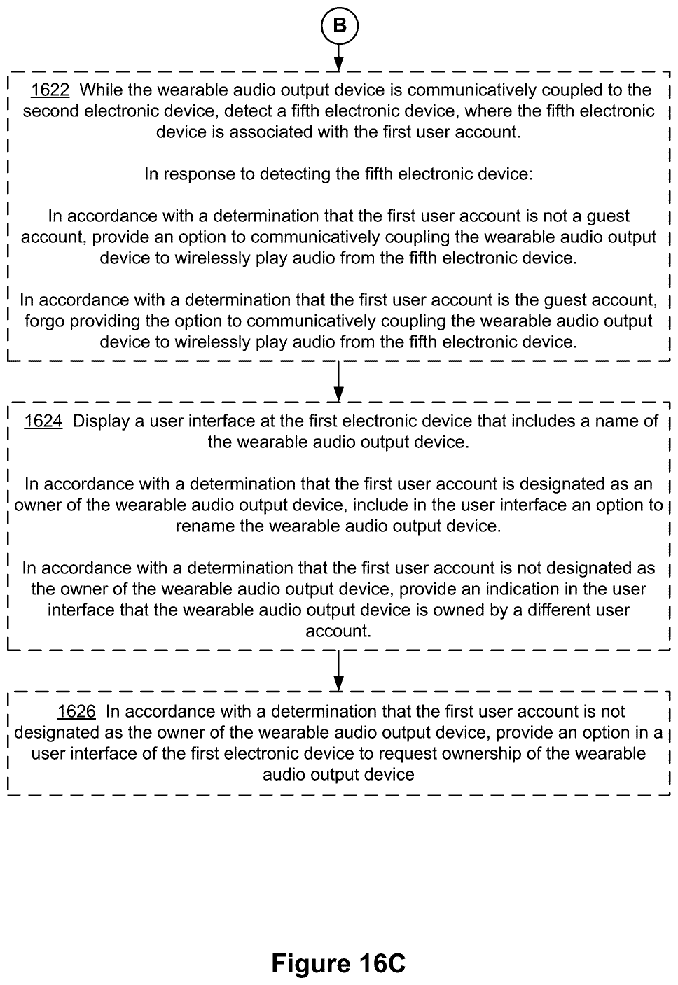

FIGS. 13A-13C are flow diagrams of a process for adjusting a mute state of a microphone of one or more wearable audio output devices. FIGS. 14A-14C are flow diagrams of a process for adaptively changing ambient sound audio levels in response to detected speech in the physical environment. FIGS. 15A-15B are flow diagrams of a process for adaptively changing modification of ambient sound audio levels in response to detected change in one or more audio properties of the physical environment. FIGS. 16A-16C are flow diagrams of a process for communicatively coupling a wearable audio output device with authorized electronic devices.

The user interfaces and device interactions in FIGS. 5A-5P, 6A-6J, 7A-7D, 8A-8P, 9A-9B, 10A-10E, 11A-11M, and 12A-12G are used to illustrate the processes in FIGS. 13A-13C, 14A-14C, 15A-15B, and 16A-16C.

### EXAMPLE DEVICES

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random-access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

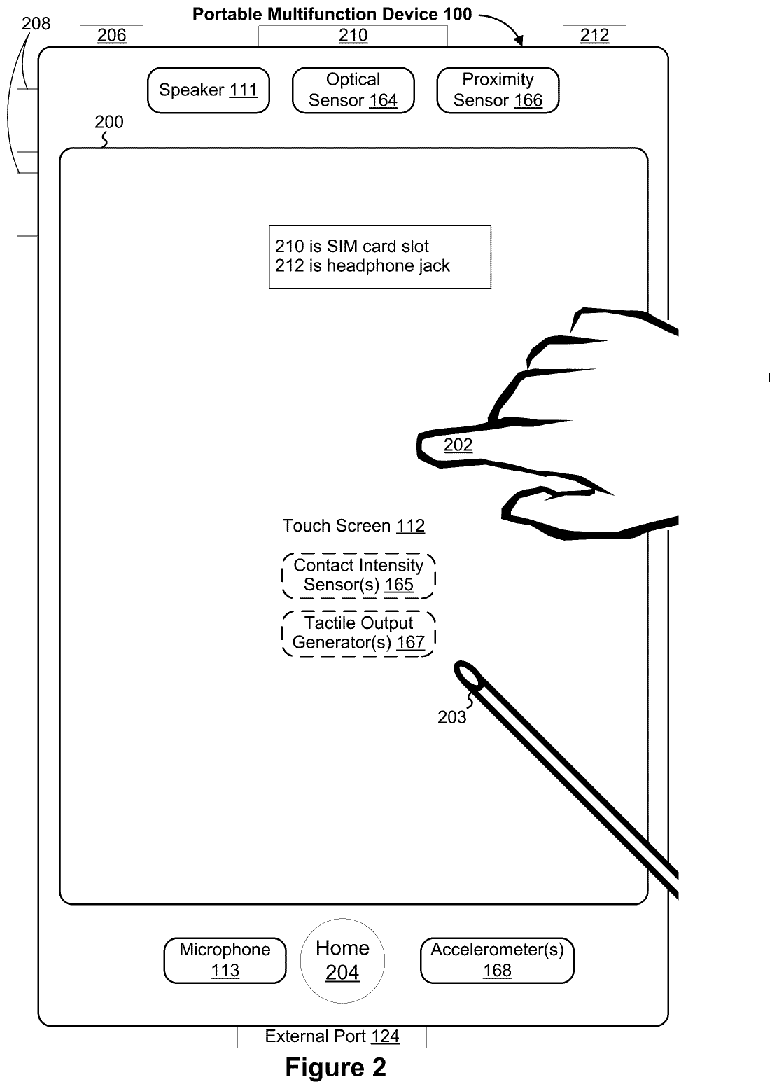

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's car (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

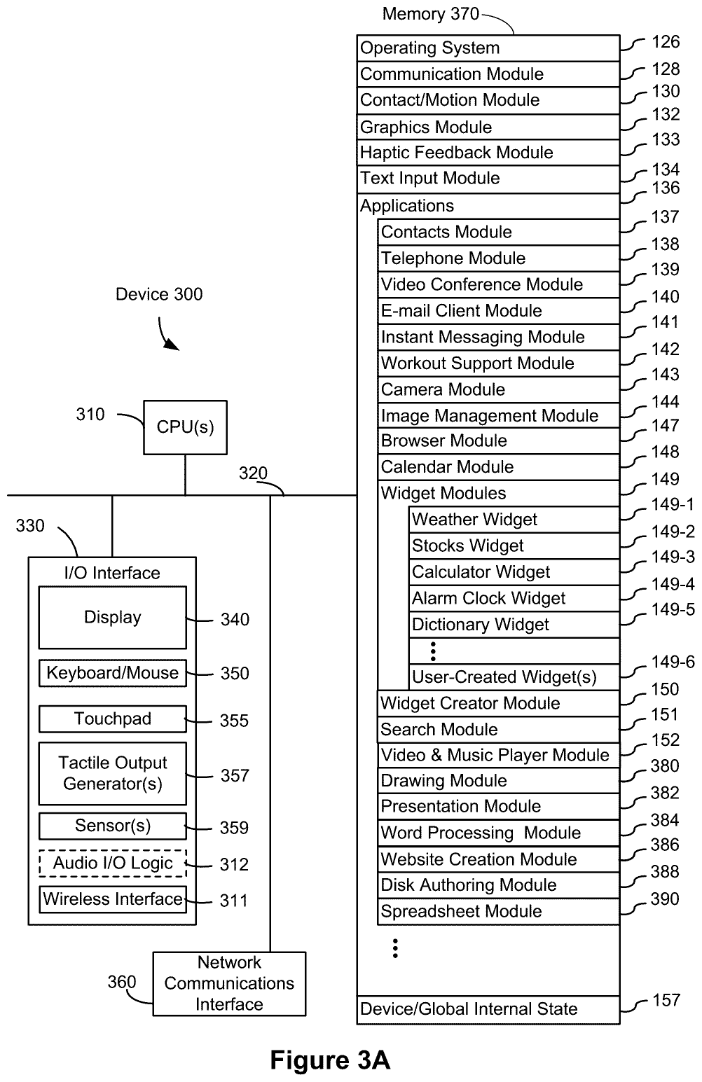

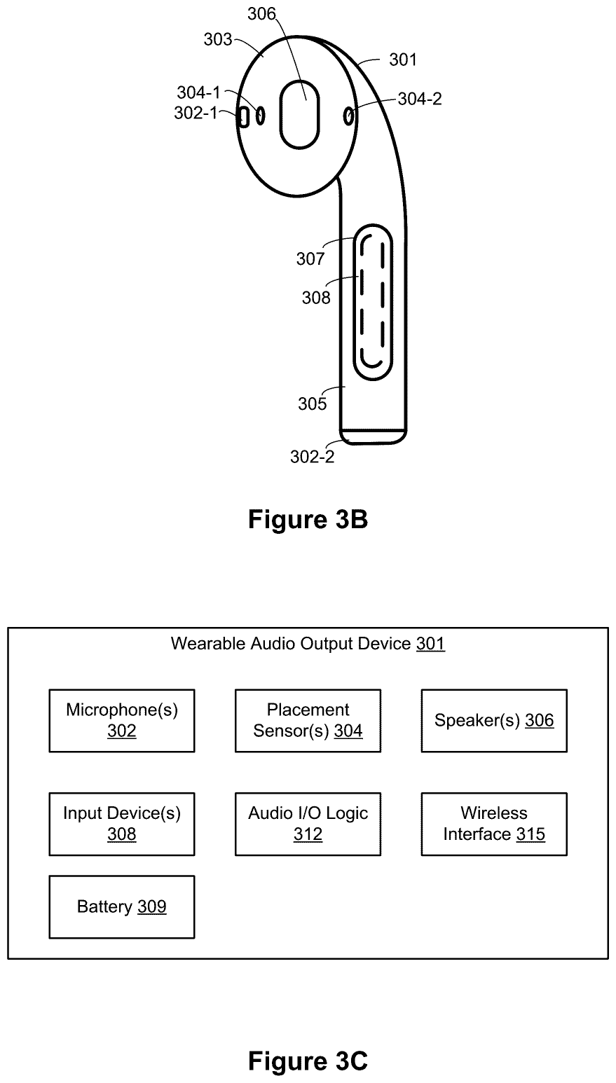

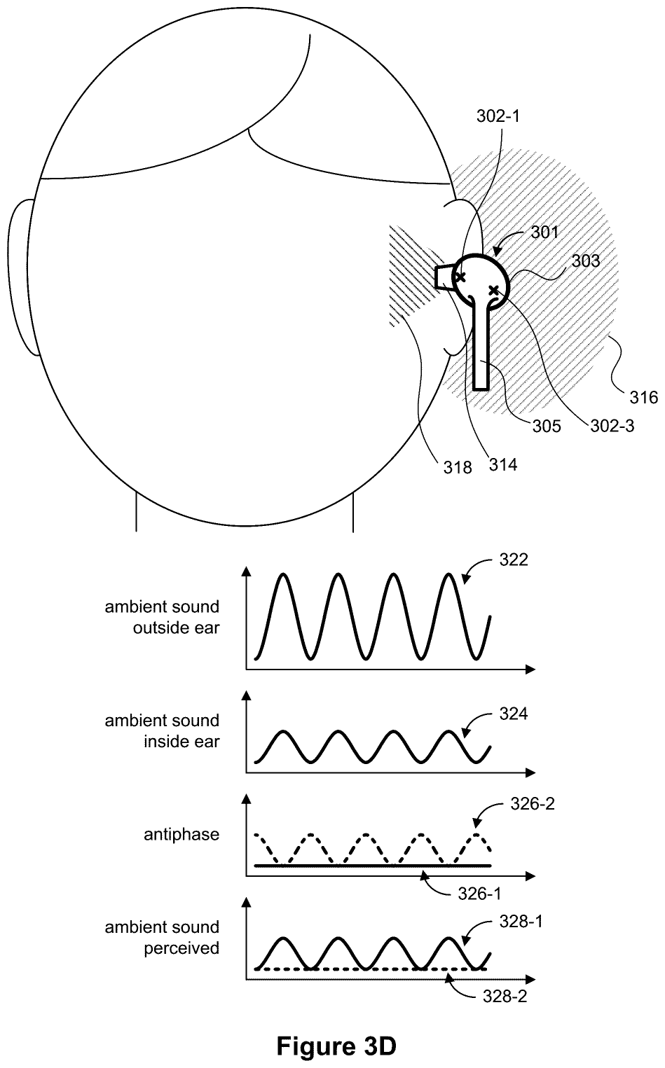

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as Vx Works) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture-which do not require that the intensity of the contact(s) meet a respective intensity threshold in order for the first gesture recognition criteria to be met—are in competition with second gesture recognition criteria for a second gesture-which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone module 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or.
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference 139, e-mail 140, or IM 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on touch-sensitive display system 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (FIG. 3) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher-level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancelation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event-to-event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3A is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). In some embodiments, device 300 includes a wireless interface 311 for communication with one or more wearable audio output devices 301. In some embodiments, device 300 includes a network communications interface 360 for communication with remote devices (e.g., in conjunction with communication module 128).

Memory 370 includes high-speed random-access memory, such as DRAM, SRAM, DDR RAM or other random access solid-state memory devices; and optionally includes non-volatile memory, such as one or more magnetic disk storage devices, optical disk storage devices, flash memory devices, or other non-volatile solid-state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A are, optionally, stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

FIG. 3B illustrates physical features of an example wearable audio output device 301 in accordance with some embodiments. In some embodiments, the wearable audio output device 301 is one or more in-ear earphone(s), earbud(s), over-ear headphone(s), or the like. In the example of FIG. 3B, wearable audio output device 301 is an earbud. In some embodiments, wearable audio output device 301 includes a head portion 303 and a stem portion 305. In some embodiments, head portion 303 is configured to be inserted into a user's ear. In some embodiments, stem portion 305 physically extends from head portion 303 (e.g., is an elongated portion extending from head portion 303). For example, head portion 303 physically extends downward, in front of, and/or past a user's earlobe while head portion 303 is inserted into a user's ear.

In some embodiments, wearable audio output device 301 includes one or more audio speakers 306 (e.g., in head portion 303) for providing audio output (e.g., to a user's ear). In some embodiments, wearable audio output device 301 includes one or more placement sensors 304 (e.g., placement sensors 304-1 and 304-2 in head portion 303) to detect positioning or placement of wearable audio output device 301 relative to a user's ear, such as to detect placement of wearable audio output device 301 in a user's ear.

In some embodiments, wearable audio output device 301 includes one or more microphones 302 for receiving audio input. In some embodiments, one or more microphones 302 are included in head portion 303 (e.g., microphone 302-1). In some embodiments, one or more microphones 302 are included in stem portion 305 (e.g., microphone 302-2). In some embodiments, microphone(s) 302 detect speech from a user wearing wearable audio output device 301 and/or ambient noise around wearable audio output device 301. In some embodiments, multiple microphones of microphones 302 are positioned at different locations on wearable audio output device 301 to measure speech and/or ambient noise at different locations around wearable audio output device 301.

In some embodiments, wearable audio output device 301 includes one or more input devices 308 (e.g., in stem portion 305). In some embodiments, input device(s) 308 includes a pressure-sensitive (e.g., intensity-sensitive) input device. In some embodiments, the pressure-sensitive input device detects inputs from a user in response to the user squeezing the input device (e.g., by pinching stem portion 305 of wearable audio output device 301 between two fingers). In some embodiments, input device(s) 308 include a touch-sensitive surface (e.g., a capacitive sensor) for detecting touch inputs, accelerometer(s), and/or attitude sensor(s) (e.g., for determining an attitude of wearable audio output device 301 relative to a physical environment and/or changes in attitude of the device), and/or other input device by which a user can interact with and provide inputs to wearable audio output device 301. In some embodiments, input device(s) 308 include one or more capacitive sensors, one or more force sensors, one or more motion sensors, and/or one or more orientation sensors. FIG. 3B shows input device(s) 308 at a location in stem portion 305, however in some embodiments one or more of input device(s) 308 are located at other positions within wearable audio output device 301 (e.g., other positions within stem portion 305 and/or head portion 303). In some embodiments, wearable audio output device 301 includes a housing with one or more physically distinguished portions 307 at locations that correspond to input device(s) 308 (e.g., to assist a user in locating and/or interacting with input device(s) 308). In some embodiments, physically distinguished portion(s) 307 include indent(s), raised portion(s), and/or portions with different textures. In some embodiments, physically distinguished portion(s) 307 include a single distinguished portion that spans multiple input devices 308. For example, input devices 308 include a set of touch sensors configured to detect swipe gestures and a single distinguished portion (e.g., a depression or groove) spans the set of touch sensors. In some embodiments, physically distinguished portion(s) 307 include a respective distinguished portion for each input device of input device(s) 308.

FIG. 3C is a block diagram of an example wearable audio output device 301 in accordance with some embodiments. In some embodiments, wearable audio output device 301 is one or more in-ear earphone(s), earbud(s), over-ear headphone(s), or the like. In some examples, wearable audio output device 301 includes a pair of earphones or earbuds (e.g., one for each of a user's ears). In some examples, wearable audio output device 301 includes over-ear headphones (e.g., headphones with two over-ear earcups to be placed over a user's ears and optionally connected by a headband). In some embodiments, wearable audio output device 301 includes one or more audio speakers 306 for providing audio output (e.g., to a user's ear). In some embodiments, wearable audio output device 301 includes one or more placement sensors 304 to detect positioning or placement of wearable audio output device 301 relative to a user's ear, such as to detect placement of wearable audio output device 301 in a user's ear. In some embodiments, wearable audio output device 301 conditionally outputs audio based on whether wearable audio output device 301 is in or near a user's ear (e.g., wearable audio output device 301 forgoes outputting audio when not in a user's ear, to reduce power usage). In some embodiments where wearable audio output device 301 includes multiple (e.g., a pair) of wearable audio output components (e.g., earphones, earbuds, or earcups), each component includes one or more respective placement sensors, and wearable audio output device 301 conditionally outputs audio based on whether one or both components is in or near a user's ear, as described herein. In some embodiments, wearable audio output device 301 furthermore includes an internal rechargeable battery 309 for providing power to the various components of wearable audio output device 301.

In some embodiments, wearable audio output device 301 includes audio I/O logic 312, which determines the positioning or placement of wearable audio output device 301 relative to a user's ear based on information received from placement sensor(s) 304, and, in some embodiments, audio I/O logic 312 controls the resulting conditional outputting of audio. In some embodiments, wearable audio output device 301 includes a wireless interface 315 for communication with one or more multifunction devices, such as device 100 (FIG. 1A) or device 300 (FIG. 3A), and electronic accessory case 342 (see FIG. 3E). In some embodiments, interface 315 includes a wired interface for connection with a multifunction device, such as device 100 (FIG. 1A) or device 300 (FIG. 3A) (e.g., via a headphone jack or other audio port). In some embodiments, a user can interact with and provide inputs (e.g., remotely) to wearable audio output device 301 via interface 315. In some embodiments, wearable audio output device 301 is in communication with multiple devices (e.g., multiple multifunction devices, and/or an audio output device case), and audio I/O logic 312 determines, which of the multifunction devices from which to accept instructions for outputting audio.

In some embodiments, wearable audio output device 301 includes one or more microphones 302 for receiving audio input. In some embodiments where wearable audio output device 301 includes multiple (e.g., a pair) of wearable audio output components (e.g., earphones or earbuds), each component includes one or more respective microphones. In some embodiments, audio I/O logic 312 detects or recognizes speech or ambient noise based on information received from microphone(s) 302.

In some embodiments, wearable audio output device 301 includes one or more input devices 308. In some embodiments where wearable audio output device 301 includes multiple (e.g., a pair) of wearable audio output components (e.g., earphones, earbuds, or earcups), each component includes one or more respective input devices. In some embodiments, input device(s) 308 include one or more volume control hardware elements (e.g., an up/down button for volume control, or an up button and a separate down button, as described herein with reference to FIG. 1A) for volume control (e.g., locally) of wearable audio output device 301. In some embodiments, inputs provided via input device(s) 308 are processed by audio I/O logic 312. In some embodiments, audio I/O logic 312 is in communication with a separate device (e.g., device 100, FIG. 1A, or device 300, FIG. 3A) that provides instructions or content for audio output, and that optionally receives and processes inputs (or information about inputs) provided via microphone(s) 302, placement sensor(s) 304, and/or input device(s) 308, or via one or more input devices of the separate device. In some embodiments, audio I/O logic 312 is located in device 100 (e.g., as part of peripherals interface 118, FIG. 1A) or device 300 (e.g., as part of I/O interface 330, FIG. 3A), instead of device 301, or alternatively is located in part in device 100 and in part in device 301, or in part in device 300 and in part in device 301.

FIG. 3D illustrates example audio control by a wearable audio output device 301 in accordance with some embodiments. While the following example is explained with respect to implementations that include a wearable audio output device having earbuds to which interchangeable eartips (sometimes called silicon eartips or silicon seals) are attached, the methods, devices and user interfaces described herein are equally applicable to implementations in which the wearable audio output devices do not have eartips, and instead each have a portion of the main body shaped for insertion in the user's cars. In some embodiments, when a wearable audio output device having earbuds to which interchangeable eartips may be attached are worn in a user's ears, the earbuds and eartips together act as physical barriers that block at least some ambient sound from the surrounding physical environment from reaching the user's ear. For example, in FIG. 3D, wearable audio output device 301 is worn by a user such that head portion 303 and eartip 314 are in the user's left ear. Eartip 314 extends at least partially into the user's ear canal. Preferably, when head portion 303 and eartip 314 are inserted into the user's ear, a seal is formed between eartip 314 and the user's ear so as to isolate the user's ear canal from the surrounding physical environment. However, in some circumstances, head portion 303 and eartip 314 together block some, but not necessarily all, of the ambient sound in the surrounding physical environment from reaching the user's ear. Accordingly, in some embodiments, a first microphone (or, in some embodiments, a first set of one or more microphones) 302-1 (and optionally a third microphone 302-3) is located on wearable audio output device 301 so as to detect ambient sound, represented by waveform 322, in region 316 of a physical environment surrounding (e.g., outside of) head portion 303. In some embodiments, a second microphone (or, in some embodiments, a second set of one or more microphones) 302-2 (e.g., of microphones 302, FIG. 3C) is located on wearable audio output device 301 so as to detect any ambient sound, represented by waveform 324, that is not completely blocked by head portion 303 and eartip 314 and that can be heard in region 318 inside the user's ear canal. Accordingly, in some circumstances in which wearable audio output device 301 is not producing a noise-cancelling (also called “antiphase”) audio signal to cancel (e.g., attenuate) ambient sound from the surrounding physical environment, as indicated by waveform 326-1, ambient sound waveform 324 is perceivable by the user, as indicated by waveform 328-1. In some circumstances in which wearable audio output device 301 is producing an antiphase audio signal to cancel ambient sound, as indicated by waveform 326-2, ambient sound waveform 324 is not perceivable by the user, as indicated by waveform 328-2.

In some embodiments, ambient sound waveform 322 is compared to attenuated ambient sound waveform 324 (e.g., by wearable audio output device 301 or a component of wearable audio output device 301, such as audio I/O logic 312, or by an electronic device that is in communication with wearable audio output device 301) to determine the passive attenuation provided by wearable audio output device 301. In some embodiments, the amount of passive attenuation provided by wearable audio output device 301 is taken into account when providing the antiphase audio signal to cancel ambient sound from the surrounding physical environment. For example, antiphase audio signal waveform 326-2 is configured to cancel attenuated ambient sound waveform 324 rather than unattenuated ambient sound waveform 322.

In some embodiments, wearable audio output device 301 is configured to operate in one of a plurality of available audio output modes, such as an active noise control audio output mode, an active pass-through audio output mode, and a bypass audio output mode (also sometimes called a noise control off audio output mode). In the active noise control mode (also called “ANC”), wearable audio output device 301 outputs one or more audio-cancelling audio components (e.g., one or more antiphase audio signals, also called “audio-cancelation audio components”) to at least partially cancel ambient sound from the surrounding physical environment that would otherwise be perceivable to the user. In the active pass-through audio output mode, wearable audio output device 301 outputs one or more pass-through audio components (e.g., plays at least a portion of the ambient sound from outside the user's ear, received by microphone 302-1, for example) so that the user can hear a greater amount of ambient sound from the surrounding physical environment than would otherwise be perceivable to the user (e.g., a greater amount of ambient sound than would be audible with the passive attenuation of wearable audio output device 301 placed in the user's ear). In the bypass mode, active noise management is turned off, such that wearable audio output device 301 outputs neither any audio-cancelling audio components nor any pass-through audio components (e.g., such that any amount of ambient sound that the user perceives is due to physical attenuation by wearable audio output device 301).

Attention is now directed towards embodiments of user interfaces (“UI”) that are, optionally, implemented on portable multifunction device 100.

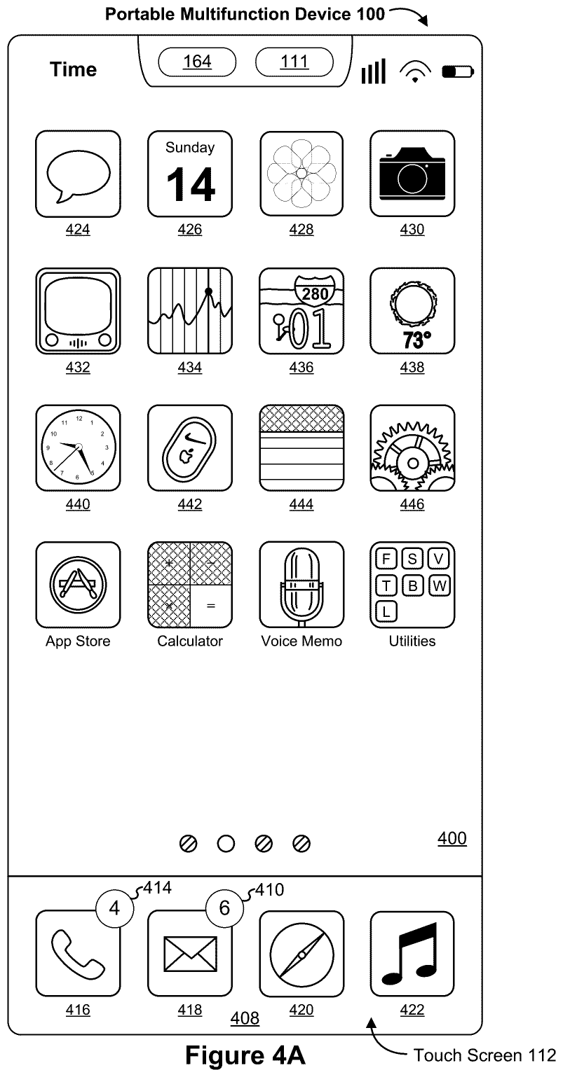

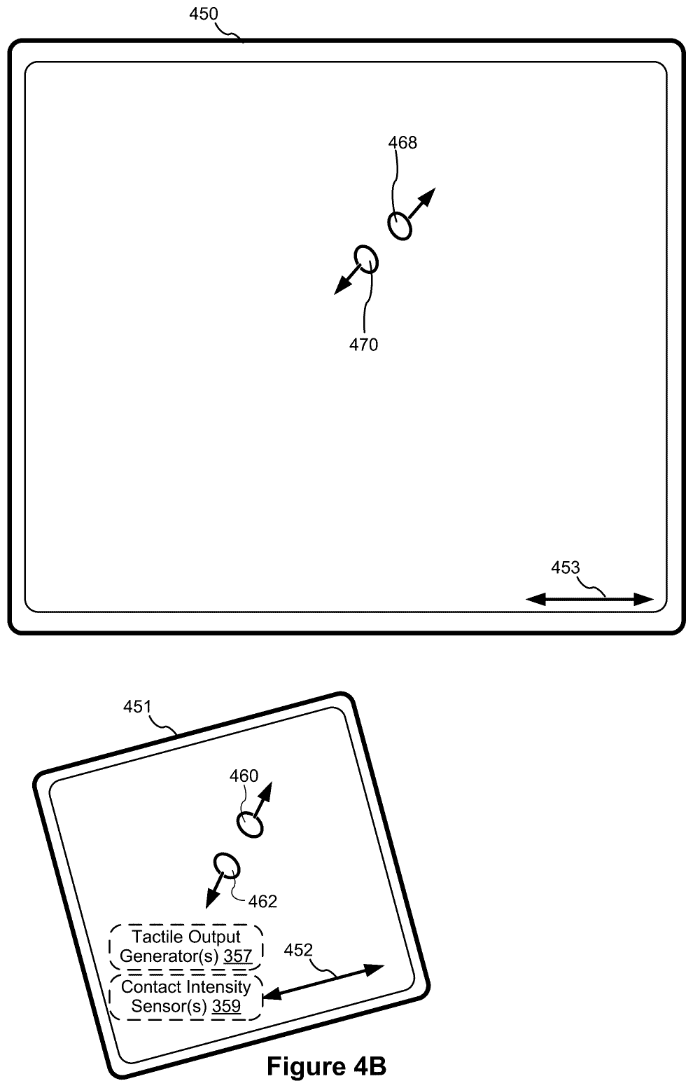

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3) with a touch-sensitive surface 451 (e.g., a tablet or touchpad 355, FIG. 3) that is separate from the display 450. Although many of the examples that follow will be given with reference to inputs on touch-sensitive display system 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse-based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

In some embodiments, the response of the device to inputs detected by the device depends on criteria based on the contact intensity during the input. For example, for some “light press” inputs, the intensity of a contact exceeding a first intensity threshold during the input triggers a first response. In some embodiments, the response of the device to inputs detected by the device depends on criteria that include both the contact intensity during the input and time-based criteria. For example, for some “deep press” inputs, the intensity of a contact exceeding a second intensity threshold during the input, greater than the first intensity threshold for a light press, triggers a second response only if a delay time has elapsed between meeting the first intensity threshold and meeting the second intensity threshold. This delay time is typically less than 200 ms (milliseconds) in duration (e.g., 40, 100, or 120 ms, depending on the magnitude of the second intensity threshold, with the delay time increasing as the second intensity threshold increases). This delay time helps to avoid accidental recognition of deep press inputs. As another example, for some “deep press” inputs, there is a reduced-sensitivity time period that occurs after the time at which the first intensity threshold is met. During the reduced-sensitivity time period, the second intensity threshold is increased. This temporary increase in the second intensity threshold also helps to avoid accidental deep press inputs. For other deep press inputs, the response to detection of a deep press input does not depend on time-based criteria.

In some embodiments, one or more of the input intensity thresholds and/or the corresponding outputs vary based on one or more factors, such as user settings, contact motion, input timing, application running, rate at which the intensity is applied, number of concurrent inputs, user history, environmental factors (e.g., ambient noise), focus selector position, and the like. Example factors are described in U.S. patent application Ser. Nos. 14/399,606 and 14/624,296, which are incorporated by reference herein in their entireties.

### USER INTERFACES AND ASSOCIATED PROCESSES

Attention is now directed towards embodiments of user interfaces (“UI”) and associated processes that may be implemented on an electronic device, such as portable multifunction device 100, device 300, and/or wearable audio output devices 301.

FIGS. 5A-5P illustrate example user interfaces and user interactions for adjusting microphone operation of wearable audio output devices. FIGS. 6A-6J illustrate example user interfaces and user interactions for controlling various features associated with audio output devices. FIGS. 7A-7D illustrate example user interfaces and user interactions for various features associated with audio output devices. FIGS. 8A-8P illustrate example audio outputs with example changes in the audio properties of a surrounding physical environment. FIGS. 9A-9B illustrate example conversations and corresponding changes in the audio outputs of wearable audio output devices. FIGS. 10A-10E illustrate an example conversation and corresponding changes in the outputs of a multifunction device and wearable audio output devices. FIGS. 11A-11M illustrate example user interfaces, user interactions, and connectivity for audio output devices. FIGS. 12A-12G illustrate example user interfaces and user interactions corresponding to various associated audio output devices. The user interfaces and device interactions in these figures are used to illustrate the processes described below, including the processes in FIGS. 13A-13C, 14A-14C, 15A-15B, and 16A-16C. For convenience of explanation, some of the embodiments will be discussed with reference to operations performed on a device with a touch-sensitive display system 112. In such embodiments, a focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector. Additionally, analogous operations are, optionally, performed on a device in communication with a display generation component (e.g., a wireless display device) that is separate from the device.

FIGS. 5A-5F illustrate example user interfaces and user interactions for adjusting microphone operation of wearable audio output devices in accordance with some embodiments. FIG. 5A illustrates user 502 wearing wearable audio output devices 301. User 502 in FIG. 5A is using multifunction device 100 to video chat with a remote user. The multifunction device 100 displays video chat user interface 506 that shows the remote user and image 508 of user 502. Video chat user interface 506 also includes speaker icon 512, microphone icon 514, and dismiss icon 510. Microphone icon 514 is in unmuted state 514-a in FIG. 5A, indicating that the microphone of the wearable audio output device 301-1 (and/or the microphone of wearable audio output device 301-2) is unmuted for the video chat application. User 502 in FIG. 5A is talking to the remote user with statement 516. In some embodiments, microphone icon 514 is selectable, and when selected, toggles the mute state of the microphone for the video chat application.

FIG. 5B shows user input 518 at wearable audio output device 301-1 and corresponding notification 519 from wearable audio output device 301-1 indicating that the active microphone (e.g., the microphone of wearable audio output device 301-1, wearable audio output device 301-2, or other microphone) is muted for the video chat application. In some embodiments, user input 518 causes audio detected with one or more microphones to cease to be provided as input to the real-time communication session. For example, user input 518 is a tap gesture, a squeeze gesture, a button press, a light press gesture, or other type of gesture. In some embodiments, each of wearable audio output devices 301 include a stem portion 305 that the user can use to provide inputs to the wearable audio output devices (e.g., described with reference to FIG. 3B). In some embodiments, stem portion 305 is or includes input device(s) (e.g., input devices 308) that respond to user inputs applied to stem portion 305. In some embodiments, the input device(s) include a touch-sensitive input device that responds to touch inputs applied to stem portion 305, such as finger touches as illustrated in FIG. 5B. In some embodiments, the input device(s) include a pressure-sensitive input device that responds to press inputs applied to stem portion 305 when held and squeezed between two fingers. Although only one wearable audio output device is shown in FIG. 5B, one of ordinary skill will recognize that wearable audio output device 301-2 can have an analogous structure with a corresponding stem, and that the same functionality described herein with reference to wearable audio output device 301-1 may be available using wearable audio output device 301-2 and its corresponding stem as well.

FIG. 5B also shows microphone icon 514 in muted state 514-b, indicating that the microphone is muted for the video chat application. In some embodiments, a microphone is selected by the multifunction device 100 as the microphone to use for capturing audio from the user. In some embodiments, the selected microphone is muted for the video chat application in response to user input 518. In some embodiments, the selected microphone is a microphone of wearable audio output device 301-1, wearable audio output device 301-2, or other microphone communicatively coupled to the multifunction device 100. In some embodiments, in response to user input 518, the microphone is muted for active voice chat and/or video chat application, but is unmuted for other functions (e.g., dictation and/or conversing with a digital assistant).

FIG. 5C shows user 502 speaking while the microphone is in the muted state, as indicated by microphone icon 514. User 502 in FIG. 5C is talking to a digital assistant, as indicated by the use of a trigger word or phrase such as “hey assistant” in statement 520. In the example of FIG. 5C, the remote user does not hear the statement 520 as the microphone is muted for the video chat application. FIG. 5D shows a calendar event being added to a calendar of user 502, as indicated by notification 522. The calendar event in FIG. 5D is added in response to the statement 520 in FIG. 5C. In the example of FIG. 5D, the microphone is muted for the video chat application as indicated by microphone icon 514.

FIG. 5E shows user input 524 at wearable audio output device 301-1 and corresponding notification 525 from wearable audio output device 301-1 indicating that the active microphone (e.g., the microphone of wearable audio output device 301-1, wearable audio output device 301-2, or other microphone) is unmuted for the video chat application. In some embodiments, user input 518 causes audio detected with one or more microphones to be provided as input to the real-time communication session. For example, user input 524 is a tap gesture, a squeeze gesture, a button press, a light press gesture, or other type of gesture. In some embodiments, user input 524 is a same type of input as user input 518 in FIG. 5B. In some embodiments, user input 524 toggles a mute state of the microphone for the video chat application. In some embodiments, in response to detecting user input 524, the active microphone is unmuted for each function (and/or each application) for which the active microphone was previously muted. FIG. 5E also shows microphone icon 514 in unmuted state 514-a, indicating that the microphone is unmuted for the video chat application. FIG. 5F shows user 502 speaking while the microphone is in the unmuted state, as indicated by microphone icon 514. Statement 526 from user 502 in FIG. 5F is transmitted to the remote user due to the microphone being in the unmuted state. Thus, FIGS. 5A-5E illustrate example user interfaces and user interactions for adjusting the mute state of a microphone for a particular function, type of function, application, and/or type of application in accordance with some embodiments.

FIGS. 5G-5P illustrate example user interfaces and user interactions for adjusting microphone operation of wearable audio output devices in accordance with some embodiments. FIG. 5G shows user 502 conversing with a remote user (e.g., “Janet”) via a telephony application, as indicated by user interface 528. User interface 528 includes microphone icon 530, indicating a mute state of the active microphone for the telephony application. In the example of FIG. 5G, microphone icon 530 state 530-a indicates that audio detected with one or more microphones is provided as input to the telephony application (e.g., to transmit to the remote user). In some embodiments, microphone icon 530 is selectable, and when selected, toggles the mute state of the microphone for the telephony application.

FIG. 5H shows output volume 534 of device 100 having an output level of 536-1. For example, output volume 534 corresponds to a volume of audio output by a speaker of the device (e.g., a volume of the remote user's voice). FIG. 5H further shows user input 532 (e.g., a swipe gesture, a pinch gesture with downward movement, or other type of input) from user 502 at wearable audio output device 301-1. In the example of FIG. 5H, user input 532 is an input mapped to an output volume adjustment function. FIG. 5I shows output volume 534 of device 100 at an output level of 536-2 (e.g., lower than 536-1) in response to user input 532 in FIG. 5H. FIG. 5H further shows user 502 continuing a conversation with the remote user via the telephony application.

FIG. 5J shows user input 538 from user 502 at wearable audio output device 301-2. FIG. 5J further shows feedback 535 (e.g., audio and/or haptic feedback) output by wearable audio output device 301-2 in response to detecting user input 538. In the example of FIG. 5J, user input 538 is an input mapped to a microphone mute function (e.g., for the telephony application). In some embodiments, user input 538 causes audio detected with one or more microphones to cease to be provided as input to the real-time communication session of the telephony application. FIG. 5J also shows notification 539 displayed on device 100 indicating that the microphone is muted for the ongoing call with the remote user. In the example of FIG. 5J, microphone icon 530 state 530-b indicates that audio detected with one or more microphones is not provided as input to the telephony application. In some embodiments, a first type of input (e.g., a single tap, squeeze, button press, or other selection input) toggles the mute state for the microphone and a second type of input (e.g., a double tap, double squeeze, double button press, or other selection input) ends the active call. In some embodiments, the second type of input ends the active call if a call is active and performs a different function if a call is not active (e.g., activates a digital assistant).

FIG. 5K shows user input 540 from user 502 at wearable audio output device 301-2. FIG. 5K further shows notification 542 output by wearable audio output device 301-2 in response to detecting user input 540. In the example of FIG. 5K, user input 540 is an input mapped to a digital assistant function. In accordance with some embodiments, user input 538 is a first type of input and user input 540 is a second type of input, different from the first type of input. For example, the first type of input is a light press input and the second type of input is a deep press input. As another example, the first type of input is a short press input and the second type of input is a long press input. FIG. 5K also shows user input 541 from user 502 at device 100. User input 541 in FIG. 5K is at button 543. In accordance with some embodiments, button 543 is mapped to the digital assistant function. As illustrated in FIG. 5K, user 502 may activate the digital assistant function via either user input 540 at wearable audio output device 301-2 or user input 541 at button 543. In some embodiments, user 502 may also activate the digital assistant function via a voice command (e.g., a trigger phrase such as “hey assistant”).

FIG. 5L shows user 502 providing instructions 544 (e.g., a voice command) to the digital assistant. In the example, of FIG. 5L instructions 544 are not relayed to the remote user because the microphone is muted for the telephony application, as indicated by microphone icon 530 being in state 530-b.

FIG. 5M shows user interface 552 (e.g., corresponding to a notes application) being displayed at device 100 in response to instructions 544 in FIG. 5L. FIG. 5M further shows user interface 548 (e.g., corresponding to the telephony application) being displayed at device 100 and including selectable microphone icon 550. In some embodiments, selectable microphone icon 550, when selected, toggles a mute state of the microphone for the telephony application. For example, user interface 548 replaces user interface 528 of FIG. 5L (e.g., because user interface 548 is more compact than user interface 528 and therefore provides screen space for user interface 552). FIG. 5M further shows user input 556 at microphone icon 554 enabling a microphone function for the notes application. In some embodiments, microphone icon 554 is part of user interface 552. In some embodiments, microphone icon 554 is part of a user input user interface (e.g., corresponding to a software keyboard function). FIG. 5M also shows user 502 dictating message 546 for the notes application in conjunction with enabling the microphone function. In some embodiments, microphone icon 550 is selectable, and when selected, toggles the mute state of the microphone for the telephony application.

FIG. 5N shows reminder user interface 558 with text that corresponds to message 546 in FIG. 5M. In the example of FIGS. 5M and 5N, the message 546 is not conveyed to the remote user because the microphone mute state for the telephony application is muted, as denoted by microphone icon 550 in FIGS. 5M and 5N. FIG. 5N further shows user input 560 on user interface 548. User input 560 in FIG. 5N is not at a location that corresponds to a selectable icon (such as the microphone icon 550).

FIG. 5O shows user interface 528 displayed on device 100 in response to user input 560 on user interface 548 in FIG. 5M. The mute state of the microphone for the telephony application is muted in FIG. 5O, as indicated by microphone icon 530 being in state 530-b. FIG. 5P shows user input 562 from user 502 at wearable audio output device 301-1. FIG. 5P further shows feedback 564 output by wearable audio output device 301-1 in response to detecting user input 562. In accordance with some embodiments, an active noise cancellation (ANC) mode is toggled on in response to detecting user input 562 (as indicated by feedback 564). In the example of FIG. 5P, user input 562 is an input mapped to a noise adjustment function (activating the ANC mode). For example, user input 562 is a light press, a deep press, a long press, a squeeze, or other type of gesture. In the example of FIGS. 5K and 5P, a same type of gesture detected at different wearable audio output devices causes different functions to be performed (e.g., executed). FIG. 5K shows a long press input at wearable audio output device 301-2 activating a digital assistant function and FIG. 5P shows a long press input at wearable audio output device 301-1 activating an ANC function.

FIGS. 6A-6J illustrate example user interfaces and user interactions for controlling various features associated with audio output devices in accordance with some embodiments. FIG. 6A shows tracking notification user interface 604 displayed at device 100. In the example of FIG. 6A, tracking notification user interface 604 is overlaid over a user interface for wearable audio output devices 301 (e.g., labeled “Max's Earbuds”). In some embodiments, tracking notification user interface 604 is displayed in response to a user request to display the user interface for wearable audio output devices 301. For example, the user request is a voice command, a selection of an icon for wearable audio output devices 301, a selection of an audio settings icon, or other type of user input. In some embodiments, tracking notification user interface 604 is displayed in accordance with a determination that the user of device 100 is not the designated owner of wearable audio output devices 301. For example, a user account associated with device 100 is different than a user account designated as the owner of wearable audio output devices 301.

Tracking notification user interface 604 includes information about device tracking functionality for wearable audio output devices 301. Tracking notification user interface 604 also includes option 606 to accept the information (and, optionally, close the user interface) and option 608 to message the designated owner of wearable audio output devices 301. FIG. 6A further shows user input 609 selecting option 606 and user input 611 selecting option 608. In some embodiments, in response to detecting user input 609 the tracking notification user interface 604 ceases to be displayed. In some embodiments, in response to detecting user input 611, a process is initiated to message the designated owner. For example, in response to detecting user input 611, a user interface is displayed with one or more options for drafting, editing, and/or sending a message to the designated owner. As another example, in response to detecting user input 611, a message is automatically transmitted to a device of the designated owner (e.g., a device associated with the user account that is designated as the owner of wearable audio output devices 301). In some embodiments, the message includes identifying information for the user of the device 100 (e.g., a name of the user, an account name, and/or other type of identifying information). In some embodiments, the message is sent anonymously (e.g., does not include any identifying information for the user of the device 100).

FIG. 6B shows user interface 610 with information about wearable audio output devices 301. User interface 610 includes selectable element 612 for a name of wearable audio output devices 301, selectable element 614 for a noise control mode of wearable audio output devices 301, selectable element 616 for mapping a tap input to a left device (e.g., wearable audio output device 301-2), selectable element 618 for mapping a tap input to a right device (e.g., wearable audio output device 301-1), selectable element 620 for mapping a press and hold input (e.g., a long press) to a left device (e.g., wearable audio output device 301-2), and selectable element 622 for mapping a press and hold input to a right device (e.g., wearable audio output device 301-1). A press and hold input is a press input that is held (e.g., maintained) for at least a predetermined amount of time (e.g., 0.1 seconds, 0.2 seconds, 0.25 seconds, 0.5 seconds, 1 second, 2 seconds, or other amount of time). Selectable element 616 indicates that a tap input at the left earbud is mapped to a microphone mute function. Selectable element 618 indicates that a tap input at the right earbud is mapped to the microphone mute function. Selectable element 620 indicates that a press and hold input at the left earbud is mapped to a digital assistant function. Selectable element 622 indicates that a press and hold input at the right earbud is mapped to a noise control function.

FIG. 6B further shows user input 624 selecting selectable element 612. In some embodiments, in response to detecting user input 624, a naming user interface is displayed (e.g., that includes an option to rename wearable audio output devices 301 in accordance with a determination that the user is the designated owner of wearable audio output devices 301).

FIG. 6B also shows user input 615 selecting selectable element 614. In some embodiments, in response to detecting user input 615, a noise control mode of wearable audio output devices 301 is adjusted. For example, user input 615 is at a position that corresponds to an active transparency mode. In some embodiments, an active transparency mode is activated for wearable audio output devices 301 in accordance with a user input at a position that corresponds to the transparency icon of selectable element 614. In some embodiments, an ANC mode is activated for wearable audio output devices 301 in accordance with a user input at a position that corresponds to the noise cancellation icon of selectable element 614. In some embodiments, active noise control is disabled for wearable audio output devices 301 in accordance with a user input at a position that corresponds to the off icon of selectable element 614. In some embodiments, a degree of ANC or active transparency is adjusted in accordance with a position of the user input on the selectable element 614.

FIG. 6B also shows user input 617 selecting selectable element 616. In some embodiments, in response to detecting user input 617, a tap input mapping user interface is displayed (e.g., analogous to user interface 640 shown in FIG. 6E) for the left device (e.g., wearable audio output device 301-2). FIG. 6B also shows user input 619 selecting selectable element 618. In some embodiments, in response to detecting user input 619, a tap input mapping user interface is displayed the right device (e.g., wearable audio output device 301-1) (e.g., analogous to user interface 640 shown in FIG. 6E). FIG. 6B also shows user input 621 selecting selectable element 620. In some embodiments, in response to detecting user input 621, a hold input mapping user interface is displayed the left device (e.g., wearable audio output device 301-2) (e.g., analogous to user interface 640 shown in FIG. 6E).

FIG. 6C shows naming user interface 628 displayed in response to user input 624 in FIG. 6B. In the example of FIG. 6C, naming user interface 628 includes a message regarding the user not being able to rename wearable audio output devices 301 because the user is not the designated owner of wearable audio output devices 301. In some embodiments, the user is determined not to be the designated owner based on a user account associated with device 100 being different than the user account designated as the owner of wearable audio output devices 301. Naming user interface 628 includes option 630 to accept the information (and, optionally, close the user interface) and option 632 to message the designated owner of wearable audio output devices 301. FIG. 6C further shows user input 631 selecting option 630. In some embodiments, in response to detecting user input 631, naming user interface 628 ceases to be displayed. In some embodiments, in response to detecting a user input at option 632, a process is initiated to message the designated owner (e.g., as described above with respect to selection of option 608 in FIG. 6A).

FIG. 6D shows user interface 610 displayed on device 100 in response to detecting user input 631 in FIG. 6C. For example, naming user interface 628, which was overlaid over user interface 610 in FIG. 6C, has ceased to be displayed in FIG. 6D in response to detecting user input 631. FIG. 6D also shows user input 634 at selectable element 622 of user interface 610.

FIG. 6E shows user interface 640 displayed on device 100 in response to detecting user input 634 in FIG. 6D. User interface 640 includes options for mapping a press and hold input detected at a right earbud (e.g., wearable audio output device 301-1) to a particular function. User interface 640 includes selectable element 642 indicating the corresponding wearable audio output device, selectable element 644 for a noise control function, selectable element 648 for a digital assistant function, and selectable element 650 for a microphone mute function. In the example of FIG. 6E, the press and hold input is mapped to a noise control function as indicated by checkmark 646 on selectable element 644. User interface 640 also includes options 652 for the noise control functions associated with selectable element 644. Options 652 in FIG. 6E include a noise cancellation option (e.g., toggling an ANC mode), a transparency option (e.g., toggling an active transparency mode), and an off option (e.g., disabling both ANC and active transparency). In some embodiments, options 652 are displayed in accordance with selectable element 644 being selected. For example, if selectable element 648 or selectable element 650 is selected, options 652 cease to be displayed. FIG. 6E further shows user input 647 selecting selectable element 648, user input 651 selecting selectable element 650, and user input 653 selecting the off option of options 652. In some embodiments, user input 647 causes the press and hold input for the right earbud to map to a digital assistant function. In some embodiments, user input 651 causes the press and hold input for the right earbud to map to a microphone mute function. In some embodiments, user input 653 causes the press and hold input for the right earbud to map to an off state for noise control. In some embodiments, options 652 include an adaptive noise option, e.g., in addition to, or in place of, the options shown (e.g., in place of the off option).

FIG. 6F illustrates settings user interface 660, e.g., displayed over the entirety (or substantially all, e.g., greater than 95%, 96%, 97%, 98%, or 99%) of the user interface shown in FIG. 4A (e.g., a home screen interface) (e.g., in response to detecting a swipe gesture, and/or activation of a button or icon). Settings user interface 660 includes a plurality of controls for various features of device 100. Notably, settings user interface 660 includes volume control 662 for controlling output volume. Upward and downward swipe inputs on volume control 662 may be provided to increase or decrease, respectively, the volume of audio outputs from device 100 (e.g., via wearable audio output devices 301). FIG. 6F further shows user input 664 on volume control 662. In some embodiments, user input 664 is a tap, press, long press, deep press, and/or other type of input.

FIG. 6G illustrates a transition from FIG. 6F in response to detecting user input 664. In particular, FIG. 6G shows audio control user interface 670, which is displayed (e.g., in place of, or overlaid with, settings user interface 660). Audio control user interface 670 includes volume control 672 at position 672-a, which is an enlarged version of volume control 662 (FIG. 6F), and which may allow for finer (e.g., more granular) volume control. Audio control user interface 670 also includes noise control 674, adaptive adjustments control 678, and speech detection control 682. FIG. 6H shows wearable audio output devices 301 operating with an adaptive adjustments mode disabled, as indicated by adaptive adjustments control 678, and a speech detection mode disabled, as indicated by speech detection control 682. FIG. 6H also shows wearable audio output devices 301 operating in an active transparency mode, as indicated by noise control 674. In an active transparency (e.g., active pass-through) audio output mode one or more pass-through audio components are output so that the user can hear a greater amount of ambient sound from the surrounding physical environment than would otherwise be perceivable to the user (e.g., as described herein with reference to FIG. 3D).

FIG. 6H shows user input 686 at volume control 672. User input 686 has a downward movement (e.g., includes or is a swipe down gesture). In some embodiments, in response to detecting user input 686, an output volume of audio output at wearable audio output devices 301 is adjusted (e.g., is decreased). In some embodiments, a degree of the adjustment is based on a movement component of user input 686 (e.g., a distance and/or speed of user input 686). In some embodiments, the adjustment is based on a position of user input 686 with respect to volume control 672 (e.g., an initial position of user input 686 and/or an ending position of user input 686). In some embodiments, the output volume of audio output at wearable audio output devices 301 is adjusted in response to detecting an input at one of wearable audio output devices 301. For example, in response to detecting a swipe gesture (e.g., at a stem of wearable audio output device 301-1 or 301-2), the output volume of audio output at wearable audio output devices 301 is adjusted. As another example, in response to detecting an input that includes a rotation of a crown of wearable audio output device 301-1 or 301-2, the output volume of audio output at wearable audio output devices 301 is adjusted. In some embodiments, a degree of the adjustment is based on a movement component of the user input detected at one of wearable audio output devices 301 (e.g., a distance and/or speed of the user input). In some embodiments, the adjustment is based on a position of the user input with respect to a portion of wearable audio output device 301-1 or 301-2 (e.g., an initial position and/or ending position of the user input). In some embodiments, the output volume of audio output at wearable audio output devices 301 is adjusted in response to detecting a first type input at one of wearable audio output devices 301. In some embodiments, the first type of input is assigned to an adjustment of the output volume in accordance with an input mapping (e.g., as described previously with respect to FIGS. 6D-6E). FIG. 6H further shows user input 683 at speech detection control 682 and user input 684 at adaptive adjustments control 678. In some embodiments, in response to detection of user input 683, a speech detection mode is enabled (e.g., toggled on). For example, while the speech detection mode is enabled, detecting speech causes a change in modification of ambient sound (e.g., a decrease in ANC and/or an increase in active transparency). In some embodiments, speech from the user or directed to the user cases the change in the modification of ambient sound, whereas speech between two other people does not cause the change in the modification of ambient sound. In some embodiments, in response to detection of user input 684, an adaptive adjustments mode is enabled (e.g., toggled on). In some embodiments, in response to detection of user input 684, one or more adaptive adjustment controls are displayed (e.g., in addition to, or replacing, the controls shown in FIG. 6H). For example, the one or more adaptive adjustment controls may include an adaptive volume adjustment control that, when selected, enables an adaptive volume adjustment mode that automatically raises/lowers volume based on ambient noise. As another example, the one or more adaptive adjustment controls may include an adaptive noise management control that, when selected, enables an adaptive noise management mode that automatically raises/lowers a degree of noise management (e.g., a degree of ANC and/or active transparency) based on ambient noise.

FIG. 6I shows audio control user interface 670 with volume control 672 at level 672-b that is less than level 672-a in FIG. 6G in response to user input 686 in FIG. 6H. FIG. 6I also shows an adaptive adjustments mode being enabled as indicated by adaptive adjustments control 678 and a speech detection mode being enabled as indicated by speech detection control 682. FIG. 6I further shows user input 688 at noise control 674. In some embodiments, user input 688 is a tap, press, long press, and/or deep press input.

FIG. 6J illustrates a transition from FIG. 6I. In particular, FIG. 6I shows audio control user interface 670, in which display of noise control 674, adaptive adjustments control 678, and speech detection control 682 is replaced with display of an expanded noise management control 690, which includes representations of a plurality of available audio output modes (e.g., three available audio output modes) for wearable audio output devices 301, each of which is associated with a different audio output mode available for wearable audio output devices 301. In particular, expanded noise management control 690 includes transparency icon 696, off icon 694, and active noise control icon 692. Transparency icon 696, off icon 694, and active noise control icon 692 are selectable icons and, when selected, cause wearable audio output devices 301 to operate in the corresponding mode. In some embodiments, expanded noise management control 690 is a selectable slider and inputs detecting at positions along expanded noise management control 690 cause wearable audio output devices 301 to operate with a corresponding degree of ANC or active transparency based on the position of the inputs. In some embodiments, expanded noise management control 690 includes an adaptive noise adjustment icon, e.g., in addition to, or in place of, the icons shown (e.g., in place of the off icon). In some embodiments, the adaptive noise adjustment icon, when selected, toggles an adaptive noise management mode, an adaptive volume adjustment mode, and/or another adaptive noise mode.

Active noise control icon 692 represents an active noise control (“ANC”) audio output mode in which one or more audio-cancelling audio components are output to at least partially cancel ambient sound from the surrounding physical environment that would otherwise be perceivable to the user. Off icon 694 represents a bypass audio output mode in which neither audio-cancelling audio components nor pass-through audio components are provided (e.g., any amount of ambient sound that the user perceives is due to physical attenuation by the wearable audio output devices 301 (and any attached eartips (or earcups) in or on the user's ears). A selection indicator displayed over transparency icon 696 (e.g., and not displayed over either off icon 694 or active noise control icon 692) indicates that the active transparency (e.g., an audio pass-through) mode represented by transparency icon 696 is the mode in which wearable audio output devices 301 are currently operating. In response to detecting user input 688 (e.g., and in accordance with a determination that user input 688, shown in FIG. 6I, is a tap or press gesture at noise control 674), noise control 674, adaptive adjustments control 678, and speech detection control 682 cease to be displayed and expanded noise management control 690 is displayed. In some embodiments, expanded noise management control 690 is displayed concurrently with adaptive adjustments control 678 and speech detection control 682 in response to detecting user input 688.

FIGS. 7A-7D illustrate example user interfaces and user interactions for various features associated with audio output devices in accordance with some embodiments. FIG. 7A shows user interface 702 showing available user interactions for wearable audio output devices 301. In particular, FIG. 7A shows user interface 702 with representations 703 of wearable audio output devices (e.g., wearable audio output devices 301) and illustrations of user gesture 704 (e.g., a tap gesture at stem portion 305) for adjusting a mute state of a microphone of wearable audio output devices 301. In some embodiments, user interface 702 is overlaid over another user interface (e.g., user interface 400 of FIG. 4A). In some embodiments, user interface 702 is displayed in conjunction with a software setup or update procedure for wearable audio output devices 301 and/or device 100. In some embodiments, user interface 702 is displayed in conjunction with pairing and/or communicatively coupling wearable audio output devices 301 with device 100. User interface 702 includes dismiss control 712 and continue control 706. In some embodiments, a user selection of dismiss control 712 causes user interface 702 to cease to be displayed. In some embodiments, a particular type of input (e.g., a swipe up gesture, a swipe down gesture, or other type of gesture) on user interface 702 at a position that does not correspond to a selectable icon causes user interface 702 to cease to be displayed. In some embodiments, a user input at the underlying user interface (e.g., at the displayed portion of user interface 400) causes user interface 702 to cease to be displayed. FIG. 7A further shows user input 708 at continue control 706. In some embodiments, user interface 702 does not include continue control 706 (e.g., includes a done control instead).

FIG. 7B shows user interface 710 displayed in response to user input 708 in FIG. 7A. User interface 710 includes noise management control 714, volume adjustment control 716, speech detection control 718, dismiss control 712, and done control 720. In the example of FIG. 7B, a noise management mode is enabled as indicated by noise management control 714, a volume adjustment mode is enabled as indicated by volume adjustment control 716, and a speech detection mode is enabled as indicated by speech detection control 718. In some embodiments, the noise management mode, the volume adjustment mode, and/or the speech detection mode are enabled by default. In some embodiments, user interface 710 is displayed independent of user interface 702 (e.g., user interface 710 is displayed without displaying user interface 702 first). In some embodiments, user interface 710 is displayed in conjunction with a software setup or update procedure for wearable audio output devices 301 and/or device 100. In some embodiments, user interface 702 is displayed in conjunction with pairing and/or communicatively coupling wearable audio output devices 301 with device 100. In some embodiments, user interface 710 includes only a subset of the controls shown in FIG. 7B (e.g., only noise management control 714 and volume adjustment control 716 without speech detection control 718).

FIG. 7C shows user input 724 at noise management control 714, user input 726 at volume adjustment control 716, and user input 728 at speech detection control 718. FIG. 7D shows the noise management mode being disabled, as indicated by noise management control 714, in response to detecting user input 724. FIG. 7D also shows the volume adjustment mode being disabled, as indicated by volume adjustment control 716, in response to detecting user input 726. FIG. 7D also shows the speech detection mode being disabled, as indicated by speech detection control 718, in response to detecting user input 728. FIG. 7D further shows user input 732 at dismiss control 712 and user input 730 at done control 720. In some embodiments, in response to detecting user input 732 at dismiss control 712, user interface 702 ceases to be displayed. In some embodiments, in response to detecting user input 730 at done control 720, user interface 702 ceases to be displayed. In some embodiments, selection of dismiss control 712 causes any user changes to noise management control 714, volume adjustment control 716, and/or speech detection control 718 to be discarded. In some embodiments, selection of done control 720 causes any user changes to noise management control 714, volume adjustment control 716, and/or speech detection control 718 to be saved/stored.

FIGS. 8A-8P illustrate example audio outputs with example changes in the audio properties of a surrounding physical environment in accordance with some embodiments. FIGS. 8A-8F illustrate changes in audio outputs provided by wearable audio output devices 301 worn by user 804 in response to changes in ambient sound, particularly speech, in a physical environment surrounding user 804. FIG. 8A illustrates user 804 seated and wearing wearable audio output device 301. Wearable audio output devices 301 are in communication with an electronic device (e.g., device 100, FIG. 1A) and provide audio output corresponding to audio content from the device, represented by device content waveform 808-1. Ambient sound present in the physical environment is represented by ambient sound waveform 810-1. Ambient sound from the physical environment that is not blocked by wearable audio output devices 301 (e.g., due to imperfect passive attenuation by wearable audio output devices 301, as described herein with reference to FIG. 3D) and that can be heard while wearing wearable audio output devices 301 is represented by attenuated ambient sound waveform 812-1. In accordance with some embodiments, the ambient sound present in the physical environment is considered to satisfy predefined audio output criteria (e.g., audio output criteria associated with providing device audio content, for example at a volume level selected by user 804 or automatically determined by wearable audio output devices 301 or by the device in communication with wearable audio output devices 301). In addition, active noise control is enabled for wearable audio output devices 301, and thus a noise-cancelling signal, represented by antiphase waveform 814-1, is provided to cancel attenuated ambient sound waveform 812-1. As a result of the active noise control, little (or no) ambient sound is perceived by user 804, as indicated by perceived ambient sound waveform 816-1.

FIG. 8B illustrates person 820 having approached user 804 and begun speaking to user 804, as indicated by speech bubble 822, at a first time. In some embodiments, person 820 is determined to be speaking to user 804 in accordance with person 820 speaking the name of user 804. In some embodiments, person 820 is determined to be speaking to user 804 based on the relative positions of user 804 and person 820 and/or a direction in which person 820 is directing their speech. The increase in the ambient sound in the physical environment due to person 820 speaking is shown by ambient sound waveform 810-2 and by attenuated ambient sound waveform 812-2. In some embodiments, the ambient sound present in the physical environment in FIG. 8B is no longer considered to satisfy the predefined audio output criteria (e.g., audio output criteria associated with providing device audio content). In some embodiments, the ambient sound present in the physical environment in FIG. 8B is considered to satisfy different, second predefined audio output criteria (e.g., audio output criteria associated with a bias toward ambient sound). In some embodiments, initially after person 820 begins speaking, wearable audio output devices 301 continue to output audio content from the device, as shown by device content waveform 808-2, and also continue to cancel ambient sound, as shown by antiphase waveform 814-2. As a result, user 804 does not hear (or has trouble hearing) the ambient sound, as indicated by perceived ambient sound waveform 816-2.

FIG. 8C shows person 820 continuing to speak with user 804, as indicated by speech bubble 824, at a second time, subsequent to the first time. FIG. 8C further shows modification of the audio outputs provided by wearable audio output devices 301 in response to detecting speech from person 820 (e.g., the ambient sound in the physical environment no longer satisfying the predefined audio output criteria). Device content waveform 808-3 in FIG. 8C shows that the volume level of the audio content from the device is reduced relative to the level shown by device content waveform 808-2 in preceding FIG. 8B. Also, active noise control is disabled in FIG. 8C, as shown by antiphase waveform 814-3 being at zero. In addition, wearable audio output devices 301 are actively passing through ambient sound from physical the environment (e.g., using a microphone, such as microphones 302 to acquire ambient sound from the physical environment), so that user 804 hears ambient sound at a volume level above attenuated ambient sound level 812-3 resulting from passive attenuation by wearable audio output devices 301. In some embodiments, user 804 hears the ambient sound at a volume level that is approximately equal to (e.g., within 10 percent, 15 percent or 20 percent of) the volume level of the ambient sound in the physical environment (e.g., to reverse the attenuation by wearable audio output devices 301, so that user 804 can hear and respond to sounds in the physical environment as if user 804 were not wearing wearable audio output devices 301). In some embodiments, wearable audio output devices 301 amplify the ambient sound from the physical environment so that user 804 hears the ambient sound at a volume level above the volume level of ambient sound in the physical environment (e.g., to assist users that are hard of hearing), as indicated by perceived ambient sound waveform 816-3. In some embodiments, the ANC mode is disabled in response to the speech between person 820 and user 804, but the active transparency mode is not enabled. In some embodiments, the active transparency mode is enabled (and/or a degree of active transparency is increased) in response to the speech between person 820 and user 804 and in accordance with a speech detection mode of wearable audio output devices 301 and/or device 100 being enabled.

FIG. 8D shows user 804 speaking with person 820, as indicated by speech bubble 826, at a third time, subsequent to the first time (and optionally the second time). Device content waveform 808-4 in FIG. 8D shows that the volume level of the audio content from the device continues to be at a reduced relative to the level shown by device content waveform 808-2 in FIG. 8B. FIG. 8D also shows antiphase waveform 814-4 continuing to be at zero (e.g., ANC being disabled) and perceived ambient sound waveform 816-4 continuing to be higher than attenuated ambient sound level 812-4 (e.g., active transparency being enabled).

FIG. 8E shows user 804 and person 820 have ceased their conversation at a fourth time, subsequent to the third time. As a result of the speech having ceased, the active transparency mode is disabled in FIG. 8E, as indicated by perceived ambient sound waveform 816-5 being the same as attenuated ambient sound level 812-5. As a result of the speech having ceased (e.g., for at least a predefined amount of time), the ambient sound present in the physical environment, as shown by ambient sound waveform 810-5, and the attenuated ambient sound, as shown by attenuated ambient sound waveform 812-5, return to the same levels as shown in FIG. 8A. Accordingly, in some embodiments, the ambient sound present in the physical environment again satisfies predefined audio output criteria. In the example of FIG. 8E, the ANC mode is disabled as indicated by antiphase waveform 814-5 and device content waveform 808-5 shows that the volume level of the audio content from the device continues to be at a reduced relative to the level shown by device content waveform 808-2. In some embodiments, active transparency is disabled after a first time period from the speech having ceased and ANC is re-enabled after a second time period from the speech having ceased, the second time period being longer than the first time period. In some embodiments, the volume level of the audio content from the device is increased after the first time period, after the second time period, or after a third time period that is different than the first time period and the second time period.

FIG. 8F illustrates a transition from FIG. 8E. In particular, FIG. 8F indicates that person 820 has stopped speaking and left physical environment (e.g., at a fifth time, subsequent to the fourth time). In some embodiments, the ambient sound present in the physical environment in FIG. 8F is considered to no longer satisfy the second predefined audio output criteria. In response, wearable audio output devices 301 resume playback of the audio content from the device at the same (or similar) volume level as in FIG. 8A, as indicated by device content waveform 808-6 in FIG. 8F. Wearable audio output devices 301 also resume active noise control, and accordingly resume generating a noise-cancelling signal, as indicated by antiphase waveform 814-6, to cancel the attenuated ambient sound indicated by attenuated ambient sound waveform 812-6. As a result of the resumed active noise control, little (or no) ambient sound is perceived by user 804, as indicated by perceived ambient sound waveform 816-6.

In some embodiments, FIGS. 8A-8F correspond to a speech detection mode of wearable audio output devices 301 being enabled. In some embodiments, the speech detection mode corresponds to speech detection control 718 of FIG. 7B. In some embodiments, in accordance with the speech detection mode of wearable audio output devices 301 being disabled, speech in the physical environment is not identified (e.g., audio from the physical environment is not analyzed to determine whether it includes speech). In some embodiments, in accordance with the speech detection mode of wearable audio output devices 301 being disabled, ANC, active transparency, and/or audio content are not adjusted in accordance with the speech from user 804, speech directed to user 804, and/or a conversation between user 804 and another person or speaking device.

FIG. 8G-8P illustrate changes in audio outputs provided by wearable audio output devices 301 worn by user 804 in response to changes in ambient sound in a physical environment surrounding user 804. FIG. 8G shows user 804 seated at their desk wearing audio output devices 301. In FIG. 8G, adaptive noise management mode 833 of wearable audio output devices 301 is enabled and adaptive volume mode 835 wearable audio output devices 301 is enabled. FIG. 8G further shows ANC mode 830 active and having an output volume level of 830-1 and media content 831 having an output volume level of 831-1. In some embodiments, adaptive noise management mode 833 corresponds to noise management control 714 of FIG. 7B. In some embodiments, adaptive volume mode 835 corresponds to volume adjustment control 716 of FIG. 7B.

FIG. 8H shows two people, 832-1 and 832-2, having a conversation near user 804, as indicated by speech bubble 834. In the example of FIG. 8H, the nearby people are not talking to user 804 and wearable audio output devices 301 adjust outputs accordingly. ANC mode 830 in FIG. 8H has an output volume level of 830-2, higher than 830-1, e.g., to cancel noise from the conversation between person 832-1 and person 832-2. Media content 831 has an output volume level of 831-2, higher than 831-1, e.g., to compensate for noise from the conversation between person 832-1 and person 832-2.

FIG. 8I shows that the conversation between person 832-1 and person 832-2 has ended and that person 832-2 has left the area. Person 832-1 is not talking in FIG. 8I. ANC mode 830 in FIG. 8I has an output volume level of 830-3, lower than 830-2, e.g., due to no longer needing to cancel noise from the conversation between person 832-1 and person 832-2. Media content 831 has an output volume level of 831-1, lower than 831-1, e.g., due to no longer needing to compensate for noise from the conversation between person 832-1 and person 832-2.

FIG. 8J shows person 832-1 talking to user 804, as indicated by speech bubble 834. In the example of FIG. 8J, person 832-1 says the name of user 804. ANC mode 830 in FIG. 8J has an output volume level of 830-4, lower than 830-3, e.g., due to detecting the speech from person 832-1 that is (or may be) directed to user 804. The media content 831 has an output volume level of 831-3, lower than 831-1, e.g., due to detecting the speech from person 832-1 that is (or may be) directed to user 804. In some embodiments, the speech is determined to be directed to user 804 in accordance with recognition of user 804's name in the speech. In some embodiments, the speech is determined to be directed to user 804 based on the relative positions of user 804 and person 832-1 and/or the direction that person 832-1 is facing.

FIG. 8K shows person 832-1 continuing to talk to user 804, as indicated by speech bubble 842. For example, FIG. 8K corresponds to a second time, after a first time corresponding to FIG. 8J. ANC mode 830 in FIG. 8K is disabled (e.g., so that user 804 can hear person 832-1 more clearly). Active transparency mode 840 is enabled and has an output volume level of 840-1, e.g., to further assist user 804 in being able to hear person 832-1. Media content 831 has an output volume level of 831-3, e.g., due to detecting the speech from person 832-1 that is (or may be) directed to user 804. In the example of FIGS. 8J-8K, wearable audio output devices 301 switch from an ANC mode to an active transparency mode based on the conversation between user 804 and person 832-1. In some embodiments, wearable audio output devices 301 change a level (e.g., a degree) of ANC or active transparency based on the conversation between user 804 and person 832-1, but do not switch from the ANC mode to the active transparency mode.

FIG. 8L shows person 832-1 continuing to talk to user 804, as indicated by speech bubble 844, while having moved further away from user 804. For example, FIG. 8L corresponds to a third time, after the second time corresponding to FIG. 8K. Active transparency mode 840 is enabled and has an output volume level of 840-2, greater than output volume level 840-1, e.g., to further assist user 804 in being able to hear person 832-1 as person 832-1 moves further away (and/or speaks more quietly). Media content 831 has an output volume level of 831-3, e.g., due to detecting the speech from person 832-1 that is (or may be) directed to user 804.

FIG. 8M shows user input 850 from user 804 at wearable audio output device 301-2. FIG. 8M further shows feedback 852 output by wearable audio output device 301-2 in response to detecting user input 850. In some embodiments, feedback 852 does not include words (e.g., includes tones and/or pulses). In some embodiments, feedback 852 includes haptic feedback. In accordance with some embodiments, the adaptive noise management mode 833 is toggled off in response to detecting user input 850 (e.g., as indicated by feedback 852). In the example of FIG. 8M, user input 850 is a type of input mapped to a noise adjustment function (e.g., toggling the adaptive noise management mode). For example, user input 850 may be a light press, a deep press, a long press, a squeeze, a button press, a crown or knob rotation, or other type of gesture.

FIG. 8N shows user input 854 from user 804 at wearable audio output device 301-1. FIG. 8N further shows feedback 856 output by wearable audio output device 301-1 in response to detecting user input 854. In some embodiments, feedback 856 does not include words (e.g., includes tones and/or pulses). In some embodiments, feedback 856 includes haptic feedback. In accordance with some embodiments, the adaptive volume mode 835 is toggled off in response to detecting user input 854 (e.g., as indicated by feedback 856). In the example of FIG. 8N, user input 854 is a type of input mapped to a volume adjustment function (e.g., toggling the adaptive volume mode). For example, user input 854 may be a light press, a deep press, a long press, a squeeze, or other type of gesture.

In the example of FIGS. 8M and 8N, a same type of gesture detected at different wearable audio output devices causes different functions to be performed. FIG. 8M shows an input at wearable audio output device 301-2 toggling an adaptive noise management mode (e.g., a first function) and FIG. 5P shows a same type of input at wearable audio output device 301-1 toggling an adaptive volume mode (e.g., a second function). In some embodiments, the function performed in response to a particular type of input is based on an input mapping (e.g., default or set by the user) as described previously with respect to FIGS. 6D-6E.

FIG. 8O shows user 804 seated at their desk wearing audio output devices 301. In FIG. 8O, adaptive noise management mode 833 of wearable audio output devices 301 is disabled and adaptive volume mode 835 wearable audio output devices 301 is disabled. FIG. 8O further shows ANC mode 830 active and having an output volume level of 830-1 and media content 831 having an output volume level of 831-1.

FIG. 8P shows two people, 832-1 and 832-2, having a conversation near user 804, as indicated by speech bubble 864. In the example of FIG. 8P, the nearby people are not talking to user 804, but wearable audio output devices 301 forgo adjust outputs in accordance with adaptive noise management mode 833 and adaptive volume mode 835 being disabled. Accordingly, FIG. 8P further shows ANC mode 830 active and having an output volume level of 830-1 and media content 831 having an output volume level of 831-1. As illustrated in FIGS. 8G-8H, in accordance adaptive noise management mode 833 and adaptive volume mode 835 being enabled, wearable audio output devices 301 adjust ANC mode 830 and media content 831 in response to changes in the environment of user 804. As illustrated in FIGS. 8G-8H, in accordance adaptive noise management mode 833 and adaptive volume mode 835 being disabled, wearable audio output devices 301 forgo adjusting ANC mode 830 and media content 831 in response to changes in the environment of user 804.

Although FIGS. 8G-8P illustrate examples of speech in the environment, wearable audio output devices 301 can adjust ANC, active transparency, and/or media content volume levels in response to other changes in the environment of user 804 in a similar manner. For example, in response to detecting an alarm signal (e.g., a fire alarm), wearable audio output devices 301 reduce ANC, raise active transparency, and/or reduce media content volume so that user 804 is able to better hear the alarm. As another example, in response to detecting particular traffic noises (e.g., a car and/or train horn), wearable audio output devices 301 reduce ANC, raise active transparency, and/or reduce media content volume so that user 804 is able to better hear the traffic (e.g., and safely respond). In some embodiments, in response to detecting particular traffic noises and in accordance with a determination that the user is moving (e.g., walking, biking, or driving), wearable audio output devices 301 reduce ANC, raise active transparency, and/or reduce media content volume. In some embodiments, in response to detecting traffic noises and in accordance with a determination that the user is stationary (e.g., seated, laying down, or standing in place), wearable audio output devices 301 increase ANC, decrease active transparency, and/or increase media content volume (e.g., so that the user is not bothered by traffic noises that aren't relevant to the user).

FIGS. 9A-9B illustrate example conversations and corresponding changes in the audio outputs of wearable audio output devices in accordance with some embodiments. FIG. 9A illustrates user 902 having a conversation with person 904 while wearing wearable audio output devices 301. In FIG. 9A, user 902 is listening to music or other audio content prior to a start of conversation with person 904 (e.g., prior to time t2). As shown in FIG. 9A, at a first time, t1, audio content 906 has a first level, ANC 908-1 has a first level, active transparency 910-1 is disabled, and neither user 902 nor person 904 is speaking, as indicated by lines 912-1 and 914-1 at t1. At a second time, t2, user 902 is speaking (e.g., corresponding to a start of conversation 916-1), as indicated by the increase in line 912-1 at t2, and audio content 906 has been reduced to a second level (e.g., lower than the first level). Additionally, at the second time, ANC is disabled and active transparency is enabled. At a third time, t3, person 904 is talking (e.g., conversation 916-1 is ongoing), as indicated by the increase in line 914-1 at t3, and audio content 906 is further reduced to a third level, less than the second level. At a fourth time, t4, user 902 has finished speaking (e.g., corresponding to an end (or pause) of conversation 916-1), as indicated by the decrease in line 912-1 at t4. At a fifth time, t5, a time period p1 has elapsed since the end of conversation 916-1 and audio content 906 returns to the first level, ANC is enabled, and active transparency is disabled. In some embodiments, the time period p1 is based on one or more characteristics of the conversation. For example, the time period is based on a cadence of the conversation, a duration of the conversation, and/or a type of speech that preceded the end of the conversation (e.g., a question, statement, or salutation). In the example of FIG. 9A, ANC is disabled and active transparency is enabled in accordance with the start of the conversation. In some embodiments, ANC is lowered or disabled, but active transparency is not enabled in accordance with the start of the conversation. In some embodiments, active transparency is enabled or increased in accordance with the start of the conversation if wearable audio output devices 301 are in an active transparency mode and/or a bypass mode at the start of the conversation. In some embodiments, FIG. 9A corresponds to a speech detection mode of wearable audio output devices 301 being enabled. In some embodiments, in accordance with the speech detection mode of wearable audio output devices 301 being disabled, a start of conversation 916-1 is not identified. In some embodiments, in accordance with the speech detection mode of wearable audio output devices 301 being disabled, ANC, active transparency, and/or audio content are not adjusted in accordance with the start of conversation 916-1. In some embodiments, the speech detection mode corresponds to speech detection control 718 of FIG. 7B.

FIG. 9B illustrates user 902 having another conversation with person 904 while wearing wearable audio output devices 301. In FIG. 9B, user 902 is listening to spoken word media content prior to a start of conversation with person 904 (e.g., prior to time t2). As shown in FIG. 9B, at a first time, t1, the spoken word media is playing, ANC 908-2 is disabled, active transparency 910-2 is disabled, and neither user 902 nor person 904 is speaking, as indicated by lines 912-2 and 914-2 at t1. At a second time, t2, person 904 is speaking (e.g., corresponding to a start of conversation 916-2), as indicated by the increase in line 912-2 at t2. In accordance with some embodiments, audio content 920 and active transparency 910-2 are unchanged at time t2 (e.g., audio content 920 and active transparency 910-2 do not change immediately after the start of conversation 916-2). At a third time, t3, conversation 916-2 is ongoing, and audio content 920 is paused (e.g., so that user 902 can focus on the conversation) and active transparency 910-2 is enabled, as indicated by the increase in line 910-2 at time t3. At a fourth time, t4, person 904 has finished speaking (e.g., corresponding to an end (or pause) of conversation 916-2), as indicated by the decrease in line 914-2 at t4. At a fifth time, t5, a time period p2 has elapsed since the end of conversation 916-2 and audio content 920 resumes (e.g., unpauses) and active transparency is disabled. In some embodiments, audio content 920 resumes at a point slightly before audio content 920 was paused. For example, audio content 920 resumes at a point 1 second, 2 seconds, or 5 seconds before the point where audio content 920 was paused. As shown in FIG. 9B, the time period p2 is longer than the time period p1 from FIG. 9A. In some embodiments, the time period p1 is based on one or more characteristics of conversation 916-1 and the time period p2 is based on one or more characteristics of conversation 916-2. In some embodiments, the one or more characteristics include a duration of the conversation, a cadence of the conversation, a type of speech preceding the pause in the conversation, and/or another characteristic of the conversation. In some embodiments, FIG. 9B corresponds to a speech detection mode of wearable audio output devices 301 being enabled. In some embodiments, in accordance with the speech detection mode of wearable audio output devices 301 being disabled, a start of conversation 916-2 is not identified. In some embodiments, in accordance with the speech detection mode of wearable audio output devices 301 being disabled, active transparency and/or audio content are not adjusted in accordance with the start of conversation 916-2. In some embodiments, the speech detection mode corresponds to speech detection control 718 of FIG. 7B.

FIGS. 10A-10E illustrate an example conversation and corresponding changes in the outputs of a multifunction device and wearable audio output devices in accordance with some embodiments. FIG. 10A shows user 1002 wearing wearable audio output devices 301 while listening to media content on device 100. Device 100 in FIG. 10A shows media user interface 1004 that includes image 1006 (e.g., a still image or video), media title 1008, media playback control 1010 (e.g., a pause button), and output volume control 1012. In some embodiments, media user interface 1004 includes a subset of the elements shown in FIG. 10A and/or one or more additional elements not shown in FIG. 10A.

FIG. 10B shows person 1014 talking to user 1002, as indicated by speech bubble 1016. In accordance with some embodiments, media user interface 1004 is obscured, as indicated by user interface 1018, (e.g., blurred, dimmed, and/or otherwise obscured) in response to detecting person 1014 talking to user 1002. In some embodiments, prior to detecting the speech, device 100 displays information about the audio playback to wearable audio output devices 301. In some embodiments, in response to detecting the speech, device 100 obscures the information about the audio playback. For example, the information about the audio playback includes a title, track, album, cover art, and/or artist of a song being played. As another example, the information about the audio playback includes a book title, chapter, description, cover page, cover art, and/or author name. In some embodiments, obscuring the information includes blurring the information. In some embodiments, obscuring the information includes reducing a size and/or emphasis of the information. In some embodiments, obscuring the information includes ceasing to display the information. In some embodiments, the information ceases to be obscured at the end of the first time period in accordance with the determination that the conversation had the first value for the respective characteristic. In some embodiments, the information about the audio playback ceases to be obscured at the end of a second time period in accordance with the determination that the conversation had a second value for the respective characteristic. In some embodiments, the information about the audio playback is obscured in accordance with a determination that the conversation has the first value for the respective characteristic. For example, a fast-paced conversation causes blurring of the audio playback information, and a slow-paced conversation causes a reduction in size of the audio playback information. As another example, the information about the audio playback is obscured in accordance with the conversation lasting longer than a threshold amount of time (e.g., lasting longer than 30 seconds, 1 minute, 2 minutes, 5 minutes, or 10 minutes).

In some embodiments, in response to detecting person 1014 talking to user 1002, device 100 reduces an audio fidelity of the audio playback. For example, a low pass filter is applied to the audio playback (e.g., to muffle the playback). As another example, an equalizer is applied to the audio playback to reduce higher frequency sounds such that low frequency sounds are more prominent than higher frequency sounds in the audio playback. In some embodiments, reducing the audio fidelity of the audio playback includes lowering a volume of the audio playback and/or applying a low pass filter to the audio playback. For example, reducing the audio fidelity the audio playback causes the audio playback to sound as though it is coming from another room sometimes referred to as “blurring” the audio. In some embodiments, reducing the audio fidelity includes increasing an amount of reverberation (e.g., a signal simulating one or more physical elements such as a room and/or furniture reverberating in response to a direct signal) relative to an amount of direct signal (e.g., in addition, or as an alternative, to reducing the audio volume and/or applying a low pass filter to the audio playback). In some embodiments, increasing the amount of reverberation relative to the amount of direct signal includes decreasing an amplitude of the direct signal and/or increasing an amount of reverberant audio (e.g., increasing a volume of the reverberant audio). In some embodiments, an amplitude of both direct signal and reverberant signal are reduced, but reverberant signal amplitude is reduced less than direct signal amplitude. In some embodiments, an amplitude of both direct signal and reverberant signal are increased, but reverberant signal amplitude is increased more than direct signal amplitude.

FIG. 10C shows the conversation between user 1002 and person 1014 continuing, as indicated by speech bubble 1020. FIG. 10C further shows that the media content playback has been paused, as indicated by playback control 1022 (e.g., a play button that, when selected, causes playback of the media content to resume). In some embodiments, the media content playback is paused in accordance with the conversation between user 1002 and person 1014 having one or more characteristics. For example, the one or more characteristics may include a duration, a cadence, an active speaker (e.g., user 1002), and/or another characteristic of the conversation.

FIG. 10D shows the conversation between user 1002 and person 1014 continuing, as indicated by speech bubble 1026. FIG. 10D further shows that the media content playback is still paused, as indicated by playback control 1022 and media user interface 1004 is still obscured, as indicated by user interface 1018. In the example of FIG. 10, person 1014 is saying goodbye (e.g., ending the conversation).

FIG. 10E shows that the conversation between user 1002 and person 1014 has ended and person 1014 has departed. For example, FIG. 10E corresponds to a second time that is later than a first time represented in FIG. 10D. FIG. 10E further shows that the media content playback has resumed, as indicated by playback control 1010, and media user interface 1004 is no longer obscured. In some embodiments, the amount of time that elapses between the end of the conversation and the resumption of the media content playback and unobscured user interface is based on one or more characteristics of the conversation. For example, the one or more characteristics may include a duration, a cadence, a type of speech preceding the end of the conversation, and/or another characteristic of the conversation.

FIGS. 11A-11M illustrate example user interfaces, user interactions, and connectivity for audio output devices in accordance with some embodiments. FIG. 11A shows an environment that includes wearable audio output devices 301 and a variety of portable electronic devices associated with various user accounts. The portable electronic devices in FIG. 11A include devices 100-1 and 100-2 associated with a first user account, devices 100-3 and 100-6 associated with a second user account, device 100-4 associated with a third user account, and devices 100-5 and 100-7 associated with a fourth user account. In the example of FIG. 11A each of the devices 100-1 through 100-7 are within communication range 1101 of wearable audio output devices 301. For example, communication range 1101 corresponds to a device-to-device connection range, e.g., via Bluetooth, Wi-Fi direct, or other communication protocol. As shown by the chart in FIG. 11A, the first user account is a guest account for wearable audio output devices 301, the second user account is the designated owner account for wearable audio output devices 301, the third user account is not associated with wearable audio output devices 301, and the fourth user account is a permanent account for wearable audio output devices 301.

FIG. 11B shows wearable audio output devices 301 communicatively coupled via guest association 1102 to device 100-1, which is associated with the first user account. In some embodiments, the communicatively coupling includes pairing wearable audio output devices 301 with device 100-1. In some embodiments, audio output from device 100-1 is routed to wearable audio output devices 301 while wearable audio output devices 301 are communicatively coupled to device 100-1. In some embodiments, guest association 1102 represents an audio route established between wearable audio output devices 301 a device 100-1. In some embodiments, the audio route allows for audio from device 100-1 to be output via wearable audio output devices 301.

FIG. 11C shows device 100-2, associated with the first user account, entering communication range 1101 and communicatively coupling with wearable audio output devices 301. In some embodiments, device 100-2 automatically, without user input, communicatively couples with wearable audio output devices 301 due to device 100-2 being on a same user account as device 100-1 (e.g., the first user account). In some embodiments, guest association 1104 replaces guest association 1102 in FIG. 11B. In some embodiments, wearable audio output devices 301 concurrently couple to device 100-1 and device 100-2. In some embodiments, device 100-2 is given priority over device 100-1 for coupling to wearable audio output devices 301 (e.g., due to a user preference and/or setting).

FIG. 11D shows device 100-2, associated with the first user account, communicatively coupled with wearable audio output devices 301. In FIG. 11D, device 100-1 has left communication range 1101. In some embodiments, device 100-2 communicatively couples to wearable audio output devices 301 in response to device 100-1 decoupling (e.g., due to being powered off and/or leaving communication range 1101).

FIG. 11E shows device 100-3, associated with the second user account, entering communication range 1101. In accordance with some embodiments, device 100-3 does not automatically, without user input, communicatively couple with wearable audio output devices 301, e.g., due to device 100-3 being on a different user account than device 100-2. In the example of FIG. 11E, coupling user interface 1108 is displayed on device 100-3 in response to device 100-3 entering communication range 1101. Coupling user interface 1108 includes a connect element (e.g., software button) 1110 that, when selected, initiates a process to communicatively couple device 100-3 with wearable audio output devices 301. Coupling user interface 1108 further includes text notifying the user of device 100-3 that coupling with wearable audio output devices 301 will remove guest association 1104 (e.g., due to the first account being a guest account). FIG. 11E further shows user input 1112 at connect element 1110. In some embodiments, coupling user interface 1108 is displayed in accordance with a determination that the second user account is designated as the owner of wearable audio output devices 301 and/or a determination that the first account is a guest account for wearable audio output devices 301. In some embodiments, coupling user interface 1108 is overlaid over a previously displayed user interface (e.g., a wake screen, a home screen, an application-specific user interface, or other type of user interface). In some embodiments, a first type of input at coupling user interface 1108 causes coupling user interface 1108 to cease to be displayed (e.g., a swipe gesture, such as a swipe up gesture). In some embodiments, coupling user interface 1108 includes a dismiss element (e.g., an ‘X’ icon), that, when selected, causes coupling user interface 1108 to cease to be displayed.

FIG. 11F shows device 100-3 being communicatively coupled, via association 1116, to wearable audio output devices 301 in response to user input 1112 in FIG. 11E. In the example of FIG. 11F, device 100-2 is no longer communicatively coupled to wearable audio output devices 301 (e.g., guest association 1104 is replaced with association 1116 in response to user input 1112). FIG. 11F further shows, in the table, that the first user account is no longer associated with wearable audio output devices 301 (e.g., due to user input 1112).

FIG. 11G shows device 100-3 continuing to be communicatively coupled, via association 1116, to wearable audio output devices 301. In the example of FIG. 11G, device 100-4, associated with the third user account, is in communication range 1101. Device 100-4 does not automatically communicatively couple to wearable audio output devices 301, e.g., due to the third user account not being associated with wearable audio output devices 301. Bringing device 100-4 within communication range 1101 does not cause display of a coupling user interface, such as coupling user interface 1108, e.g., due to the third user account not being associated with wearable audio output devices 301.

FIG. 11H shows device 100-3 continuing to be communicatively coupled, via association 1116, to wearable audio output devices 301. In the example of FIG. 11H, device 100-5, associated with the fourth user account, is in communication range 1101. Device 100-5 does not automatically communicatively couple to wearable audio output devices 301, e.g., due to a different user account (e.g., the second user account) being communicatively coupled. In the example of FIG. 11H, in accordance with device 100-5 being within communication range 1101, coupling user interface 1120 is displayed on device 100-3. Coupling user interface 1120 includes a notification regarding device 100-5 being within communication range 1101 and connection element 1122 that, when selected, initiates a process to communicatively couple device 100-5 with wearable audio output devices 301. FIG. 11H further shows user input 1124 selecting connection element 1122. In some embodiments, coupling user interface 1120 is overlaid over a previously displayed user interface (e.g., a wake screen, a home screen, an application-specific user interface, or other type of user interface). In some embodiments, a first type of input at coupling user interface 1120 causes coupling user interface 1120 to cease to be displayed (e.g., a swipe gesture, such as a swipe up gesture). In some embodiments, coupling user interface 1120 includes a dismiss element (e.g., an ‘X’ icon), that, when selected, causes coupling user interface 1120 to cease to be displayed. In accordance with some embodiments, coupling user interface 1120 is displayed at device 100-3, as opposed to a coupling user interface being displayed at device 100-5, due to the second user account being designated as the owner of wearable audio output devices 301.

FIG. 11I shows device 100-5 being communicatively coupled, via association 1126, to wearable audio output devices 301 in response to user input 1124 in FIG. 11H. In the example of FIG. 11I, device 100-3 is no longer communicatively coupled to wearable audio output devices 301 (e.g., association 1116 is replaced with association 1126 in response to user input 1124).

FIG. 11J shows device 100-5 continuing to be communicatively coupled, via association 1126, to wearable audio output devices 301. In the example of FIG. 11J, device 100-6, associated with the second user account, is in communication range 1101. Device 100-6 does not automatically communicatively couple to wearable audio output devices 301, e.g., due to a different user account (e.g., the fourth user account) being communicatively coupled. In the example of FIG. 11J, in accordance with device 100-6 being within communication range 1101, coupling user interface 1128 is displayed on device 100-6. Coupling user interface 1128 includes a notification regarding device 100-5 being communicatively coupled with wearable audio output devices 301 and connection element 1130 that, when selected, initiates a process to communicatively couple device 100-6 with wearable audio output devices 301. In some embodiments, coupling user interface 1128 is overlaid over a previously displayed user interface (e.g., a wake screen, a home screen, an application-specific user interface, or other type of user interface). In some embodiments, a first type of input at coupling user interface 1128 causes coupling user interface 1128 to cease to be displayed (e.g., a swipe gesture, such as a swipe up gesture). In some embodiments, coupling user interface 1128 includes a dismiss element (e.g., an ‘X’ icon), that, when selected, causes coupling user interface 1128 to cease to be displayed. In the example of FIG. 11J, connection element 1130 is not selected by the user. In accordance with some embodiments, coupling user interface 1128 is displayed at device 100-6, as opposed to a coupling user interface being displayed at device 100-5, due to the second user account being designated as the owner of wearable audio output devices 301.

FIG. 11K shows device 100-7, associated with the fourth user account, entering communication range 1101 and communicatively coupling with wearable audio output devices 301. In some embodiments, device 100-7 automatically, without user input, communicatively couples with wearable audio output devices 301 due to device 100-7 being on a same user account as device 100-5 (e.g., the fourth user account). In some embodiments, association 1132 replaces association 1126 in FIG. 11J. In some embodiments, wearable audio output devices 301 concurrently couple to device 100-5 and device 100-7. In some embodiments, device 100-7 is given priority over device 100-5 for coupling to wearable audio output devices 301 (e.g., due to a user preference and/or setting).

FIG. 11L shows device 100-4, associated with the third user account, being within communication range 1146 of wearable audio output devices 301 while wearable audio output devices 301 are in wireless accessory case 1142. Wireless accessory case 1142 includes a button 1144 that, when selected, initiates a process to communicatively couple (e.g., pair) wearable audio output devices 301 (and optionally wireless accessory case 1142) with device 100-4. For example, selection of button 1144 causes display of coupling user interface 1140 on device 100-4. In some embodiments, coupling user interface 1140 is displayed in response to an input at device 100-4 (e.g., an input identifying wearable audio output devices 301 for communicatively coupling). Coupling user interface 1140 includes text notifying the user that wearable audio output devices 301 are associated with a different account, temporary share element 1150, and permanent association element 1152. FIG. 11L further shows wearable audio output devices 1149 (e.g., communicatively coupled to device 100-4) associated with the third user account. In some embodiments, temporary share element 1150 is displayed in accordance with a determination that wearable audio output devices 1149 are nearby (e.g., within a communication range of device 100-4). In some embodiments, wearable audio output devices 1149 are determined to be nearby when wearable audio output devices 1149 are within a predefined distance of device 100-4 (e.g., determined based on one or more position sensors, such as a GPS sensor). FIG. 11L further shows user input 1151 at a location that corresponds to temporary share element 1150 and user input 1153 at a location that corresponds to permanent association element 1152. In some embodiments, in response to detecting user input 1151, a process is initiated to establish a temporary (e.g., one time) communicative coupling between the device 100-4 and wearable audio output devices 301. In some embodiments, in response to detecting user input 1151, a process is initiated to establish a communicative coupling between the device 100-4 and wearable audio output devices 301 without generating an association between the third user account and wearable audio output devices 301. In some embodiments, in response to detecting user input 1153, a process is initiated to (i) establish a communicative coupling between the device 100-4 and wearable audio output devices 301 and (ii) generate an association between the third user account and wearable audio output devices 301.

FIG. 11M shows device 100-4, associated with the third user account, being within communication range 1146 of wearable audio output devices 301 while wearable audio output devices 301 are in wireless accessory case 1142. In some embodiments, selection of button 1144 causes display of coupling user interface 1160 on device 100-4. In some embodiments, coupling user interface 1160 is displayed in response to an input at device 100-4 (e.g., an input identifying wearable audio output devices 301 for communicatively coupling). Coupling user interface 1160 includes text notifying the user that wearable audio output devices 301 are associated with a different account, guest association element 1162, and permanent association element 1164. In some embodiments, guest association element 1162 is displayed in accordance with a determination that no other wearable audio output devices associated with the third user account are nearby. In some embodiments, coupling user interface 1140 (e.g., as shown in FIG. 11L) is displayed in accordance with a determination that at least one wearable audio output device associated with the third user account is nearby and coupling user interface 1160 (e.g., as shown in FIG. 11M) is displayed in accordance with a determination that no wearable audio output devices associated with the third user account are nearby.

FIG. 11M further shows user input 1166 at a location that corresponds to guest association element 1162 and user input 1168 at a location that corresponds to permanent association element 1164. In some embodiments, in response to detecting user input 1166, a process is initiated to establish communicative coupling between the device 100-4 and wearable audio output devices 301 via a guest association. In some embodiments, in response to detecting user input 1166, a process is initiated to (i) establish a communicative coupling between the device 100-4 and wearable audio output devices 301 and (ii) generate a guest association between the third user account and wearable audio output devices 301. For example, a guest association is an association between wearable audio output devices 301 and a particular user account that is maintained until a device associated with another user account (e.g., the owner account) communicatively couples with wearable audio output devices 301. In some embodiments, in response to detecting user input 1168, a process is initiated to (i) establish a communicative coupling between the device 100-4 and wearable audio output devices 301 and (ii) generate an association between the third user account and wearable audio output devices 301. In some embodiments, a coupling user interface includes a selectable temporary share element (e.g., temporary share element 1150), a guest association element (e.g., guest association element 1162), and/or a permanent association element (e.g., permanent association element 1164).

FIGS. 12A-12G illustrate example user interfaces and user interactions corresponding to various associated audio output devices in accordance with some embodiments. FIG. 12A shows device 100-4 displaying account user interface 1202. In some embodiments, account user interface 1202 is displayed in response to a user input at device 100-4 (e.g., selecting an account icon displayed on a control user interface or home screen, or selecting an account element on a settings user interface). Account user interface 1202 includes account identifier 1204, selectable cloud storage element 1208, selectable app store element 1210, selectable subscriptions element 1212, listing 1214 of devices associated with the third user account (e.g., denoted ‘My Devices’), and listing 1222 of devices having a guest association with the third user account. In some embodiments, selectable cloud storage element 1208, when selected, causes display of a user interface with information about and/or settings for a cloud storage account associated with the third user account. In some embodiments, selectable app store element 1210, when selected, causes display of a user interface with information about and/or settings for an app store account associated with the third user account.

Listing 1214 includes selectable element 1216 denoted ‘John's Phone’, selectable element 1218 denoted ‘John's Tablet, and selectable element 1220 denoted ‘John's Earbuds’. In some embodiments, selectable element 1216, when selected, causes display of a user interface with information about and/or settings for the device named John's Phone. In some embodiments, selectable element 1218, when selected, causes display of a user interface with information about and/or settings for the device named John's Tablet. Listing 1222 includes selectable element 1224 denoted ‘Max's Earbuds’. FIG. 12A further shows user input 1226 at selectable element 1220.

FIG. 12B shows device 100-4 displaying user interface 1228 in response to user input 1226 in FIG. 12A. User interface 1128 is similar to user interface 610 of FIG. 6B. User interface 1228 corresponds to a set of devices named “John's Earbuds” (e.g., an instance of wearable audio output devices 301) and includes selectable element 1230 indicating a name of the set of devices, selectable element 1232 indicating a noise control mode of the set of devices, selectable element 1234 indicating a tap input mapping for the left device of the set of devices, selectable element 1236 indicating a tap input mapping for the right device of the set of devices, and selectable element 1238 that, when selected, causes display of a user interface for conducting an car tip fit test and/or initiates a process for conducting the car tip fit test. In some embodiments, selectable element 1230, when selected, causes display of a user interface for renaming the set of devices. In some embodiments, selectable element 1232 includes an ANC icon that, when selected, causes the set of devices to operate in an ANC mode, a transparency icon that, when selected causes the set of devices to operate in an active transparency mode, and an off icon that, when selected causes the set of devices to operate in a bypass mode (e.g., in which ANC and active transparency are both off). In some embodiments, selectable element 1234, when selected, causes display of a user interface for adjusting a mapping between a tap input at the left device and a corresponding function. In some embodiments, selectable element 1236, when selected, causes display of a user interface for adjusting a mapping between a tap input at the right device and a corresponding function. FIG. 12B further shows user input 1239 on user interface 1228. In the example of FIG. 12B, user input 1239 is a swipe up gesture that causes user interface 1228 to scroll downward.

FIG. 12C shows user interface 1228 after the downward scroll caused by user input 1239. User interface 1228 in FIG. 12C includes selectable element 1238, selectable element 1240 indicating a call control mapping, selectable element 1242 indicating whether an car detection mode is enabled, selectable element 1244 indicating a spatial audio setting of the set of devices, selectable element 1246 indicating that a device tracking mode is enabled for the set of devices, and a portion of element 1248 showing information about the set of devices. In some embodiments, selectable element 1240, when selected, causes display of a user interface for adjusting a mapping between an end call function and an input at the set of devices. In some embodiments, selectable element 1242, when selected, toggles enablement of the car detection mode. In some embodiments, selectable element 1244, when selected, causes display of a user interface for adjusting a spatial audio setting for the set of devices. FIG. 12C further shows user input 1250 on user interface 1228. In the example of FIG. 12C, user input 1250 is a swipe up gesture that causes user interface 1228 to scroll downward.

FIG. 12D shows user interface 1228 after the downward scroll caused by user input 1250. User interface 1228 in FIG. 12D includes selectable element 1246, element 1248 including information about a model name, model number, serial number, and/or version for the set of devices, selectable element 1258 indicating whether coverage is active for the set of devices, selectable element 1260, and selectable element 1262. In some embodiments, selectable element 1258, when selected, causes display of a user interface with information about, and/or settings for, protective coverage of the set of devices (e.g., an insurance policy covering the set of devices). In some embodiments, selectable element 1260, when selected, causes device 100-4 to disconnect from the set of devices. In some embodiments, selectable element 1262, when selected, causes device 100-4 to delete the association with the set of devices (and/or disconnect from the set of devices). For example, selectable element 1262, when selected, removes the association between the set of devices and the third user account.

FIG. 12E shows user input 1266 at selectable element 1224 of user interface 1202 denoted ‘Max's Earbuds’. FIG. 12F shows device 100-4 displaying user interface 1268 in response to user input 1266 in FIG. 12E. User interface 1268 is similar to user interface 610 of FIG. 6B. User interface 1268 corresponds to a set of devices named “Max's Earbuds” (e.g., an instance of wearable audio output devices 301) and includes selectable element 1270 indicating a name of the set of devices, selectable element 1272 indicating a noise control mode of the set of devices, selectable element 1274 indicating a tap input mapping for the left device of the set of devices, selectable element 1276 indicating a tap input mapping for the right device of the set of devices, and selectable element 1278 that, when selected, causes display of a user interface for conducting an car tip fit test and/or initiates a process for conducting the car tip fit test. In some embodiments, selectable element 1270, when selected, causes display of a user interface indicating that the set of devices is not owned by the third user account (e.g., naming user interface 628, FIG. 6C). In some embodiments, selectable element 1272 includes an ANC icon that, when selected, causes the set of devices to operate in an ANC mode, a transparency icon that, when selected causes the set of devices to operate in an active transparency mode, and an off icon that, when selected causes the set of devices to operate in a bypass mode (e.g., in which ANC and active transparency are both off). In some embodiments, selectable element 1274, when selected, causes display of a user interface for adjusting a mapping between a tap input at the left device and a corresponding function. In some embodiments, selectable element 1276, when selected, causes display of a user interface for adjusting a mapping between a tap input at the right device and a corresponding function. FIG. 12F further shows user input 1280 on user interface 1268. In the example of FIG. 12F, user input 1280 is a swipe up gesture that causes user interface 1268 to scroll downward.

FIG. 12G shows user interface 1268 after the downward scroll caused by user input 1280. User interface 1268 in FIG. 12G includes selectable element 1278, selectable element 1282 indicating a call control mapping for the set of devices, selectable element 1284 indicating whether an ear detection mode is enabled, selectable element 1286 indicating a spatial audio setting of the set of devices, and selectable element 1288. FIG. 12G further shows user input 1279 selecting selectable element 1278, user input 1283 selecting selectable element 1282, user input 1285 selecting selectable element 1284, user input 1287 selecting selectable element 1286, and user input 1289 selecting selectable element 1288. In some embodiments, user input 1279 causes display of a user interface for conducting an car tip fit test and/or initiates a process for conducting the car tip fit test displayed. In some embodiments, user input 1283 causes display of a user interface for adjusting a mapping between an end call function and an input at the set of devices. In some embodiments, user input 1285 causes an car detection mode to be toggled. In some embodiments, user input 1287 causes display of a user interface for adjusting a spatial audio setting for the set of devices. In some embodiments, user input 1289 causes device 100-4 to disconnect from the set of devices and causes deletion of the guest association between device 100-4 and the set of devices.

Thus, FIGS. 12B-12D illustrate options available to a user of device 100-4 for earbuds that are associated with the third user account and FIGS. 12F-12G illustrate options available to the user of the device 100-4 for earbuds that have a guest association with the third user account. As shown in FIGS. 12B-12G, the user of device 100-4 has more information about and options for devices that have an association (e.g., a permanent association) with the third user account as compared to devices that have a guest association with the third user account.

FIGS. 13A-13C are flow diagrams illustrating method 1300 for adjusting a mute state of a microphone of one or more wearable audio output devices in accordance with some embodiments. Method 1300 is performed at a wearable audio output device (e.g., wearable audio output device 301, FIGS. 3B-3C) that includes a microphone (e.g., microphones 302) and one or more input devices (e.g., input devices 308). Examples of the wearable audio output device include in-ear earphones (sometimes called earbuds), over-ear headphones, or other wearable audio output device. In some embodiments, the wearable audio output device includes a speaker (e.g., speaker(s) 306) or other audio output device and optionally one or more elements to enable the speaker to be positioned in a respective physical arrangement relative to an ear of a person using the wearable audio output device. In some embodiments, the wearable audio output device includes a housing with one or more physically distinguished portions. In some embodiments, the wearable audio output device includes one or more audio output devices (e.g., speaker(s) 306). In some embodiments, the wearable audio output device includes one or more placement sensors (e.g., sensor(s) 304). Some operations in method 1300 are, optionally, combined and/or the order of some operations is, optionally, changed.

As described below, method 1300 provides an improved interface for controlling an audio device, such as a wearable audio device, by adjusting operation of a microphone of the audio device in response to a particular type of gesture. Providing additional control options for controlling the audio device, such as changing microphone modes, changing audio output modes, interacting with a digital assistant, and/or adjusting audio playback, reduces power usage and improves battery life (e.g., by alleviating the need to power a display and/or power communication circuitry to communicate with a remote display) and allows for a user to not have to switch between multiple devices to interact with the audio device (e.g., the user need not find/switch to other electronic devices (e.g., a smartphone or tablet) to control the audio inputs/outputs), as well as reducing the number of inputs needed for the user to control the audio device, and enhances the operability of the audio output device and makes the user-device interface more efficient (e.g., by helping the user to achieve an intended outcome and reducing user mistakes when operating/interacting with the audio output device), which, additionally, reduces power usage and improves battery life of the audio output device by enabling the user to use the audio output device more quickly and efficiently.

The wearable audio output device detects (1302) an input (e.g., user input 518 in FIG. 5B) via one or more input devices (e.g., input device(s) 308). In some embodiments, the one or more input devices include one or more capacitive sensors, one or more force sensors, one or more motion sensors, and/or one or more device orientation sensors. In some embodiments, the one or more input devices include a sequence of capacitive sensors arranged to detect user gestures. In some embodiments, the sequence of capacitive sensors are arranged in a column or row along a length of a stem of the wearable audio output device. In some circumstances, capacitive sensors consume less power and/or provide improved detection of user touch gestures than other types of sensors (e.g., force or pressure sensors).

In some embodiments, the wearable audio output device is (1304) in communication with a second wearable audio output device (e.g., wearable audio output device 301-2) to form a set of wearable audio output devices (e.g., two or more wearable audio output devices that work together to provide audio output for the user, optionally creating audio effects such as stereo audio, spatial audio, noise cancellation and/or active transparency). In some embodiments, the wearable audio output device and the second wearable audio device have different behaviors in response to user inputs. For example, the first wearable audio output device has a different set of assignments between types of input gesture and operations performed in response than the second wearable audio output device. As an example, a squeeze gesture detected via the first wearable audio output device changes a mute state of the wearable audio output device, while a different gesture, such as a tap gesture, detected via the second wearable audio output device changes a mute state of the second wearable audio output device. In this example, a squeeze gesture detected via the second wearable audio output device causes performance of a different operation, such as toggling playback of media content instead of changing the mute state.

In response to detecting the input (1306), in accordance with a determination that the input is a first type of input, the wearable audio output device adjusts (1308) a mute state of the microphone for a first audio function that uses the microphone without adjusting the mute state of the microphone for a second audio function that uses the microphone. For example, FIGS. 5B-5D show user input 518 causing the microphone to mute for the video chat (e.g., as indicated by microphone icon 514) while keeping the microphone unmuted for a digital assistant function (e.g., as indicated by notification 522).

In some embodiments, adjusting the mute state of the microphone for the first audio function comprises adjusting the mute state for both the wearable audio output device and the second wearable audio output device in the set of wearable audio output devices. In some embodiments, each wearable audio output device includes a respective microphone. In some embodiments, the pair of wearable audio output devices are configured such that only one microphone is active at any particular time. In some embodiments, the input causes each microphone to be muted. Adjusting the mute state for both wearable audio output devices in response to a single gesture reduces the number of inputs needed, which enhances the operability of the devices and makes the user-device interface more efficient (e.g., by helping the user to achieve an intended outcome and reducing user mistakes when operating/interacting with the devices), which, additionally, reduces power usage and improves battery life of the devices by enabling the user to use the devices more quickly and efficiently.

In some embodiments, the second wearable audio output device detects a second input at the second wearable audio output device; and, in response to detecting the second input and in accordance with a determination that the second input is the first type of input, activates a second function of the second wearable audio output device, where the second function of the second wearable audio output device is distinct from adjusting the mute state. For example, FIG. 5B shows user input 518 (e.g., a first type of user input) detected at wearable audio output device 301-1 (e.g., a second wearable audio output device), where user input 518 corresponds to a function for adjusting the mute state of a microphone as indicated by notification 519. FIG. 5H shows user input 532 (e.g., a second type of user input) detected at wearable device 301-1, where user input 532 corresponds to a change in volume as indicated by output volume 534 changing from output level 536-1 (in FIG. 5H) to output level 536-2 (in FIG. 5I) in response to wearable audio output device 301-1 detecting user input 532.

For example, each wearable audio output device has a respective input mapping that is configurable by the user, where each input mapping assigns particular functions to particular input types. In some embodiments, the first wearable audio output device and the second wearable audio device have different behaviors. For example, the first wearable audio output device has a different set of assignments between type of input gesture and operation performed in response than the second wearable audio output device (e.g., a long squeeze gesture via the first wearable audio output device changes the audio output mode of the wearable audio output device, or both wearable audio output devices, while a different gesture, such as a short squeeze (e.g., single squeeze) gesture, via the second wearable audio output device changes the audio output mode of the second wearable audio output device, or both wearable audio output devices, and/or a long squeeze gesture via the second wearable audio output device performs a different operation, such as toggling playback of media content instead of changing audio output mode.

Detecting and being responsive in different ways to different types of gestures enhances operability of the device (e.g., provides flexibility without requiring a graphical user interface and/or cluttering the graphical user interface with additional displayed controls, as well as reducing the number of inputs needed to access this flexibility) and makes the user-device interface more efficient.

In some embodiments, the second wearable audio output device detects a second input at the second wearable audio output device; and, in response to detecting the second input and in accordance with a determination that the second input is the first type of input, adjusts a mute state of a microphone of the second wearable audio output device for the first audio function without adjusting the mute state for the second audio function. For example, FIG. 5B shows user input 518 at wearable audio output device 301-1 causing adjustment to the mute state and FIG. 5J shows user input 538 (e.g., a same type of input) at wearable audio output device 301-2 causing adjustment to the mute state. For example, each wearable audio output device has the same input mapping (e.g., a default input mapping). In some embodiments, the mute state of a microphone or microphones of both the first and second wearable audio output devices are adjusted in response to detecting the second input, in accordance with a determination that the second input is the first type of input. Adjusting the mute state for either the wearable audio output devices in response to a single gesture reduces the number of inputs needed, which enhances the operability of the devices and makes the user-device interface more efficient (e.g., by helping the user to achieve an intended outcome and reducing user mistakes when operating/interacting with the devices), which, additionally, reduces power usage and improves battery life of the devices by enabling the user to use the devices more quickly and efficiently.

In some embodiments, the first audio function corresponds (1310) to detecting audio with one or more microphones at the device and enabling the detected audio to be used (e.g., by the audio output device and/or by a device to which the audio output device is connected such as a smartphone, tablet, laptop, or desktop computer) to provide input to a real-time communication session (e.g., the video chat in FIGS. 5A-5F and/or the telephone session in FIGS. 5G-5P). For example, the real-time communication session is a phone call, voice chat, video chat, or other type of communication session. In some embodiments, the first audio function corresponds to a real-time communication application. For example, the first audio function toggles a mute state for audio being recorded by the device and provided to the real-time communication application. In some embodiments, the first audio function corresponds to two or more applications.

In some embodiments, adjusting the mute state of the microphone for the first audio function includes (1312) adjusting the mute state for both the wearable audio output device and the second wearable audio output device in the set of wearable audio output devices. Adjusting the mute state for both the wearable audio output devices in response to a single gesture reduces the number of inputs needed, which enhances the operability of the devices and makes the user-device interface more efficient (e.g., by helping the user to achieve an intended outcome and reducing user mistakes when operating/interacting with the devices), which, additionally, reduces power usage and improves battery life of the devices by enabling the user to use the devices more quickly and efficiently.

In some embodiments, the second audio function corresponds (1314) to detecting audio with one or more microphones at the device and enabling the detected audio to be used (e.g., by the audio output device and/or by a device to which the audio output device is connected such as a smartphone, tablet, laptop, or desktop computer) to generate instructions (e.g., spoken instructions) for a digital assistant. For example, FIGS. 5J-5K shows user input 538 muting the microphone for the telephony application (e.g., as indicated by notification 539) without muting the microphone for the digital assistant function (e.g., as indicated by notification 542). For example, the user is able to mute the microphone for an active real-time communication via an input detected at the wearable device. In this example, the user is able to issue voice commands to a digital assistant via the microphone while the microphone is muted for the active real-time communication. The digital assistant can be an application, module, and/or software capable of analyzing the user instructions to identify tasks and provide assistance with completing the identified tasks. For example, a digital assistant can be an application, e.g., implemented in part on a portable electronic device in communication with the wearable audio output device and in part on a set of server computers accessed by the portable electronic device via a communications network such as the internet, that uses semantic analysis to analyze text, recognize terms and interpret the intended meaning. In some embodiments, processing by the digital assistant is performed at the portable electronic device and/or at the set of server computers.

A task can be any type of action with which a digital assistant can provide assistance. For example, a task can include scheduling a meeting, performing a financial transaction, determining an estimated time of arrival, providing directions, providing weather information, performing a search and providing search results, providing spelling and/or definition of a term, alerting a user of relevant information, and/or other type of task. As an example, the digital assistant can gather requested data for the user from one or more web servers, such as weather data and/or traffic data. As another example, to assist with scheduling a meeting, a digital assistant can gather calendar information for each intended participant and recommend one or more proposed times for the meeting. As another example, to assist with performing a financial transaction, a digital assistant can determine the financial applications available and/or utilized by the user and recommend a financial application to perform the financial transaction.

Adjusting the mute state of the wearable audio output device for a first function, but not for a second function, in response to a single gesture can reduce the number of inputs needed, which enhances the operability of the devices and makes the user-device interface more efficient (e.g., by helping the user to manage audio for multiple functions of the device), which, additionally, reduces power usage and improves battery life of the devices by enabling the user to use the devices more quickly and efficiently.

In some embodiments, the second audio function corresponds (1316) to detecting audio with one or more microphones at the device and enabling the detected audio to be used (e.g., by the audio output device and/or by a device to which the audio output device is connected such as a smartphone, tablet, laptop, or desktop computer) to generate content (e.g., text or audio content based on the detected audio). For example, FIGS. 5M-5N show an audio function corresponding to dictation into a notes application. For example, the user is able to mute the microphone for an active real-time communication via an input detected at the wearable device. In this example, the user is able to use the microphone to provide voice inputs to a dictation application/service while the microphone is muted for the active real-time communication.

In response to detecting the input (1306), in accordance with a determination that the input is not a first type of input, the wearable audio output device forgoes (1318) adjusting the mute state of the microphone for the first audio function that uses the microphone. For example, FIG. 5H shows user input 532 (e.g., a swipe input) at wearable audio output device 301-1 and FIG. 5I shows the mute state of the microphone being unchanged in response to user input 532. In some embodiments, adjusting the mute state of the microphone comprises activating a mute/unmute toggle function. In some embodiments, the mute state is adjusted in response to the input in accordance with a determination that the wearable audio output device is being worn by the user; and, in accordance with a determination that the wearable audio output device is not being worn by the user, the mute state is not adjusted in response to the input. In some embodiments, the one or more input devices include an input device that is pressure-sensitive (also called “intensity-sensitive”) (e.g., the input device responds to squeeze inputs (e.g., inputs where intensity (also called pressure) is applied to the input device when held and pinched between two fingers) that satisfy an intensity threshold, which in some embodiments is greater than a nominal contact detection intensity threshold that would be used for touch inputs). In some embodiments, the one or more input devices include an input device that is touch-sensitive (e.g., the input device responds to touch inputs, such as by a finger or stylus, that satisfy a nominal contact detection intensity threshold).

In some embodiments, in accordance with a determination that the input is a second type of input, the wearable audio output device activates (1320) a second function of the wearable audio output device, where the second function is distinct from adjusting the mute state of the microphone. For example, FIG. 5H shows user input 532 (e.g., a swipe input) at wearable audio output device 301-1 and FIG. 5I shows an output volume of wearable audio output devices 301 being adjusted in response to user input 532. For example, the second type of input is a tap gesture, a double tap gesture, a squeeze gesture, a button press, a deep press gesture, or other input gesture. In some embodiments, the second function comprises an audio playback function, an ambient noise adjustment function, or other type of function. In some embodiments, the second function is distinct from adjusting the mute state of the microphone for the first audio function.

Detecting and being responsive in different ways to different types of gestures enhances operability of the device (e.g., provides flexibility without requiring a graphical user interface and/or cluttering the graphical user interface with additional displayed controls, as well as reducing the number of inputs needed to access this flexibility) and makes the user-device interface more efficient.

In some embodiments, the second function corresponds (1322) to changing a volume level of the wearable audio output device (e.g., as illustrated in FIGS. 5H-5I). For example, an output volume for the wearable audio output device is adjusted in response to the input. In some embodiments, the output volume is adjusted in accordance with location, movement, duration, and/or force of the input. Changing volume levels in response to gestures at the wearable audio output device enhances operability of the device (e.g., provides flexibility without requiring a graphical user interface and/or cluttering the user interface with additional displayed controls, as well as reducing the number of inputs needed to access this flexibility) and makes the user-device interface more efficient.

In some embodiments, the second function corresponds (1324) to a digital assistant (e.g., invoking, interacting with, and/or dismissing a digital assistant) (e.g., as illustrated in FIG. 5K). For example, a digital assistant comprises functionality for performing operations on a device in response to user inputs (e.g., audio and/or textual inputs such as spoken and/or typed commands). In some embodiments, invoking the digital assistant causes the digital assistant to be responsive to user inputs (gestures, phrases, and/or verbal commands detected by one or more microphones of the device). In some embodiments, dismissing (and/or disabling) the digital assistant causes the digital assistant to not be responsive to user inputs. In some embodiments, the function causes a digital assistant invocation command to be sent a network connected device, and the network connected device invokes the digital assistant and provides corresponding audio to the wearable audio output device. Invoking, interacting with, and/or dismissing a digital assistant in response to gestures at the wearable audio output device enhances operability of the device (e.g., provides flexibility without requiring a graphical user interface and/or cluttering the user interface with additional displayed controls, as well as reducing the number of inputs needed to access this flexibility) and makes the user-device interface more efficient.

In some embodiments, the second function corresponds (1326) to changing an audio output mode of the wearable audio output device (e.g., adjusting active noise cancellation for ambient noise, transparency for ambient noise, and/or other audio output mode functions) (e.g., as illustrated in FIG. 5P). In some embodiments, when ambient sound from the physical environment is being actively passed through, noise-cancellation is disabled. In some embodiments, the ambient noise adjustment function activates a pass-through mode (or transparency mode or non-noise canceling mode) that allows the user to hear unaided audio (e.g., normal voices) from the user's environs. In some embodiments, when noise-cancellation is enabled, no ambient sound from the physical environment is actively passed through. In some embodiments, the ambient noise adjustment function activates an active noise control mode (ANC) and the wearable audio output device outputs one or more audio-cancelling audio components (e.g., one or more antiphase audio signals, also called “audio-cancellation audio components”) to at least partially cancel ambient sound from the surrounding physical environment that would otherwise be perceivable to the user. In some embodiments, an ambient sound waveform is detected by one or more microphones of the wearable audio output device, and an antiphase (or partially antiphase) audio signal waveform is produced by the wearable audio output device to at least partially cancel the ambient sound waveform.

Adjusting audio output modes in response to gestures at the wearable audio output device enhances operability of the device (e.g., provides flexibility without requiring a graphical user interface and/or cluttering the user interface with additional displayed controls, as well as reducing the number of inputs needed to access this flexibility) and makes the user-device interface more efficient. Additionally, using different levels of pass-through audio components and cancellation audio components in different audio output modes provides the user with flexibility between different levels of audio immersion (e.g., via ambient audio cancellation) or audio transparency (e.g., via ambient audio pass-through) that can be achieved with a gesture, e.g., a gesture detected at an input device of one of the wearable audio output devices.

In some embodiments, the first type of input is (1328) a squeeze input or tap input. In some embodiments, the first type of input comprises a squeeze input (e.g., a single squeeze, a double squeeze, or other type of squeeze gesture). In some embodiments, a squeeze gesture is a gesture that involves pressing something (e.g., stem portion 305) between two or more fingers. In some embodiments, a squeeze is maintained for less than a threshold amount of time (e.g., 0.1, 0.2, 0.5 seconds, 1 second, 1.5 seconds, or 2 seconds). In some embodiments, a long squeeze gesture is a squeeze gesture that is maintained for at least the threshold amount of time. In some embodiments, the first type of input comprises a tap input. For example, a single tap, a double tap, or other type of tap gesture (e.g., detected by an accelerometer and/or inertial measurement unit (IMU)). In some embodiments, the first type of input is a deep press. In some embodiments, the first type of input is a tap-and-hold gesture (e.g., a tap gesture that is held for at least a predetermined amount of time). In some embodiments, the one or more input devices of the wearable audio output device include an input device that is touch-sensitive (e.g., the input device responds to touch inputs, such as by a finger or stylus, that satisfy a nominal contact detection intensity threshold). Including multiple types of sensors in the device expands the number and/or type of gestures that can be detected at the device. Expanding the number and/or type of gestures that can be detected enhances operability of the device (e.g., provides flexibility without requiring a graphical user interface and/or cluttering the user interface with additional displayed controls, as well as reducing the number of inputs needed to access this flexibility) and makes the user-device interface more efficient.

In some embodiments, in accordance with adjusting the mute state of the microphone, the wearable audio output devices provides (1330) non-visual feedback to a user of the wearable audio output device indicating that the mute state of the microphone has been adjusted (e.g., notification 542). For example, the non-visual feedback includes audio feedback (e.g., one or more tones and/or words), haptic feedback, and/or other types of non-visual feedback. Providing non-visual feedback to the user enhances the operability of the devices and makes the user-device interface more efficient (e.g., by helping the user to achieve an intended outcome and reducing user mistakes when operating/interacting with the devices), which, additionally, reduces power usage and improves battery life of the devices by enabling the user to use the devices more quickly and efficiently. Additionally, providing non-visual feedback provides flexibility without requiring a graphical user interface and/or cluttering the user interface with additional displayed controls, as well as reducing the number of inputs needed to access this flexibility, which makes the user-device interface more efficient.

In some embodiments, in accordance with the first audio function corresponding to a first application, the non-visual feedback includes (1332) first audio feedback; and, in accordance with the first audio function corresponding to a second application, the non-visual feedback includes second audio feedback. As an example, notification in 519 (e.g., corresponding to a video chat) in FIG. 5B may be different than feedback 535 (e.g., corresponding to a telephony application) in FIG. 5J. In some embodiments, the first audio function corresponds to a first application, and the non-visual feedback includes audio and/or haptic feedback designated for (e.g., by) the first application. For example, applications are able to select/provide their own audio feedback (e.g., mute/unmute tones). To continue the example, a system tone may be used if an application does not designate its own tones. For example, the first application is a video conferencing application, a phone application, or other type of application that accepts voice inputs from the user. Providing improved feedback (e.g., application-specific feedback) to the user enhances the operability of the devices and makes the user-device interface more efficient (e.g., by helping the user to achieve an intended outcome and reducing user mistakes when operating/interacting with the devices).

In some embodiments, the wearable audio output device is (1334) communicatively coupled to an electronic device; and, in accordance with adjusting the mute state of the microphone, provides feedback to a user of the wearable audio output device via a display of the electronic device (e.g., FIGS. 5A-5B show microphone icon 514 changing from state 514-a to state 514-b in response to user input 518). In some embodiments, the feedback is a system alert of the electronic device. In some embodiments, the feedback is provided via a notification element overlaid on a user interface of the electronic device. For example, prior to providing the feedback, the electronic device is displaying a user interface (e.g., a home screen, a wake screen, an application-specific user interface, and/or other type of user interface). In this example, in accordance with adjusting the mute state of the microphone, a user interface element is presented that is overlaid on the user interface. In some embodiments, the electronic device is a companion device of the wearable audio output device. For example, the electronic device is paired with the wearable audio output device. As another example, the electronic device is associated with a same user account as the wearable audio output device. In some embodiments, the feedback is displayed (e.g., notification 539 in FIG. 5J) at a display of the electronic device. Examples of the electronic device include a phone, a tablet, a watch, a laptop computer and a desktop computer. Providing feedback to the user enhances the operability of the devices and makes the user-device interface more efficient (e.g., by helping the user to achieve an intended outcome and reducing user mistakes when operating/interacting with the devices), which, additionally, reduces power usage and improves battery life of the devices by enabling the user to use the devices more quickly and efficiently.

In some embodiments, the feedback is displayed within a status region that displays information about one or more operations currently being performed by the electronic device (e.g., notification 539 in FIG. 5J corresponds to a status region). For example, the feedback is conveyed to the electronic device for display in the status region. In some embodiments, the status region (sometimes referred to as a dynamic window) has a size (e.g., a length and/or width) that is adjusted based on content presented within the window (e.g., content of the control user interface). In some embodiments, a location of the status region is adjusted in accordance with touch locations. For example, the status region is displayed at the first display location in response to a first touch input and is displayed at the second display location in response to a second touch input. In some embodiments, a location of the status region is adjustable via touch inputs (e.g., drag and/or swipe inputs) at a display location of the status region. Providing dynamic visual feedback that changes in accordance with operations currently being performed enhances the operability of the device and makes the user-device interface more efficient (e.g., by providing improved feedback to help the user provide required inputs to achieve an intended outcome, and reducing user mistakes when operating/interacting with the device), which, additionally, reduces power usage and improves battery life of the device by enabling the user to use the device more quickly and efficiently.

In some embodiments, the electronic device detects a second input; and, in response to detecting the second input, adjusts a size of the status region. For example, the second input is a tap input, a long press input, and/or other type of input. In some embodiments, the second input is detected at a location on the display that corresponds to the status region. In some embodiments, the status region is increased in size in response to the second input, and additional status information for the wearable audio output device, not displayed prior to detecting the second input, is displayed. In some embodiments, the size of the status region is adjusted in accordance with a determination that the second input is a particular type of input (e.g., a tap input, a double-tap input, or other type of input). In some embodiments, a position of the status region is adjusted in accordance with a determination that the second input is a different type of input (e.g., a deep press input, a long press input, or other type of input). Changing which information is displayed in the status region in response to a user input reduces the number of inputs needed to view different application user interfaces, without displaying additional controls, and causes the device to automatically reallocate available space in the status region, thereby providing improved feedback about a state of the device.

In some embodiments, the status region includes an element that, when selected, adjusts the mute state of the microphone. For example, user interface 548 in FIG. 5M may correspond to a status region and includes selectable microphone icon 550. For example, the element is a microphone icon and selection of the icon toggles the mute state of the microphone. Performing functions based on touch inputs on the device enhances the operability of the devices and makes the user-device interface more efficient (e.g., by helping the user to achieve an intended outcome and reducing user mistakes when operating/interacting with the devices), which, additionally, reduces power usage and improves battery life of the devices by enabling the user to use the devices more quickly and efficiently.

In some embodiments, in accordance with the first audio function corresponding to a first application, the status region indicates the first application; and, in accordance with the first audio function corresponding to a second application, the status region indicates the second application. For example, user interface 548 in FIG. 5M may correspond to a status region and includes an indication of the telephony application. In some embodiments, the first audio function corresponds to a first application, and the status region indicates the first application. For example, the status region includes an icon of the first application. In some embodiments, the icon is selectable to toggle the mute state. In some embodiments, the icon is selectable to give focus to a user interface of the first application. Providing dynamic visual feedback that changes in accordance with applications being active/affected by the audio functions enhances the operability of the device and makes the user-device interface more efficient (e.g., by providing improved feedback to help the user provide required inputs to achieve an intended outcome, and reducing user mistakes when operating/interacting with the device), which, additionally, reduces power usage and improves battery life of the device by enabling the user to use the device more quickly and efficiently.

In some embodiments, the first audio function corresponds to a first application, the feedback is displayed within a user interface of the first application. For example, FIGS. 5I-5J show microphone icon 530 in user interface 528 changing from state 530-a to state 530-b in response to user input 538. For example, the first application is a video conferencing application and the feedback (e.g., a muted microphone symbol) is displayed in the video conferencing user interface. Providing dynamic visual feedback that corresponds to the application being affected enhances the operability of the device and makes the user-device interface more efficient (e.g., by providing improved feedback to help the user provide required inputs to achieve an intended outcome, and reducing user mistakes when operating/interacting with the device), which, additionally, reduces power usage and improves battery life of the device by enabling the user to use the device more quickly and efficiently.

In some embodiments, providing the feedback includes: (i) causing display of a notification user interface element at the electronic device; and (ii) ceasing to cause display of the notification user interface element after a preset time period. For example, notification 539 may be displayed for only a preset amount of time (e.g., 5, 10, or 15 seconds). For example, the feedback is displayed in a popup notification that is displayed for 5, 10, or 15 seconds. In some embodiments, providing feedback comprises displaying the feedback in a notification user for a preset amount of time and then ceasing to display the feedback. Providing dynamic visual feedback that is displayed for a preset amount of time enhances the operability of the device and makes the user-device interface more efficient (e.g., by providing feedback to help the user provide required inputs to achieve an intended outcome and not requiring that the user manually dismiss the feedback), which, additionally, reduces power usage and improves battery life of the device by enabling the user to use the device more quickly and efficiently.

In some embodiments: (i) the wearable audio output devices obtains (1336) an updated input mapping for the wearable audio output device; (ii) after obtaining the updated input mapping, detects a second input via the one or more input devices, the second input being the first type of input; and (iii) in response to detecting the second input, adjusts an audio output state of the wearable audio output device based on the updated input mapping. For example, user input 647 (FIG. 6E) causes a change in mapping of a press and hold input at the right device from a transparency function to a digital assistant function. In some embodiments: (i) the mute state of the microphone is adjusted in response to detecting the input based on a first input mapping; (ii) after adjusting the mute state of the microphone in response to detecting the input, the wearable audio output device obtains a second input mapping; (iii) after obtaining the second input mapping, the wearable audio output device detects a second input via the one or more input devices, the second input being the first type of input; and (iv) in response to detecting the second input, the wearable audio output device adjusts an audio output state of the wearable audio output device based on the second input mapping. As an example, the updated input mapping is generated at a companion device (e.g., a device associated with a same user account as the wearable audio output device) in response to a user input at the companion device. In some embodiments, the adjustment to the audio output state of the wearable audio output device includes a change in volume of audio output. In some embodiments, the adjustment to the audio output state of the wearable audio device includes a change in noise control (e.g., ANC, active transparency, and/or other noise control). For example, the user is able to change the input mapping such that a second input type (e.g., a press and hold input) causes the adjustment to the mute state instead of the first input type (e.g., a tap input, or vice versa). Providing a means for the user to modify (e.g., personalize) controls enhances the operability of the device and makes the user-device interface more efficient (e.g., by reducing user mistakes when operating/interacting with the device), which, additionally, reduces power usage and improves battery life of the device by enabling the user to use the device more quickly and efficiently.

In some embodiments, in accordance with a failure to adjust the mute state of the microphone, the wearable audio output device provides (1338) error feedback to a user of the wearable audio output device. In some embodiments, the error feedback is provided at the wearable audio output device, at a companion device, and/or at another electronic device. In some embodiments, the error feedback is provided via a system user interface, an application user interface, and/or another user interface. For example, the error feedback includes audio feedback, haptic feedback, and/or other types of feedback. Providing feedback to the user enhances the operability of the devices and makes the user-device interface more efficient (e.g., by helping the user to achieve an intended outcome and reducing user mistakes when operating/interacting with the devices), which, additionally, reduces power usage and improves battery life of the devices by enabling the user to use the devices more quickly and efficiently.

In some embodiments, a companion device provides information about controlling the mute state of the microphone of the wearable audio output device in conjunction with a software setup or update procedure for the companion device (e.g., user interface 702 shown in FIG. 7A). For example, during the software setup or update procedure, in response to completion of the software setup or update procedure, or when the wearable audio output devices are connected to or used with the companion device after the software setup or update procedure has completed such as on a first connection or use of the wearable audio output devices with the companion device after the software setup or update procedure has completed. In some embodiments, the user interface illustrates a simulated input and a simulated adjustment to the mute state of the microphone. For example, the simulated input is a default input for triggering the adjustment to the mute state. Displaying simulated gestures and corresponding functions and/or adjustments provides visual feedback to the user by indicating operation and states of the device. Providing improved feedback to the user enhances the operability of the devices and makes the user-device interface more efficient (e.g., by helping the user to achieve an intended outcome and reducing user mistakes when operating/interacting with the devices), which, additionally, reduces power usage and improves battery life of the devices by enabling the user to use the devices more quickly and efficiently.

It should be understood that the particular order in which the operations in FIGS. 13A-13C have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 1400, 1500, and 1600) are also applicable in an analogous manner to method 1300 described above with respect to FIGS. 13A-13C. For example, the inputs, gestures, functions, and feedback described above with reference to method 1300 optionally have one or more of the characteristics of the inputs, gestures, functions, and feedback described herein with reference to other methods described herein (e.g., methods 1400, 1500, and 1600). For brevity, these details are not repeated here.

FIGS. 14A-14C are flow diagrams illustrating method 1400 for adaptively changing ambient sound audio levels in response to detected speech in the physical environment in accordance with some embodiments. Method 1400 is performed at a wearable audio output device (e.g., wearable audio output device 301-1). Examples of the wearable audio output device include in-ear earphones, over-ear headphones, or other wearable audio output device. In some embodiments, the wearable audio output device includes a speaker (e.g., speaker(s) 306) or other audio output device and optionally one or more elements to enable the speaker to be positioned in a respective physical arrangement relative to an ear of a person using the wearable audio output device. In some embodiments, the wearable audio output device includes a housing with one or more physically distinguished portions. In some embodiments, the wearable audio output device includes one or more audio output devices (e.g., speaker(s) 306). In some embodiments, the wearable audio output device includes one or more placement sensors (e.g., sensor(s) 304). Some operations in method 1400 are, optionally, combined and/or the order of some operations is, optionally, changed.

As described below, method 1400 provides audio outputs in an intuitive manner by adjusting the levels of different audio components in an audio output in response to speech in the surrounding physical environment. In some examples, the provided audio output is automatically adjusted to allow the user to hear more ambient sound when speech (or an increase in speech) is detected in the surrounding physical environment. Varying, e.g., automatically varying, the levels of different audio components, and the balance between the different audio components, in an audio output allows for the manner in which audio output is provided to be dynamically adjusted to be better suited to the current state of the surrounding physical environment, without requiring additional input from the user. Providing an adaptive and more intuitive user experience while reducing the number of inputs needed to achieve such an experience enhances the operability of the device and makes the user-device interface more efficient (e.g., by helping the user to achieve an intended outcome and reducing user mistakes when operating/interacting with the device), which, additionally, reduces power usage and improves battery life of the device by enabling the user to use the device more quickly and efficiently.

While the wearable audio output device has a first physical arrangement relative to a respective body part of a user (e.g., the headphone is being worn by a user, in, on, or over one or more of the user's ears) in which ambient sound from a physical environment is modified by the wearable audio output device (e.g., via active noise cancellation, passive noise cancellation, and/or active audio transparency) to have a first ambient-sound audio level, the wearable audio output device detects (1402) speech in the physical environment, the speech corresponding to a start of conversation (e.g., with the user).

In response to detecting the speech, the wearable audio output device changes (1404) a modification of ambient sound (e.g., by decreasing a degree of active noise cancellation and/or increasing a degree of active transparency) from the physical environment by the wearable audio output so that ambient sound from the physical environment is modified by the wearable audio output device (e.g., via active noise cancellation, passive noise cancellation, and/or active audio transparency) to have a second ambient-sound audio level that is louder than the first ambient-sound audio level. For example, FIGS. 8B-8C show an ANC mode being disabled and an active transparency mode being enabled in response to detecting speech of speech bubble 822.

In some embodiments, prior to detecting the speech, the wearable audio output device provides (1406) audio playback to the user; and in response to detecting the speech, changes the audio playback. For example, FIGS. 8B-8C show content audio (e.g., device content waveform 808-2, 808-3) volume being decreased in response to detecting speech (e.g., of another user 820) of speech bubble 822. For example, the audio playback includes music from a music application, speech from an audio book, and/or audio from another application and/or function. Automatically adjusting audio playback in an audio output device allows for the manner in which audio output is provided to be dynamically adjusted to be better suited to the current state of the surrounding physical environment, without requiring additional input from the user.

In some embodiments, changing the audio playback comprises reducing a volume of the audio playback. For example, FIGS. 8B-8C show content audio volume being decreased in response to detecting speech of speech bubble 822. In some embodiments, the audio playback is provided at a first audio playback level prior to detecting the speech, and in response to detecting the speech, the audio playback is provided at a second audio playback level, where the second audio playback level is lower than the first audio playback level. In some embodiments, the audio playback is changed from the second audio playback level (e.g., to the first audio playback level) at the end of the first time period in accordance with the determination that the conversation had the first value for the respective characteristic. In some embodiments, the audio playback is changed from the second audio playback level (e.g., to the first audio playback level) at the end of a second time period in accordance with the determination that the conversation had a second value for the respective characteristic. Automatically reducing the volume of audio playback allows for the provided audio output to be dynamically adjusted to be better suited to the current state of the surrounding physical environment (e.g., assisting a user in hearing and/or responding to speech in the environment), without requiring additional input from the user.

In some embodiments, changing the audio playback comprises pausing the audio playback. For example, FIG. 9B shows audio content 920 being paused in response to a start of conversation 916-2. In some embodiments, the audio playback is provided prior to detecting the speech, and in response to detecting the speech, the audio playback is paused. In some embodiments, the audio playback is resumed at the end of the first time period in accordance with the determination that the conversation had the first value for the respective characteristic. In some embodiments, the audio playback is resumed at the end of a second time period in accordance with the determination that the conversation had a second value for the respective characteristic. Automatically pausing audio playback allows for the provided audio output to be dynamically adjusted to be better suited to the current state of the surrounding physical environment (e.g., assisting a user in hearing and/or responding to speech in the environment), without requiring additional input from the user.

In some embodiments, changing the audio playback includes: (i) in accordance with a determination that the audio playback comprises spoken word audio (e.g., an audio book or podcast), pausing the audio playback (e.g., as illustrated in FIG. 9B); and (ii) in accordance with a determination that the audio playback does not comprise spoken word audio, reducing a volume of the audio playback (e.g., as illustrated in FIG. 9A). For example, the volume of music playback is reduced whereas the audio playback of an audio book is paused. Automatically adjusting audio playback based on a type of audio content allows for the provided audio output to be dynamically adjusted to be better suited to the current state of the surrounding physical environment (e.g., assisting a user in hearing and/or responding to speech in the environment), without requiring additional input from the user (e.g., adjusting volume controls and/or playback controls).

In some embodiments, the audio playback is changed in a first manner in accordance with a determination that the conversation has the first value for the respective characteristic; and the audio playback is changed in a second manner in accordance with a determination that the conversation has a different value for the respective characteristics. For example, FIG. 9A shows audio content 906 being reduced to a second level at time t2 (e.g., when conversation 916-1 has first characteristics) and being reduced to a third level at time t3 (e.g., when conversation 916-1 has second characteristics). For example, a fast-paced conversation causes the audio playback to be ducked (e.g., volume reduced), and a slow-paced conversation the audio playback to be paused. As another example, the audio playback is ducked in a start of the conversation and is further ducked and/or paused in accordance with the conversation lasting longer than a threshold amount of time (e.g., lasting longer than 30 seconds, 1 minute, 2 minutes, 5 minutes, or 10 minutes). Automatically adjusting audio playback in an audio output device based on a user's conversation allows for the manner in which audio output is provided to be dynamically adjusted to be better suited to the current state of the surrounding physical environment, without requiring additional input from the user.

In some embodiments, changing the audio playback comprises reducing an audio fidelity of the audio playback. For example, a low pass filter is applied to the audio playback (e.g., to muffle the playback). For example, an equalizer is applied to the audio playback to reduce higher frequency sounds such that low frequency sounds are more prominent than higher frequency sounds in the audio playback. In some embodiments, reducing the audio fidelity of the audio playback includes lowering a volume of the audio playback and/or applying a low pass filter to the audio playback. For example, reducing the audio fidelity the audio playback causes the audio playback to sound as though it is coming from another room sometimes referred to as “blurring” the audio. Automatically reducing audio fidelity of audio playback allows for the provided audio output to be dynamically adjusted to be better suited to the current state of the surrounding physical environment (e.g., assisting a user in hearing and/or responding to speech in the environment), without requiring additional input from the user.

In some embodiments, information about the audio playback is obscured (e.g., as illustrated in FIGS. 10A-10E) in accordance with a determination that the conversation has the first value for the respective characteristic. For example, a fast-paced conversation causes blurring of the audio playback information, and a slow-paced conversation causes a reduction in size of the audio playback information. As another example, the information about the audio playback is obscured in accordance with the conversation lasting longer than a threshold amount of time (e.g., lasting longer than 30 seconds, 1 minute, 2 minutes, 5 minutes, or 10 minutes). Automatically obscuring the display of information based on a state of the surrounding physical environment improves user privacy and security, e.g., by inhibiting the person talking to the user from seeing information on the device.

The wearable audio output devices detects (1408) a pause in the conversation. In some embodiments, detecting a pause in the conversation comprises detecting an end of the conversation. In some embodiments, detecting a pause in the conversation comprises not detecting speech associated with the conversation for at least a predetermined amount of time (e.g., 1 second, 2 seconds, 5 seconds, or 10 seconds). For example, FIG. 9A shows an end of conversation 916-1 being detected at t4 (e.g., corresponding to a pause in talking between user 902 and person 904).

In response to detecting the pause in the conversation (1410) and in accordance with a determination that the conversation had a first value for a respective characteristic, the wearable audio output changes (1412), at the end of a first time period (e.g., time period p1 in FIG. 9A) after detecting the pause in the conversation, a modification of ambient sound (e.g., by increasing a degree of active noise cancellation and/or decreasing a degree of active transparency) from the physical environment by the wearable audio output so that ambient sound from the physical environment is modified by the wearable audio output device (e.g., via active noise cancellation, passive noise cancellation, and/or active audio transparency) to have an ambient-sound audio level that is quieter than the second ambient-sound audio level.

In some embodiments, changing the modification of the ambient sound includes (1414) decreasing a degree of active noise cancellation. For example, ANC 908 in FIG. 9A is decreased from a first level to a second level (e.g., disabled) in response to the start of conversation 916-1. In some embodiments, decreasing the degree of active noise cancellation (ANC) comprises disabling the ANC mode. In some embodiments, decreasing the degree of ANC comprises reducing the ANC from above a threshold percentage (e.g., 90%, 80%, 75%, or 50%) to below the threshold percentage. For example, prior to detecting the speech, the ANC reduces the ambient sound to an ambient-sound audio level of 20%, 10%, or 5% and, in response to detecting the speech, the ANC reduces the ambient sound to an ambient-sound audio level of 80%, 75%, 70%, or 50%. Decreasing the degree of ANC in response to detecting the speech enhances the operability of the device (e.g., allowing the user to better hear speech in the environment) and reduces power usage and improves battery life of the devices.

In some embodiments, changing the modification of the ambient sound includes (1416) increasing a degree of active transparency. For example, active transparency 910 in FIG. 9A is increased from a first level to a second level (e.g., enabled) in response to the start of conversation 916-1. In some embodiments, increasing the degree of active transparency comprises enabling an active transparency mode. In some embodiments, changing the modification of the ambient sound comprises switching from a noise cancellation mode to an active transparency mode. In some embodiments, increasing the degree of active transparency comprises increasing an amplification factor for ambient sound from the physical environment from a first value that is below a threshold to a second value that is above the threshold (e.g., the threshold being 0.5, 0.75, or 1). In some embodiments, increasing the degree of active transparency comprises increasing the active transparency from below a threshold percentage (e.g., 15%, 20%, 30%, or 50%) to above the threshold percentage. For example, prior to detecting the speech, the active transparency increases the ambient sound at an ambient-sound audio level of 10%, 20%, or 35% and, in response to detecting the speech, the active transparency increases the ambient sound to an ambient-sound audio level of 80%, 75%, 70%, or 50%. Increasing the degree of active transparency in response to detecting the speech enhances the operability of the device (e.g., allowing the user to better hear speech in the environment).

In response to detecting the pause in the conversation (1410) and in accordance with a determination that the conversation had a second value for a respective characteristic that is different from the first value, the wearable audio output device forgoes (1418) changing, at the end of the first time period after detecting the pause in the conversation, a modification of ambient sound (e.g., by forgoing increasing a degree of active noise cancellation and/or decreasing a degree of active transparency) from the physical environment by the wearable audio output so that ambient sound from the physical environment is modified by the wearable audio output device (e.g., via active noise cancellation, passive noise cancellation, and/or active audio transparency) to have an ambient-sound audio level that is quieter than the second ambient-sound audio level. For example, FIG. 9B shows no change to the levels of ANC 908 and active transparency 910 after the time period p1. In some embodiments, the modification of the ambient sound is changed in accordance with a determination that the conversation had first respective values for a set of characteristics. In some embodiments, the set of characteristics includes a characteristic for conversation length, a characteristic for conversation pace, and/or a characteristic for type of speech preceding the pause. In some embodiments, the wearable audio output device includes one or more pass-through audio components (e.g., active when the device is operating in the transparency mode) and/or one or more cancellation audio components (e.g., active when the device is operating in a noise cancellation mode).

In some embodiments, in accordance with a determination that the conversation had the second value for a respective characteristic that is different from the first value, the wearable audio output device changes (1420), at the end of a second time period (e.g., time period p2 in FIG. 9B) after detecting the pause in the conversation, a modification of ambient sound (e.g., by increasing a degree of active noise cancellation and/or decreasing a degree of active transparency) from the physical environment by the wearable audio output so that ambient sound from the physical environment is modified by the wearable audio output device (e.g., via active noise cancellation, passive noise cancellation, and/or active audio transparency) to have an ambient-sound audio level that is quieter than the second ambient-sound audio level, where the second time period is longer than the first time period. Automatically changing a modification of ambient sound in an audio output device allows for the manner in which audio output is provided to be dynamically adjusted to be better suited to the current state of the surrounding physical environment, without requiring additional input from the user.

In some embodiments, the respective characteristic includes (1422) a cadence of the conversation. For example, a slow-paced conversation results in a change after the first time period and a fast-paced conversation results in a change after a second time period that is shorter than the first time period. In some embodiments, the cadence is based on pacing of words and/or phrases. In some embodiments, the cadence is based on timing between words, a number of syllables, and/or words/phrases per minute. In some embodiments, the cadence is based on timing between changes in speaker. Automatically changing a modification of ambient sound in an audio output device based on a cadence of a conversation allows for the manner in which audio output is provided to be dynamically adjusted to be better suited to the current state of the surrounding physical environment, without requiring additional input from the user.

In some embodiments, the respective characteristic includes (1424) a type of speech preceding the pause in the conversation. For example, a question preceding the pause results in a change after the first time period and a statement preceding the pause results in a change after a second time period that is shorter than the first time period. As another example, a phatic sound (e.g., indicating thought) preceding the pause results in a change after a third time period that is longer than the first time period. As another example, a farewell preceding the pause results in a change after the second time period. Automatically changing a modification of ambient sound in an audio output device based on a type of speech allows for the manner in which audio output is provided to be dynamically adjusted to be better suited to the current state of the surrounding physical environment, without requiring additional input from the user.

In some embodiments, the respective characteristic includes (1426) a length of the conversation. For example, a longer conversation results in a change after the first time period and a shorter conversation results in a change after a second time period that is shorter than the first time period. Automatically changing a modification of ambient sound in an audio output device based on a length of a conversation allows for the manner in which audio output is provided to be dynamically adjusted to be better suited to the current state of the surrounding physical environment, without requiring additional input from the user.

In some embodiments: (i) the detected speech is speech from the user, and (ii) the wearable audio output device (a) detects second speech; and (b) in response to detecting the second speech, forgoes changing the modification of the ambient sound in accordance with a determination that the second speech is not from the user. In some embodiments, in response to detecting the speech and in accordance with a determination that the speech is from the user, the wearable audio output device changes the modification of the ambient sound modification; and in response to detecting the speech and in accordance with a determination that the speech is not from the user, the wearable audio output device forgoes changing the modification of the ambient sound. Automatically changing a modification of ambient sound in an audio output device based on speech from the user allows for the manner in which audio output is provided to be dynamically adjusted to be better suited to the current state of the surrounding physical environment, without requiring additional input from the user.

In some embodiments, the modification of the ambient sound is not changed in response to detecting the speech, in accordance with a determination that the speech is from the user and a determination that a voice-input function is active. For example, the modification of the ambient sound is not changed if the user is speaking on a phone call, speaking in a remote meeting or conference, speaking to a digital assistant, speaking to a dictation application, and/or speaking to another voice-based application. One the other hand, in some embodiments, the modification of the ambient sound is changed in accordance with a determination that the user is speaking to another person in the physical environment.

In some embodiments: (i) the detected speech is speech directed to the user, and (ii) the wearable audio output device (a) detects second speech; and (b) in response to detecting the second speech, forgoes changing the modification of the ambient sound in accordance with a determination that the second speech is not directed to the user. In some embodiments, the second speech is determined to be not directed to the user based on the second speech not including a name of the user. In some embodiments, the second speech is determined to not be directed to the user based on the second speech including a salutation with a name of another person. In some embodiments, the second speech is determined to not be directed to the user based on a position of the speaker and/or a direction the speaker is facing. In some embodiments, in response to detecting the speech and in accordance with a determination that the speech is directed to the user, the wearable audio output device changes the modification of the ambient sound modification; and in response to detecting the speech and in accordance with a determination that the speech is not directed to the user, the wearable audio output device forgoes changing the modification of the ambient sound. In some embodiments, in response to detecting the speech and in accordance with a determination that the speech is directed to the user or a determination that the speech is from the user, the wearable audio output device changes the modification of the ambient sound modification; and in response to detecting the speech and in accordance with a determination that the speech is not directed to the user and a determination that the speech is not from the user, the wearable audio output device forgoes changing the modification of the ambient sound. In some embodiments, in response to detecting the speech and in accordance with a determination that the speech is between the user and another person (and/or voice-based device) in the physical environment, the wearable audio output device changes the modification of the ambient sound modification; and in response to detecting the speech and in accordance with a determination that the speech is not between the user and another person (and/or voice-based device) in the physical environment, the wearable audio output device forgoes changing the modification of the ambient sound. Automatically changing a modification of ambient sound in an audio output device based on speech directed to the user allows for the manner in which audio output is provided to be dynamically adjusted to be better suited to the current state of the surrounding physical environment, without requiring additional input from the user.

In some embodiments, the modification of the ambient sound is changed in response to detecting the speech, in accordance with a determination that the speech includes a name of the user. For example, FIG. 8B shows speech bubble 822 including a name of user 804. For example, the modification of the ambient sound is not changed if another person is speaking in the physical environment, but does not use the user's name (e.g., the other person is talking on a phone and/or talking to someone other than the user). In some embodiments, the modification of the ambient sound is changed in accordance with a determination that the detected speech is directed to the user (e.g., includes the user's name, title, and/or one or more words of greeting). Automatically changing a modification of ambient sound in an audio output device based on detecting speech that includes a name of the user allows for the manner in which audio output is provided to be dynamically adjusted to be better suited to the current state of the surrounding physical environment, without requiring additional input from the user.

In some embodiments: (i) the speech is detected while a speech detection mode of the wearable audio output device is enabled (e.g., the speech detection mode corresponding to speech detection control 718 of FIG. 7B); and the wearable audio output device (a) detects (1428) an input that causes the speech detection mode to be disabled (e.g., user input 728 in FIG. 7C); (b) after disabling the speech detection mode, detects second speech in the physical environment; and (c) in response to detecting the second speech, forgoes changing the modification of the ambient sound. For example, while the speech detection mode is enabled, detecting speech causes a change in the modification of ambient sound, and while the speech detection mode is disabled, detecting speech does not cause a change in the modification of the ambient sound. In some embodiments, while the speech detection mode is disabled, the method includes not detecting second speech in ambient sound in the physical environment and forgoing changing the modification of the ambient sound in response to detecting ambient sound in the physical environment that includes the second speech. For example, while the speech mode is disabled, speech in the physical environment is not identified/recognized. Providing a means for the user to active and deactivate the speech detection mode enhances the operability of the devices and makes the user-device interface more efficient (e.g., by helping the user to achieve an intended outcome and reducing user mistakes when operating/interacting with the devices), which, additionally, reduces power usage and improves battery life of the devices by enabling the user to use the devices more quickly and efficiently.

In some embodiments, the input is detected at an electronic device that is communicatively coupled to the wearable audio output device, the input selecting a speech detection control of a user interface. For example, user input 683 in FIG. 6H is detected at device 100 and toggles a speech detection mode for wearable audio output devices 301. In some embodiments, the user interface is a control center user interface. For example, the user interface includes a plurality of controls for the electronic device and/or the wearable audio output device.

In some embodiments, the user interface includes the speech detection control (e.g., speech detection control 682, FIG. 6G) and one or more ambient noise controls (e.g., noise control 674). In some embodiments, the one or more ambient noise controls include a noise cancellation control and a transparency control. In some embodiments, the one or more ambient noise controls, when selected, adjust active noise cancellation for ambient noise, transparency for ambient sound, and/or other ambient sound functions. For example, active transparency for ambient sound includes using external microphone(s) at the wearable audio output device to capture audio and play it via one or more speakers at the wearable audio output device. In some embodiments, the user interface includes one or more spatial audio controls (e.g., the spatial audio control settings include a balance setting, a stereo setting, and/or other setting). For example, selection of a spatial audio control may toggle simulation of a more realistic listening experience in which audio seems to come from sources of sound in a separate frame of reference, such as the physical environment (e.g., when a spatial audio mode is enabled, audio is generated and/or output so as to sound as though different sources of sound come from different simulated positions in a three-dimensional environment) surrounding the user. As another example, selection of the stereo setting toggles the output mode between stereo audio output and mono audio output. As another example, selection of the balance setting allows a user to adjust relative volume between different speaker devices. Presenting the speech detection control and one or more ambient noise controls enhances operability of the device (e.g., provides flexibility by reducing the number of inputs needed) and makes the user-device interface more efficient.

In some embodiments, the wearable audio output device detects (1430) a change in one or more audio properties of the physical environment; and, in response to detecting the change in the one or more audio properties of the physical environment, changes a modification of ambient sound from the physical environment by the wearable audio output device. For example, FIGS. 8G-8H illustrate a change in audio properties due to the discussion between persons 832-1 and 832-2 and a resulting change to ANC mode 830 (e.g., from level 830-1 to level 830-2). Varying the levels of different audio components, and the balance between the different audio components, in an audio output allows for the manner in which audio output is provided to be dynamically adjusted to be better suited to the current state of the surrounding physical environment, without requiring additional input from the user. Providing an adaptive and more intuitive user experience while reducing the number of inputs needed to achieve such an experience enhances the operability of the device and makes the user-device interface more efficient (e.g., by helping the user to achieve an intended outcome and reducing user mistakes when operating/interacting with the device), which, additionally, reduces power usage and improves battery life of the device by enabling the user to use the device more quickly and efficiently.

In some embodiments, changing the modification of ambient sound includes changing a degree of active noise cancellation (e.g., changing ANC mode 830 from level 830-1 to level 830-2). In some embodiments, changing the degree of active noise cancellation (ANC) comprises disabling the ANC mode. In some embodiments, changing the degree of ANC comprises increasing the degree of ANC (e.g., in accordance with noise in the physical environment increasing). In some embodiments, changing the degree of ANC comprises decreasing the degree of ANC (e.g., in accordance with noise in the physical environment decreasing and/or in response to a particular type of sound in the physical environment being detected). Changing the degree of ANC in response to detecting the change in the one or more audio properties of the physical environment enhances the operability of the device (e.g., allowing the user to better hear events in the environment and/or blocking out irrelevant noise) and reduces power usage and improves battery life of the devices.

In some embodiments, changing the modification of ambient sound includes changing a degree of active transparency. For example, FIGS. 8K-8L illustrate a change in audio properties due to the speech from person 832-1 and a resulting change to active transparency mode 840 (e.g., from level 840-1 to level 840-2). In some embodiments, changing the degree of active transparency comprises enabling an active transparency mode. In some embodiments, changing the degree of active transparency comprises increasing the degree of active transparency (e.g., in response to a particular type of sound in the physical environment). In some embodiments, changing the degree of active transparency comprises decreasing the degree of active transparency (e.g., in accordance with noise in the physical environment increasing). Changing the degree of ANC in response to detecting the change in the one or more audio properties of the physical environment enhances the operability of the device (e.g., allowing the user to better hear events in the environment and/or blocking out irrelevant noise) and reduces power usage and improves battery life of the devices.

In some embodiments, the ambient sound modification is changed in response to detecting the change in the one or more audio properties of the physical environment in accordance with a determination that an adaptive ambient mode is enabled (e.g., FIGS. 8G-8L show that adaptive noise management mode 833 is enabled). In some embodiments, the adaptive ambient mode is independent of the speech detection mode. In some embodiments, a user interface (e.g., a control center user interface, an example of which is shown in FIGS. 6F-6I) includes an element (e.g., an icon, such as adaptive adjustments control 678, FIG. 6G) that, when selected, enables, disables, or toggles the adaptive ambient mode. In some embodiments, the user interface further includes a second element (e.g., a second icon, such as speech detection control 682, FIG. 6G) that, when selected, enables, disables, or toggles the speech detection mode. Providing a means for the user to active and deactivate the adaptive ambient mode enhances the operability of the devices and makes the user-device interface more efficient (e.g., by helping the user to achieve an intended outcome and reducing user mistakes when operating/interacting with the devices), which, additionally, reduces power usage and improves battery life of the devices by enabling the user to use the devices more quickly and efficiently.

In some embodiments, the wearable audio output device detects (1432) a change in one or more audio properties of the physical environment; and, in response to detecting the change in the one or more audio properties of the physical environment, changes an audio playback level of audio playback from the wearable audio output device. For example, FIGS. 8G-8H illustrate a change in audio properties due to the discussion between persons 832-1 and 832-2 and a resulting change to media content 831 (e.g., from level 831-1 to level 831-2). For example, a volume level of the audio playback is increased in accordance with an ambient sound level of the physical environment increasing. As another example, the volume level of the audio playback is decreased in response to a particular type of sound (e.g., a train horn, a car horn, a broadcast announcement, or other type of sound.

In some embodiments, the audio playback is changed in response to detecting the change in the one or more audio properties of the physical environment in accordance with a determination that an adaptive playback mode is enabled (e.g., FIGS. 8G-8L show that adaptive volume mode 835 is enabled). In some embodiments, the adaptive playback mode is independent of the speech detection mode. In some embodiments, a user interface (e.g., a control center user interface) includes an element (e.g., an icon, such as adaptive adjustments control 678, FIG. 6G) that, when selected, enables, disables, or toggles the adaptive playback mode. In some embodiments, the user interface further includes a second element (e.g., a second icon, such as speech detection control 682, FIG. 6G) that, when selected, enables, disables, or toggles the speech detection mode.

Changing the level of provided audio content from a device in response to changes in the audio properties of the surrounding physical environment balances the user's ability to hear provided device audio content against the user's ability to interact with the surrounding physical environment, without requiring additional input from the user. Providing an adaptive and more intuitive user experience while reducing the number of inputs needed to achieve such an experience enhances the operability of the device and makes the user-device interface more efficient (e.g., by helping the user to achieve an intended outcome and reducing user mistakes when operating/interacting with the device), which, additionally, reduces power usage and improves battery life of the device by enabling the user to use the device more quickly and efficiently.

It should be understood that the particular order in which the operations in FIGS. 14A-14C have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 1300, 1500, and 1600) are also applicable in an analogous manner to method 1400 described above with respect to FIGS. 14A-14C. For example, the inputs, gestures, functions, and feedback described above with reference to method 1400 optionally have one or more of the characteristics of the inputs, gestures, functions, and feedback described herein with reference to other methods described herein (e.g., methods 1300, 1500, and 1600). For brevity, these details are not repeated here.

FIGS. 15A-15B are flow diagrams illustrating method 1500 for adaptively changing modification of ambient sound audio levels in response to detected change in one or more audio properties of the physical environment in accordance with some embodiments. Method 1500 is performed at a wearable audio output device (e.g., wearable audio output device 301-1) that includes one or more audio output devices (e.g., speaker(s) 306). Examples of the wearable audio output device include in-ear earphones, over-ear headphones, or other wearable audio output device. In some embodiments, the wearable audio output device includes one or more elements to enable the speaker to be positioned in a respective physical arrangement relative to an car of a person using the wearable audio output device. In some embodiments, the wearable audio output device includes a housing with one or more physically distinguished portions. In some embodiments, the wearable audio output device includes one or more placement sensors (e.g., sensor(s) 304). Some operations in method 1500 are, optionally, combined and/or the order of some operations is, optionally, changed.

As described below, method 1500 provides audio outputs in an intuitive manner by adjusting the levels of different audio components in an audio output in response to changes in the audio properties of the surrounding physical environment. Varying the levels of different audio components, and the balance between the different audio components, in an audio output allows for the manner in which audio output is provided to be dynamically adjusted to be better suited to the current state of the surrounding physical environment, without requiring additional input from the user. Providing an adaptive and more intuitive user experience while reducing the number of inputs needed to achieve such an experience enhances the operability of the device and makes the user-device interface more efficient (e.g., by helping the user to achieve an intended outcome and reducing user mistakes when operating/interacting with the device), which, additionally, reduces power usage and improves battery life of the device by enabling the user to use the device more quickly and efficiently.

While the wearable audio output device has a first physical arrangement relative to a respective body part of a user (e.g., the headphone is being worn by a user, in, on, or over one or more of the user's ears) and ambient sound from the physical environment is modified by the wearable audio output device (e.g., via active noise cancellation, passive noise cancellation, and/or active audio transparency) to have a first ambient-sound level, the wearable audio output device detects (1502) a change in one or more audio properties of the physical environment. For example, FIGS. 8G-8P illustrate a change in audio properties due to the discussion between persons 832-1 and 832-2 and user 804.

In response to detecting the change in the one or more audio properties of the physical environment (1504) and in accordance with the wearable audio output device operating in a first mode (e.g., adaptive noise management mode 833), the wearable audio output device changes (1506) a modification of ambient sound (e.g., by decreasing a degree of active noise cancellation and/or increasing a degree of active transparency) from the physical environment by the wearable audio output device, where changing the modification of ambient sound from the physical environment includes changing a degree and/or type of ambient sound modification that is being provided by the audio output component. For example, FIGS. 8G-8H illustrate a change in audio properties due to the discussion between persons 832-1 and 832-2 and a resulting change to ANC mode 830 (e.g., from level 830-1 to level 830-2).

In some embodiments, changing the modification of the ambient sound includes (1508) switching from a noise cancellation mode to an active transparency mode. For example, FIGS. 8J-8K illustrate a change in audio properties due to person 832-1 talking and a resulting switch from ANC mode 830 to active transparency mode 840. In some embodiments, changing the modification of the ambient sound comprises switching from the active transparency mode to the noise cancellation mode. In some examples, the provided audio output is automatically adjusted to allow the user to hear more ambient sound when speech (or an increase in speech) is detected in the surrounding physical environment. Varying the levels of different audio components, and the balance between the different audio components, in an audio output allows for the manner in which audio output is provided to be dynamically adjusted to be better suited to the current state of the surrounding physical environment, without requiring additional input from the user. Providing an adaptive and more intuitive user experience while reducing the number of inputs needed to achieve such an experience enhances the operability of the device and makes the user-device interface more efficient (e.g., by helping the user to achieve an intended outcome and reducing user mistakes when operating/interacting with the device), which, additionally, reduces power usage and improves battery life of the device by enabling the user to use the device more quickly and efficiently.

In some embodiments, changing the modification of the ambient sound includes (1510) changing a degree of active noise cancellation (e.g., changing ANC mode 830 from level 830-1 to level 830-2, FIGS. 8G-8H). In some embodiments, changing the degree of active noise cancellation (ANC) comprises disabling or enabling the ANC mode. In some embodiments, changing the degree of ANC comprises reducing the ANC from above a threshold percentage (e.g., 90%, 80%, 75%, or 50%) to below the threshold percentage. For example, prior to detecting the speech, the ANC reduces the ambient sound to an ambient-sound audio level of 20%, 10%, or 5% and, in response to detecting the speech, the ANC reduces the ambient sound to an ambient-sound audio level of 80%, 75%, 70%, or 50%. In some embodiments, changing the degree of ANC comprises increasing the ANC from below a threshold percentage (e.g., 90%, 80%, 75%, or 50%) to above the threshold percentage. Changing the degree of ANC in response to detecting the change in the one or more audio properties of the physical environment enhances the operability of the device (e.g., allowing the user to better hear events in the environment and/or blocking out irrelevant noise) and reduces power usage and improves battery life of the devices.

In some embodiments, changing the modification of the ambient sound includes (1512) changing a degree of active transparency. For example, FIGS. 8K-8L illustrate a change in audio properties due to the speech from person 832-1 and a resulting change to active transparency mode 840 (from level 840-1 to level 840-2). In some embodiments, changing the degree of active transparency comprises enabling or disabling an active transparency mode. In some embodiments, changing the degree of active transparency comprises increasing the active transparency from below a threshold percentage (e.g., 15%, 20%, 30%, or 50%) to above the threshold percentage. For example, prior to detecting the speech, the active transparency increases the ambient sound at an ambient-sound audio level of 10%, 20%, or 35% and, in response to detecting the speech, the active transparency increases the ambient sound to an ambient-sound audio level of 80%, 75%, 70%, or 50%. In some embodiments, changing the degree of active transparency comprises decreasing the active transparency from above a threshold percentage (e.g., 15%, 20%, 30%, or 50%) to below the threshold percentage. Changing the degree of active transparency in response to detecting the change in the one or more audio properties of the physical environment enhances the operability of the device (e.g., allowing the user to better hear events in the environment and/or blocking out irrelevant noise) and reduces power usage and improves battery life of the devices.

In response to detecting the change in the one or more audio properties of the physical environment (1504) and in accordance with the wearable audio output device not operating in the first mode, the wearable audio output device forgoes (1514) changing the modification of the ambient sound in response to detecting the change in the one or more audio properties of the physical environment. For example, FIGS. 8O-8P show adaptive noise management mode 833 disabled and ANC mode 830 not changing in response to the discussion between persons 832-1 and 832-2.

In some embodiments, in response to detecting the change in the one or more audio properties of the physical environment and in accordance with the wearable audio output device operating in the first mode and in accordance with an active transparency mode being enabled, the wearable audio output device forgoes changing the modification of the ambient sound in response to detecting the change in the one or more audio properties of the physical environment. For example, the wearable audio output device changes the modification of the ambient sound in response to detecting the change in the one or more audio properties of the physical environment when an ANC mode is enabled (e.g., in accordance with the wearable audio output device operating in the first mode and in accordance with the ANC mode being enabled). In this example, the wearable audio output device does not change the modification of the ambient sound in response to detecting the change in the one or more audio properties of the physical environment when an active transparency mode is enabled. In some embodiments, the method further includes in response to detecting a change in the one or more audio properties, in accordance with the wearable audio output device operating in the first mode and in accordance with an active transparency mode being disabled, changing the modification of the ambient sound. Providing a means for the user to active and deactivate the first mode and/or the active transparency mode enhances the operability of the devices and makes the user-device interface more efficient (e.g., by helping the user to achieve an intended outcome and reducing user mistakes when operating/interacting with the devices).

In some embodiments, in response to detecting the change in the one or more audio properties of the physical environment and in accordance with the wearable audio output device operating in the first mode and in accordance with an ANC mode being enabled, the wearable audio output device forgoes changing the modification of the ambient sound in response to detecting the change in the one or more audio properties of the physical environment. For example, the wearable audio output device changes the modification of the ambient sound in response to detecting the change in the one or more audio properties of the physical environment when an active transparency mode is enabled (e.g., in accordance with the wearable audio output device operating in the first mode and in accordance with the active transparency mode being enabled). In this example, the wearable audio output device does not change the wearable audio output device does not change the modification of the ambient sound in response to detecting the change in the one or more audio properties of the physical environment when an ANC mode is enabled. In some embodiments, the method further includes in response to detecting a change in the one or more audio properties, in accordance with the wearable audio output device operating in the first mode and in accordance with an ANC mode being disabled, changing the modification of the ambient sound. Providing a means for the user to active and deactivate the first mode and/or the ANC mode enhances the operability of the devices and makes the user-device interface more efficient (e.g., by helping the user to achieve an intended outcome and reducing user mistakes when operating/interacting with the devices).

In some embodiments, the wearable audio output device detects (1516) an input via one or more input devices of the wearable audio output device; and, in response to detecting the input, changes enablement of the first mode. For example, FIG. 8M shows user input 850 causing adaptive noise management mode 833 to be disabled, as indicated by feedback 852. For example, the input causes the first mode to be enabled, disabled, or toggled. In some embodiments, a first type of input causes the first mode to be enabled and a second type of input causes the first mode to be disabled. For example, the input is a tap input, a double tap input, a deep press input, a squeeze input, a button press input, a swipe input, or other type of input. Adjusting audio output modes in response to gestures at the wearable audio output device enhances operability of the device (e.g., provides flexibility without requiring a graphical user interface and/or cluttering the user interface with additional displayed controls, as well as reducing the number of inputs needed to access this flexibility) and makes the user-device interface more efficient.

In some embodiments, in conjunction with changing the enablement of the first mode, the wearable audio output device provides (1518) first feedback to the user (e.g., feedback 852, FIG. 8M). In some embodiments, the first feedback includes audio feedback (e.g., one or more tones) provided by the audio output component. In some embodiments, the first feedback includes haptic feedback provided by the wearable audio output device. In some embodiments, the method further includes, in conjunction with changing enablement of a different mode, providing second feedback to the user, wherein the second feedback is different than the first feedback. For example, the different mode is an ANC mode, an active transparency mode, a speech detection mode, or other audio mode. Providing feedback to the user enhances the operability of the devices and makes the user-device interface more efficient (e.g., by helping the user to achieve an intended outcome and reducing user mistakes when operating/interacting with the devices), which, additionally, reduces power usage and improves battery life of the devices by enabling the user to use the devices more quickly and efficiently. Additionally, providing non-visual feedback provides flexibility without requiring a graphical user interface and/or cluttering the user interface with additional displayed controls, as well as reducing the number of inputs needed to access this flexibility, which makes the user-device interface more efficient.

In some embodiments, the wearable audio output device causes (1520) display of an adaptive ambient control (e.g., noise management control 714, FIG. 7B, or adaptive adjustments control 678, FIG. 6G) at a user interface of an electronic device that is communicatively coupled to the wearable audio output device, and the adaptive ambient control is configured to, when selected, toggle the first mode. In some embodiments, the user interface (e.g., a control center user interface) further includes a second control (e.g., a second icon) that, when selected, enables, disables, or toggles a speech detection mode. Providing a means for the user to active and deactivate the first mode enhances the operability of the devices and makes the user-device interface more efficient (e.g., by helping the user to achieve an intended outcome and reducing user mistakes when operating/interacting with the devices).

In some embodiments, the user interface further includes an ANC control (e.g., active noise control icon 692, FIG. 6J, of expanded noise management control 690) and an active transparency control (e.g., transparency icon 696 of expanded noise management control 690). In some embodiments, the ANC control (e.g., an icon), when selected, enables, disables, or toggles an ANC mode. In some embodiments, the active transparency control (e.g., an icon), when selected, enables, disables, or toggles an active transparency mode. Presenting the ANC control and the active transparency control enhances operability of the device (e.g., provides flexibility by reducing the number of inputs needed) and makes the user-device interface more efficient.

In some embodiments, the adaptive ambient control has a different visual characteristic than the ANC control and the active transparency control. In some embodiments, the adaptive ambient control has a different color and/or glyph than the ANC control and the active transparency control. For example, the ANC and active transparency controls are a first color (e.g., blue, green, or other color) and the adaptive ambient control is a second color (e.g., red, orange, or other color). Presenting a visually-distinct control enhances operability of the device (e.g., provides flexibility by reducing the number of inputs needed) and makes the user-device interface more efficient.

It should be understood that the particular order in which the operations in FIGS. 15A-15B have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 1300, 1400, and 1600) are also applicable in an analogous manner to method 1500 described above with respect to FIGS. 15A-15B. For example, the inputs, gestures, functions, and feedback described above with reference to method 1500 optionally have one or more of the characteristics of the inputs, gestures, functions, and feedback described herein with reference to other methods described herein (e.g., methods 1300, 1400, and 1600). For brevity, these details are not repeated here.

FIGS. 16A-16C are flow diagrams illustrating method 1600 for communicatively coupling a wearable audio output device with authorized electronic devices in accordance with some embodiments. Method 1500 is performed at a wearable audio output device (e.g., wearable audio output device 301-1) and/or one or more electronic devices (e.g., device 100). Examples of the wearable audio output device include in-ear earphones, over-ear headphones, or other wearable audio output device. In some embodiments, the wearable audio output devices includes one or more audio output devices (e.g., speaker(s) 306). In some embodiments, the wearable audio output device includes one or more elements to enable the speaker to be positioned in a respective physical arrangement relative to an car of a person using the wearable audio output device. In some embodiments, the wearable audio output device includes a housing with one or more physically distinguished portions. In some embodiments, the wearable audio output device includes one or more placement sensors (e.g., sensor(s) 304). Some operations in method 1600 are, optionally, combined and/or the order of some operations is, optionally, changed.

As described below, method 1600 provides automatic communicative coupling between a wearable audio output device and multiple electronic devices based on user account. Selectively coupling the wearable audio output device to the multiple electronic devices provides improved security/privacy by determining whether the devices are associated with a same user account before automatically coupling, as well as reducing the number of inputs needed for the user to control the audio device, and enhancing the operability of the audio output device.

While the wearable audio output device is communicatively coupled to wirelessly play audio from a first electronic device that is associated with a first user account, the wearable audio output device detects (1602) a second electronic device in a communication range of the wearable audio output device, the second electronic device capable of providing audio to the wearable audio output device, where the second electronic device is associated with a user account that is authorized to use the wearable audio output device.

In response to detecting the second electronic device (1604) and in accordance with a determination that the second electronic device is associated with the first user account, the wearable audio output device communicatively couples (1606) to wirelessly play audio from the second electronic device (e.g., automatically, without further input from a user of the device). For example, FIG. 11C shows device 100-2 within communication range 1101 and wearable audio output devices 301 communicatively coupling with device 100-2 via guest association 1104.

In response to detecting the second electronic device (1604) and in accordance with a determination that the second electronic device is not associated with the first user account, the wearable audio output device forgoes (1608) communicatively coupling to wirelessly play audio from the second electronic device even though the second electronic device is associated with a user account that is authorized to use the wearable audio output device. For example, FIG. 11E shows device 100-3 within communication range 1101 of wearable audio output devices 301 but not automatically communicatively coupling with wearable audio output devices 301. For example, the wearable audio output device automatically couples to devices associated with the first user account, but does not automatically couple to devices associated with another user account that is authorized to use the wearable audio output device. In some embodiments, communicatively coupling the wearable audio output device to wirelessly play audio from a remote device comprises establishing an audio route to wirelessly play audio from the remote device at the wearable audio output device. In some embodiments, establishing the audio route comprises designating the wearable audio output device as the audio output device for audio outputs from the remote device. In some embodiments, communicatively coupling the wearable audio output device to wirelessly play audio includes playing audio from an application (e.g., music application, telephony application, video conferencing application, audio book application, or other type of application) executing on the remote device, such as music, spoken word audio, and/or other type of audio. As an example, the wearable audio output device is communicatively coupled to the first electronic device and is outputting audio from a show a user is watching on the first electronic device.

In some embodiments, in accordance with a determination that the second electronic device is not associated with the first user account, the wearable audio output device causes (1610) an option to be provided to a user of the second electronic device to communicatively couple to the wearable audio output device. For example, FIG. 11E shows coupling user interface 1108 displayed on device 100-3 including connect element 1110. In some embodiments, while providing the option to the user of the second electronic device, a second user input is detected selecting the option. In some embodiments, in response to detecting the selection of the option, the second electronic device is communicatively coupled to the wearable audio output device (e.g., an audio route is set between the second electronic device and the wearable audio output device). For example, the audio route between the second electronic device and the wearable audio output device allows for audio from the second electronic device to be played back at the wearable audio output device. In some embodiments, in response to detecting the selection of the option, an audio route between the first electronic device and the wearable audio output device is disabled (e.g., terminated). For example, in response to detecting the selection of the option, audio routing is switched from being between the first electronic device and the wearable audio output device to being between the second electronic device and the wearable audio output device. For example, the second electronic device displays a notification (e.g., 1108, FIG. 11E) that indicates that the wearable audio output device is coupled to the first electronic device and an option to couple the wearable audio output device to the second electronic device (e.g., in addition to, or in place of, the coupling to the first electronic device). In some embodiments, the option is provided in a notification user interface. In some embodiments, the method further comprises in accordance with a determination that the second electronic device is not associated with the first user account, providing an option to a user of the first electronic device to communicatively couple to the wearable audio output device to the second electronic device. In some embodiments, in accordance with a determination that the first account is a guest account, displaying a notification with the option, the notification indicating that switching the communicative coupling will remove the association between the first account and the wearable audio output device. Providing the option to communicatively couple to the wearable audio output device to the user enhances identification (e.g., distinguishing between multiple electronic devices) and security (e.g., distinguishing between electronic devices owned by the user and electronic devices owned by other users) and makes the user-device interface more efficient (e.g., by helping the user to interact with the desired electronic device), which, additionally, reduces power usage and improves battery life of the devices by enabling the user to control the devices more quickly and efficiently.

In some embodiments, the wearable audio output device detects (1612) a third electronic device in the communication range of the wearable audio output device; and, in response to detecting the third electronic device, in accordance with a determination that the third electronic device is not associated with a user account that is authorized to use the wearable audio output device, the wearable audio output device forgoes causing an option to be provided to a user of the third electronic device to communicatively couple to the wearable audio output device. For example, FIG. 11G shows device 100-4 within communication range 1101 of wearable audio output devices 301 but not communicatively coupling with wearable audio output devices 301 (or causing an option to be displayed to communicatively couple). In some embodiments, in response to detecting the third electronic device, in accordance with a determination that the third electronic device is not associated with a user account that is authorized to use the wearable audio output device, wearable audio output device forgoes providing an option to a user of the first electronic device to communicatively couple the third electronic device to the wearable audio output device. Forgoing causing the option to be provided to a user of the third electronic device to communicatively couple to the wearable audio output device improves security (e.g., avoiding coupling with unknown/unauthorized devices) and makes the user-device interface more efficient.

In some embodiments, the second electronic device: (i) displays (1614) a user interface that includes indication of the communicative coupling between the wearable audio output device and the first user account and provides an option to switch the communicatively coupling to the second electronic device; (ii) detects an input at the option; and (iii), in response to detecting the input, communicatively couples to the wearable audio output device. For example, FIG. 11E shows coupling user interface 1108 displayed on device 100-3 including connect element 1110 with user input 1112 at connect element 1110 and FIG. 11F shows wearable audio output devices 301 communicatively coupling with device 100-3 in response to user input 1112. In some embodiments, the user interface is displayed at the first electronic device. In some embodiments, the user interface is displayed at the second electronic device. In some embodiments, the user interface comprises a notification, a proximity card, an airplay route picker, or other type of user interface. Providing a means for the user to communicatively couple the wearable audio output device and the second electronic device enhances the operability of the devices and makes the user-device interface more efficient (e.g., by helping the user to achieve an intended outcome and reducing user mistakes when operating/interacting with the devices).

In some embodiments, in accordance with a determination that the first account is a guest account, the second electronic device displays (1616) a notification in the user interface that switching the communicative coupling will remove the association between the first account and the wearable audio output device; and, in accordance with a determination that the first account is not a guest account, forgoes displaying the notification in the user interface. For example, coupling user interface 1108 in FIG. 11E includes text regarding the guest account in accordance with the first user account being a guest account, but coupling user interface 1120 in FIG. 11H does not include text regarding the guest account. In some embodiments, the method further includes, in accordance with a determination that the first account has a guest account type, displaying a notification in the user interface that switching the communicative coupling will remove the association between the first account and the wearable audio output device; and, in accordance with a determination that the first account does not have the guest account type, forgoing displaying the notification in the user interface. Providing feedback to the user enhances the operability of the device and makes the user-device interface more efficient (e.g., by helping the user to achieve an intended outcome and reducing user mistakes when operating/interacting with the device).

In some embodiments, while the wearable audio output device is communicatively coupled to the second electronic device, the wearable audio output device detects (1618) a fourth electronic device; and, in response to detecting the fourth electronic device and in accordance with a determination that the fourth electronic device is associated with the same user account as the second electronic device, communicatively couples to wirelessly play audio from the fourth electronic device (e.g., automatically, without further input from a user of the device). For example, FIG. 11K shows device 100-7 being in communication range 1101 of wearable audio output devices 301 and communicatively coupling with wearable audio output devices 301 in accordance with device 100-7 being associated with the same user account as device 100-5 (e.g., a fourth user account). In some embodiments, the second electronic device is associated with a second user account, and the method further comprises, prior to detecting the fourth electronic device, communicatively coupling the wearable audio output device to the second electronic device in response to a user command. Automatically communicatively coupling in response to detecting the fourth electronic device allows for dynamically adjusting audio routing, without requiring additional input from the user, thereby providing an intuitive user experience while reducing the number of inputs needed to achieve such an experience.

In some embodiments, in response to detecting the fourth electronic device and in accordance with a determination that the fourth electronic device is associated with the first user account, the wearable audio output device forgoes (1620) communicatively coupling the wearable audio output device to wirelessly play audio from the fourth electronic device. For example, the wearable audio output device automatically couples to other devices associated with a same account as a device to which the wearable audio output device is currently coupled. In this example, the wearable audio output device does not automatically couple to other devices that are associated with other accounts (or no account). Forgoing communicatively coupling the wearable audio output device to wirelessly play audio from the fourth electronic device improves security (e.g., avoiding coupling with a different user account without permission) and provides an intuitive user experience while reducing the number of inputs needed to achieve such an experience.

In some embodiments, while the wearable audio output device is communicatively coupled to the second electronic device, the wearable audio output device: (i) detects (1622) a fifth electronic device, where the fifth electronic device is associated with the first user account; and (ii) in response to detecting the fifth electronic device: (a) in accordance with a determination that the first user account is not a guest account, provides an option to communicatively coupling the wearable audio output device to wirelessly play audio from the fifth electronic device; and (b) in accordance with a determination that the first user account is a guest account, forgoes providing the option to communicatively coupling the wearable audio output device to wirelessly play audio from the fifth electronic device. For example, FIG. 11J shows device 100-6 being in communication range 1101 of wearable audio output devices 301 and coupling user interface 1128 being displayed in accordance with device 100-6 being associated with the second user account (e.g., the owner account). For example, a guest account that was associated with wearable audio output device is no longer associated with the wearable audio output device after the wearable audio output device is switched to a communicative coupling with a different (e.g., permanent) associated account. As another example, if wearable audio output device was paired with a guest pairing, manually switching audio routes disables the guest pairing. In these examples, a non-guest account (e.g., a permanent account) association is maintained with the wearable audio output device after the wearable audio output device is switched to a communicative coupling with a different (e.g., permanent) associated account. Providing a means for the user to communicatively couple the wearable audio output device and the fifth electronic device enhances the operability of the devices and makes the user-device interface more efficient (e.g., by helping the user to achieve an intended outcome and reducing user mistakes when operating/interacting with the devices).

In some embodiments, the user account associated with the second electronic device is a second user account; and, while the wearable audio output device is communicatively coupled to the second electronic device, in accordance with a determination that the second user account is not designated as an owner of the wearable audio output device, the second electronic device displays a notification (e.g., notification user interface 604) that device finding capabilities for the wearable audio output device are active for a different user account. For example, the different user account is the first user account, or another user account designated as the owner of the wearable audio output device. In some embodiments, the notification is displayed in conjunction with communicatively coupling the wearable audio output device with the second electronic device. Providing feedback to the user enhances the operability of the device and makes the user-device interface more efficient (e.g., by helping the user to achieve an intended outcome and reducing user mistakes when operating/interacting with the device) as well as enhancing security and privacy of the user.

In some embodiments, the first electronic device displays (1624) a user interface that includes a name of the wearable audio output device; in accordance with a determination that the first user account is designated as an owner of the wearable audio output device, includes in the user interface an option to rename the wearable audio output device; and in accordance with a determination that the first user account is not designated as the owner of the wearable audio output device, provides an indication in the user interface that the wearable audio output device is owned by a different user account (e.g., naming user interface 628). In some embodiments, selection of the option to rename the wearable audio output device initiates a process for renaming the wearable audio output device. For example, selection of the option to rename the wearable audio output device causes display of a field (e.g., a text box) into which the user may input a name for the wearable audio output device (e.g., delete or edit an existing name). For example, the indication includes a message that the wearable audio output device cannot be renamed by the user of the first electronic device due to the first account not being designated as the owner of the wearable audio output device. Providing feedback to the user enhances the operability of the device and makes the user-device interface more efficient (e.g., by helping the user to achieve an intended outcome and reducing user mistakes when operating/interacting with the device).

In some embodiments, in accordance with a determination that the first user account is not designated as the owner of the wearable audio output device, the first electronic device provides (1626) an option in a user interface to request ownership of the wearable audio output device (e.g., option 608, FIG. 6A, or option 632, FIG. 6C). In some embodiments, the option is a button that, when selected, causes a message to be sent to a device associated with the owner account. In some embodiments, the ownership request is sent to a device associated with an owner account of the wearable audio output device. For example, an email, SMS, or other type of message is sent to the device associated with the owner account. Providing a means for the user to request ownership enhances the operability of the devices and makes the user-device interface more efficient (e.g., by helping the user to achieve an intended outcome and reducing user mistakes when operating/interacting with the devices).

In some embodiments, the first electronic device detects an input selecting the option; and, in response to detecting the input, causes a request to be sent to a device associated with an account designated as the owner of the wearable audio output device.

In some embodiments, the request does not identify the sender of the request (e.g., the request is an anonymous request). In some embodiments, the request identifies a device type of the first electronic device. In some embodiments, the request indicates a location of the first electronic device. In some embodiments, the request includes an identifier for the first user account. Providing a means for the user to request ownership anonymously protects security and privacy of the user (e.g., in a situation where the user purchased the wearable audio output device at arm's length and does not want to share identifying information with the seller).

In some embodiments, a sixth electronic device that is associated with a second user account displays a user interface (e.g., user interface 1140, FIG. 11L) that includes an option to temporarily communicatively couple (e.g., temporary share element 1150) the wearable audio output device with the sixth electronic device in accordance with a determination that a second wearable audio output device (e.g., wearable audio output devices 1149) associated with the sixth electronic device is nearby, where the user interface includes an option (e.g., guest association element 1162, FIG. 11M) to designate the second user account as a guest account for the wearable audio output device with the sixth electronic device in accordance with a determination that no other wearable audio output device associated with the sixth electronic device is nearby. In some embodiments, selection of the option to designate the second user account as a guest account initiates a process for adding the wearable audio output device as a guest device for the second user account. For example, selection of the option to designate the second user account as a guest account initiates a process for establishing an audio route between the third electronic device and the wearable audio output device. In some embodiments, temporarily communicatively coupling the wearable audio output device with the sixth electronic device comprises coupling the wearable audio output device with the sixth electronic device without generating an association between the second user account and the wearable audio output device. In some embodiments, temporarily communicatively coupling the wearable audio output device with the sixth electronic device comprises coupling the wearable audio output device with the sixth electronic device for a single session. For example, the sixth electronic device and the wearable audio output device are communicatively coupled in response to selection of the option to temporarily communicatively couple. In this example, after the sixth electronic device is disconnected (e.g., decoupled) from the wearable audio output device, the wearable audio output device will not automatically recouple to the sixth electronic device. Providing options for temporarily communicatively coupling, generating a guest association, and/or generating a permanent association (e.g., a persistent association) enhances the operability of the device and makes the user-device interface more efficient (e.g., by helping the user to achieve an intended outcome and reducing user mistakes when operating/interacting with the device) as well as improving security (e.g., by helping the user limit access to their devices by other accounts and/or users).

In some embodiments, the user interface further includes a second option (e.g., permanent association element 1152, FIG. 11L or permanent association element 1164, FIG. 11M) to associate the second user account with the wearable audio output device. In some embodiments, selection of the second option initiates a process for adding the wearable audio output device as a device for the second user account (e.g., adding the wearable audio output device to the second user account). For example, selection of the second option initiates a process for establishing an audio route between the sixth electronic device and the wearable audio output device. For example, the second option creates an association that persists after the sixth electronic device and the wearable audio output device are no longer communicatively coupled. In some embodiments, the second option is included in the user interface independent of whether another wearable audio output device associated with the sixth electronic device is nearby. Presenting the second option to associate the second user account with the wearable audio output device enhances operability of the device (e.g., provides flexibility by reducing the number of inputs needed) and makes the user-device interface more efficient.

In some embodiments, an electronic device displays a user interface (e.g., account user interface 1202, FIG. 12A) that includes indication of devices associated with the wearable audio output device, where devices associated with the first user account are displayed in a first section of the user interface (e.g., listing 1214) and device associated with a guest account are displayed in a second section of the user interface (e.g., listing 1222). For example, the user interface is displayed at the first electronic device. In some embodiments, the user interface is displayed at another electronic device associated with the first user account. Providing feedback to the user with regards to which devices are associated with a guest account enhances the operability of the device and makes the user-device interface more efficient (e.g., by helping the user to achieve an intended outcome and reducing user mistakes when operating/interacting with the device).

It should be understood that the particular order in which the operations in FIGS. 16A-16C have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 1300, 1400, and 1500) are also applicable in an analogous manner to method 1600 described above with respect to FIGS. 16A-16C. For example, the inputs, gestures, functions, and feedback described above with reference to method 1600 optionally have one or more of the characteristics of the inputs, gestures, functions, and feedback described herein with reference to other methods described herein (e.g., methods 1300, 1400, and 1500). For brevity, these details are not repeated here.

The operations described above with reference to FIGS. 13A-13C, 14A-14C, 15A-15B, and 16A-16C are, optionally, implemented by components depicted in FIGS. 1A-1B, 2, and/or 3A-3C. For example, detection operation 1302 and adjustment operation 1308 are, optionally, implemented by event sorter 170, event recognizer 180, and event handler 190. Event monitor 171 in event sorter 170 detects a contact on touch-sensitive display system 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B, 2, and/or 3A-3C.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method at a wearable audio output device that includes a microphone and one or more input devices:
detecting an input via the one or more input devices;
in response to detecting the input, in accordance with a determination that the input is a first type of input, adjusting a mute state of the microphone for a first audio function that uses the microphone without adjusting the mute state of the microphone for a second audio function that uses the microphone; and
in response to detecting the input, in accordance with a determination that the input is not the first type of input, forgoing adjusting the mute state of the microphone for the first audio function that uses the microphone.

2. The method of claim 1, wherein the first audio function corresponds to detecting audio with one or more microphones at the wearable audio output device and enabling the detected audio to be used to provide input to a real-time communication session.

3. The method of claim 1, wherein the second audio function corresponds to detecting audio with one or more microphones at the wearable audio output device and enabling the detected audio to be used to generate instructions for a digital assistant.

4. The method of claim 1, wherein the second audio function corresponds to detecting audio with one or more microphones at the wearable audio output device and enabling the detected audio to be used to generate content.

5. The method of claim 1, further comprising:
in response to detecting the input, in accordance with a determination that the input is a second type of input, activating a second function of the wearable audio output device, wherein the second function is distinct from adjusting the mute state of the microphone.

6. The method of claim 5, wherein the second function corresponds to changing a volume level of the wearable audio output device.

7. The method of claim 5, wherein the second function corresponds to a digital assistant.

8. The method of claim 5, wherein the second function corresponds to changing an audio output mode of the wearable audio output device.

9. The method of claim 1, wherein the mute state of the microphone is adjusted in response to detecting the input based on a first input mapping; and
the method further comprises:
after adjusting the mute state of the microphone in response to detecting the input, obtaining a second input mapping for the wearable audio output device;
after obtaining the second input mapping, detecting a second input via the one or more input devices, the second input being the first type of input; and
in response to detecting the second input, adjusting an audio output state of the wearable audio output device based on the second input mapping.

10. The method of claim 1, wherein the wearable audio output device is in communication with a second wearable audio output device to form a set of wearable audio output devices.

11. The method of claim 10, wherein adjusting the mute state of the microphone for the first audio function comprises adjusting the mute state for both the wearable audio output device and the second wearable audio output device in the set of wearable audio output devices.

12. The method of claim 10, further comprising:
detecting a second input at the second wearable audio output device; and
in response to detecting the second input, in accordance with a determination that the second input is the first type of input, activating a second function of the second wearable audio output device, wherein the second function of the second wearable audio output device is distinct from adjusting the mute state.

13. The method of claim 10, further comprising:
detecting a second input at the second wearable audio output device; and
in response to detecting the second input, in accordance with a determination that the second input is the first type of input, adjusting a mute state of a microphone of the second wearable audio output device for the first audio function without adjusting the mute state for the second audio function.

14. The method of claim 1, wherein the first type of input comprises a squeeze input.

15. The method of claim 1, wherein the first type of input comprises a tap input.

16. The method of claim 1, further comprising:
in accordance with adjusting the mute state of the microphone, providing non-visual feedback to a user of the wearable audio output device indicating that the mute state of the microphone has been adjusted.

17. The method of claim 16, wherein:
in accordance with the first audio function corresponding to a first application, the non-visual feedback includes first audio feedback; and
in accordance with the first audio function corresponding to a second application, the non-visual feedback includes second audio feedback.

18. The method of claim 1, wherein the wearable audio output device is communicatively coupled to an electronic device, and the method further comprises:
in accordance with adjusting the mute state of the microphone, providing feedback to a user of the wearable audio output device via a display of the electronic device.

19. The method of claim 18, wherein the feedback is displayed within a status region that displays information about one or more operations currently being performed by the electronic device.

20. The method of claim 19, further comprising:
detecting a second input at the electronic device; and
in response to detecting the second input, adjusting a size of the status region.

21. The method of claim 19, wherein the status region includes an element that, when selected, adjusts the mute state of the microphone.

22. The method of claim 19, wherein:
in accordance with the first audio function corresponding to a first application, the status region indicates the first application; and
in accordance with the first audio function corresponding to a second application, the status region indicates the second application.

23. The method of claim 18, wherein the first audio function corresponds to a first application, the feedback is displayed within a user interface of the first application.

24. The method of claim 18, wherein providing the feedback includes:
causing display of a notification user interface element at the electronic device; and
ceasing to cause display of the notification user interface element after a preset time period.

25. The method of claim 1, further comprising:
in accordance with a failure to adjust the mute state of the microphone, providing error feedback to a user of the wearable audio output device.

26. The method of claim 1, wherein a companion device provides information about controlling the mute state of the microphone of the wearable audio output device in conjunction with a software setup or update procedure for the companion device.

27. The method of claim 26, wherein the information about controlling the mute state of the microphone of the wearable audio output device illustrates a simulated input and a simulated adjustment to the mute state of the microphone.

28. A wearable audio output device, comprising:
a microphone;
one or more input devices;
one or more processors; and
memory storing one or more programs, wherein the one or more programs are configured to be executed by the one or more processors, the one or more programs including instructions for:
detecting an input via the one or more input devices;
in response to detecting the input, in accordance with a determination that the input is a first type of input, adjusting a mute state of the microphone for a first audio function that uses the microphone without adjusting the mute state of the microphone for a second audio function that uses the microphone; and
in response to detecting the input, in accordance with a determination that the input is not the first type of input, forgoing adjusting the mute state of the microphone for the first audio function that uses the microphone.

29. A computer readable storage medium storing one or more programs, the one or more programs comprising instructions that, when executed by a wearable audio output device that includes a microphone and one or more input devices, cause the wearable audio output device to:
detect an input via the one or more input devices;
in response to detecting the input, in accordance with a determination that the input is a first type of input, adjust a mute state of the microphone for a first audio function that uses the microphone without adjusting the mute state of the microphone for a second audio function that uses the microphone; and
in response to detecting the input, in accordance with a determination that the input is not the first type of input, forgo adjusting the mute state of the microphone for the first audio function that uses the microphone.

30-88. (canceled)
